(19) United States
(12) Patent Application Publication
(10) Pub. No.: US 2024/0307868 A1
(43) Pub. Date: Sep. 19, 2024

(54) SINGLE-LANE AMPLIFICATION CARTRIDGE

(71) Applicant: Becton, Dickinson and Company, Franklin Lakes, NJ (US)

(72) Inventors: Adam Steel, Jarrettsville, MD (US); Alyssa Shedlosky, Reisterstown, MD (US); Ammon David Lentz, York, PA (US)

(21) Appl. No.: 18/616,786

(22) Filed: Mar. 26, 2024

Related U.S. Application Data
(63) Continuation of application No. PCT/US2022/076490, filed on Sep. 15, 2022.
(60) Provisional application No. 63/251,485, filed on Oct. 1, 2021.
(60) Provisional application No. 63/326,633, filed on Apr. 1, 2022.

(51) Int. Cl. B01L 3/00

(52) U.S. Cl. CPC B01L 3/502707; B01L 2200/0689; B01L 2300/0663; B01L 2300/1805; B01L 2400/0694

(57) ABSTRACT

The technology described herein generally relates to microfluidic cartridges. The technology more particularly relates to a single-lane cartridge configured to carry out a single amplification reaction. The reaction chamber has a large volume with a thin-walled shape. A valve can be configured to simultaneously seal a fill channel and a vent channel leading from the reaction chamber.

### CROSS-REFERENCE TO RELATED APPLICATIONS

This application is a continuation of International Application No. PCT/US2022/076490, filed Sep. 15, 2022, which claims the benefit of U.S. Provisional Application No. 63/251,485, filed Oct. 1, 2021 and U.S. Provisional Application No. 63/326,633, filed Apr. 1, 2022, which are hereby incorporated by reference in their entirety.

### BACKGROUND

### Field

The technology described herein generally relates to microfluidic cartridges. In one aspect, the technology more particularly relates a single lane cartridge, wherein the microfluidic cartridge is configured to receive and amplify polynucleotides of interest. In another aspect, the technology relates to a microfluidic cartridge having a deep reaction chamber to amplify polynucleotides of interest from a biological sample. In another aspect, the technology relates to a microfluidic cartridge having a large surface area reaction chamber to amplify polynucleotides of interest from a biological sample. Embodiments of the cartridges described herein can permit detection of those polynucleotides.

### Description of the Related Art

The sensitivity of assays in molecular diagnostic tests is dependent on several factors. These factors include extraction efficiency during the processing of specimens to obtain amplification-ready samples, efficiency of amplification of the samples, and thermal uniformity achieved in a reaction volume during the amplification process, among other factors. Increasing the dimensions of the reaction volume contributes to improvements in the amplification efficiency, resulting in improved limit of detection (LOD) and improved limit of quantification (LOQ). Improving the uniformity and distribution of thermal communication between the reaction volume and a heat source contributes to improvements in thermal uniformity.

One current microfluidic cartridge implementation has reaction chambers having a reaction volume of about 4 μL. There are significant advantages associated with cartridges including reaction chambers with such small reaction volumes. As the volume of the reaction chamber decreases, however, challenges associated with achieving a desired analytical sensitivity can arise. At the same time, as the volume of the reaction chamber increases to achieve improved amplification efficiency and overcome target delivery limitations, challenges associated with achieving thermal uniformity can arise. There is a thus a need for microfluidic cartridges that overcome these challenges and achieve both improved amplification efficiency and thermal uniformity, resulting in assays having improved LOD and improved LOQ.

The discussion of the background to the technology herein is included to explain the context of the technology. This is not to be taken as an admission that any of the material referred to was published, known, or part of the common general knowledge as at the priority date of any of the claims.

Throughout the description and claims of the specification the word “comprise” and variations thereof, such as “comprising” and “comprises”, is not intended to exclude other additives, components, integers or steps.

### SUMMARY

The present technology includes methods and devices for improving amplification for larger sample sizes. The cartridge can include a deep reaction chamber for carrying out reactions requiring larger sample sizes. The cartridge can include a large surface area reaction chamber for carrying out reactions requiring larger sample sizes. The larger sample size may be necessary to detect very low analyte levels or for quantitative analysis. In some embodiments, the larger sample size is to detect viral loads. These tests may benefit from larger volumes of additive chemistry. The present technology includes methods and devices for accommodating larger volumes of sample.

Cartridges of the present technology can include a single lane cartridge. Instead of processing multiple samples in a plurality of networks, the cartridge can process a single sample in a single network. The cartridge can be specifically designed for carrying out a single reaction. This allows configurations that provide greater random access. This allows configurations that only consume as many reaction vessels as required.

Cartridges can interact with a heater assembly for uniform heating of the deep reaction chamber. Cartridges can interact with a heater assembly for uniform heating of the large surface area reaction chamber. The heater assembly can provide heat to a specific region of the cartridge, thereby increasing thermal uniformity within the cartridges and enhancing parameters of amplification performed in the cartridge. Implementations of the present technology improve features of cartridges that amplify polynucleotides of interest within deep reaction chambers.

Embodiments of cartridges according to the present technology can include a shaped deep reaction chamber, which in some embodiments can be conical or rectangular. The reaction chamber can be a very thin walled chamber to effectively transfer heat to the contents of the reaction chamber. The reaction chamber can be designed to concentrate the fluid and chemistry in the bottom of the reaction chamber. The reaction chamber can be designed to reduce thermal resistance to maximize the rapid thermal cycling of amplification molecular chemistry. The shape of the reaction chamber can be matched to cone angles of a detector. The benefit of the shape of the reaction chamber can include greater uniformity of temperature control.

Embodiments of cartridges according to the present technology can include a shaped large surface area reaction chamber, which in some embodiments can be elongate. The reaction chamber can be a sealed with a layer that effectively transfers heat to the contents of the reaction chamber. The reaction chamber can be designed to concentrate the fluid and chemistry in the bottom of the reaction chamber. The reaction chamber can be designed to reduce thermal resistance to maximize the rapid thermal cycling of amplification molecular chemistry. The reaction chamber can include features to facilitate detection. The benefit of the shape of the reaction chamber can include greater uniformity of temperature control. The benefit of the shape of the reaction chamber can include greater ease of processing and movement.

Cartridges of the present technology can also achieve improved assay sensitivity by increasing an amplification chamber volume, while achieving optimal thermal uniformity across the reaction chamber during an amplification process. The larger volume reaction chambers of the present technology can receive a larger volume of fluid eluate, containing DNA/RNA target analytes extracted from a specimen, thereby increasing assay sensitivity. In some cases, microfluidic devices of the present technology achieve a multiple-fold increase in reaction chamber volume as compared to current microfluidic devices.

The present technology can include improved sealing configurations of the reaction chamber. Valve in accordance with the present technology contain geometry to take advantage of microfluidic properties to promote complete and robust sealing of the reaction chamber. In some aspects, a single valve can seal two openings of the reaction chamber. In some aspects, a single valve can seal two different channels connected to the reaction chamber. In some aspects, a single valve can seal two access points of the reaction chamber. The single valve can prevent entry and exit into the reaction chamber through channels connected to the reaction chamber. The single valve can block an inlet and a vent, thereby isolating the contents within the amplification chamber. The single valve can prevent the movement of fluid and gas through channels connected to the reaction chamber, forming an impermeable seal during thermal cycling.

In some embodiments, a microfluidic cartridge is provided. The microfluidic cartridge can include an inlet. The microfluidic cartridge can include a reaction chamber. The microfluidic cartridge can include a vent. The microfluidic cartridge can include a fill channel spanning between the inlet and the reaction chamber comprising a first lower channel, a first through channel, and a first upper channel. The microfluidic cartridge can include a vent channel spanning between the reaction chamber and the vent comprising a second upper channel, a second through channel, and a second lower channel. The microfluidic cartridge can include a valve configured to simultaneously seal the fill channel and the vent channel along the first lower channel and the second lower channel.

In some embodiments, the reaction chamber is conical. In some embodiments, the reaction chamber is trapezoidal. In some embodiments, the reaction chamber has a volume between 50 μl and 100 μl. In some embodiments, the reaction chamber has a volume between 100 μl and 150 μl. In some embodiments, the microfluidic cartridge can include a top layer configured to seal the reaction chamber, the first upper channel, and the second upper channel. In some embodiments, the valve is configured to confine a fluid sample to the fill channel and the reaction chamber. In some embodiments, the microfluidic cartridge can include a bottom layer configured to seal the first lower channel and the second lower channel. In some embodiments, the microfluidic cartridge can include a bottom layer configured to seal valve channels of the valve. In some embodiments, the microfluidic cartridge can include a first valve channel forming a junction with the first lower channel and a second valve channel forming a junction with the second lower channel.

In some embodiments, an assembly for amplification and detection is provided. The assembly can include a cartridge. The cartridge can include an inlet. The cartridge can include a reaction chamber. The cartridge can include a vent. The cartridge can include a fill channel spanning between the inlet and the reaction chamber comprising a first lower channel, a first through channel, and a first upper channel. The cartridge can include a vent channel spanning between the reaction chamber and the vent comprising a second upper channel, a second through channel, and a second lower channel. The cartridge can include a valve configured to seal the fill channel and the vent channel along the first lower channel and the second lower channel. The assembly can include a heater assembly configured to apply heat to the reaction chamber and the valve. The assembly can include a detector configured to detect fluorescence from the reaction chamber.

In some embodiments, the heater assembly comprises a conductive element configured to receive the reaction chamber. In some embodiments, the heater assembly is configured to heat a thermally responsive substance of the valve. In some embodiments, the detector is configured for two-color detection. In some embodiments, the detector is configured to detect a plurality of different fluorogenic probes for syndromic testing. In some embodiments, the assembly is configured to receive a plurality of detectors. In some embodiments, the assembly is configured to receive a plurality of cartridges.

In some embodiments, a method of amplifying and detecting is provided. The method can include introducing an amplification-ready sample into a cartridge. In some embodiments, the cartridge comprises a fill channel spanning between an inlet and a reaction chamber. In some embodiments the fill channel comprises a first lower channel, a first through channel, and a first upper channel. In some embodiments, the cartridge comprises a vent channel spanning between the reaction chamber and a vent. In some embodiments, the vent channel comprises a second upper channel, a second through channel, and a second lower channel. The method can include closing a valve to simultaneously seal the fill channel and the vent channel along the first lower channel and the second lower channel. The method can include heating the reaction chamber. The method can include detecting fluorescence from the reaction chamber.

In some embodiments, the method can include performing syndromic testing by detecting multiple fluorogenic probes in a plurality of the cartridges. In some embodiments, detecting fluorescence comprises detecting fluorescence from a sample volume between 50 μl and 150 μl.

In some embodiments, a microfluidic cartridge is provided. The microfluidic cartridge can include an inlet. The microfluidic cartridge can include a reaction chamber. The microfluidic cartridge can include a vent. The microfluidic cartridge can include a fill channel spanning between the inlet and the reaction chamber comprising a first lower channel. The microfluidic cartridge can include a vent channel spanning between the reaction chamber and the vent comprising a second lower channel. The microfluidic cartridge can include a valve configured to simultaneously seal the fill channel and the vent channel along the first lower channel and the second lower channel.

In some embodiments, the reaction chamber comprises a flat bottom. In some embodiments, the reaction chamber has a volume between 50 μl and 150 μl. In some embodiments, the microfluidic cartridge can include a top layer. In some embodiments, the vent comprises an upper channel, a through channel, and the second lower channel. In some embodiments, the microfluidic cartridge can include a bottom layer configured to seal the reaction chamber. In some embodiments, the microfluidic cartridge can include a projection extending from the reaction chamber.

In some embodiments, a microfluidic cartridge indexer assembly is provided. The microfluidic cartridge indexer assembly can include an indexing wheel. The microfluidic cartridge indexer assembly can include a detector. The microfluidic cartridge indexer assembly can include a heater assembly. In some embodiments, the indexing wheel is configured to rotate a cartridge. In some embodiments, the indexer assembly is configured to position the cartridge relative to the heater assembly and the detector to amplify and detect polynucleotides.

In some embodiments, the microfluidic cartridge indexer assembly can include the cartridge. In some embodiments, the microfluidic cartridge indexer assembly can include cartridge loading station comprising a stack of cartridges. In some embodiments, the microfluidic cartridge indexer assembly can include a cartridge transfer mechanism configured to move the cartridge onto the indexing wheel. In some embodiments, the microfluidic cartridge indexer assembly can include a cartridge transfer mechanism configured to position the cartridge relative to the detector and the heater assembly. In some embodiments, the microfluidic cartridge indexer assembly can include a cartridge transfer mechanism configured to move the cartridge into a waste container after amplification and detection.

In some embodiments, a microfluidic cartridge reel assembly is provided. The microfluidic cartridge reel assembly can include a reel of cartridges. The microfluidic cartridge reel assembly can include one or more detectors. The microfluidic cartridge reel assembly can include one or more heater assemblies. In some embodiments, the reel of cartridges is configured to be advanced relative to the one or more detectors and the one or more heater assemblies to amplify and detect polynucleotides.

In some embodiments, the reel of cartridges is configured to advance relative to the one or more detectors and the one or more heater assemblies. In some embodiments, the microfluidic cartridge reel assembly can include a cartridge advancing mechanism configured to advance one or more cartridges of the reel of cartridges relative to the one or more detectors and the one or more heater assemblies. In some embodiments, the microfluidic cartridge reel assembly can include a cartridge advancing mechanism configured to advance one or more cartridges of the reel of cartridges into a waste container after amplification and detection.

The details of one or more embodiments of the technology are set forth in the accompanying drawings and further description herein. Other features, objects, and advantages of the technology will be apparent from the description and drawings, and from the claims.

### BRIEF DESCRIPTION

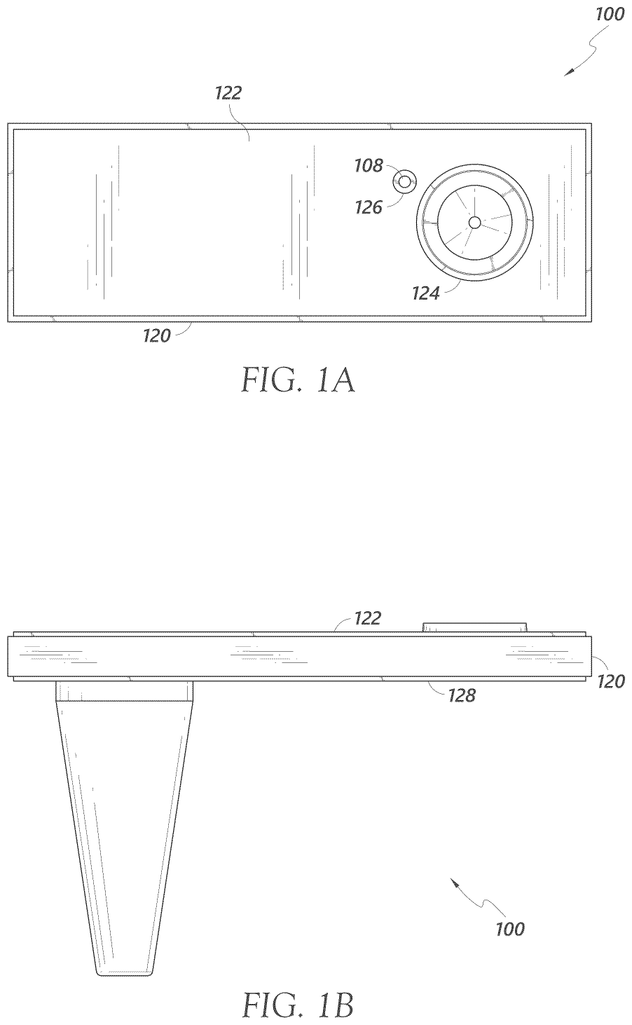

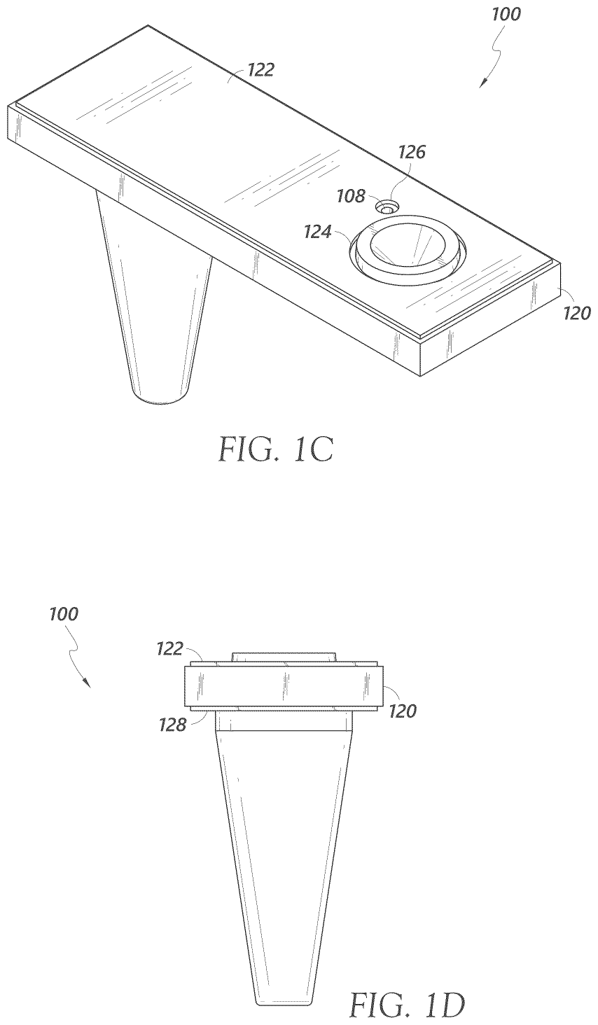

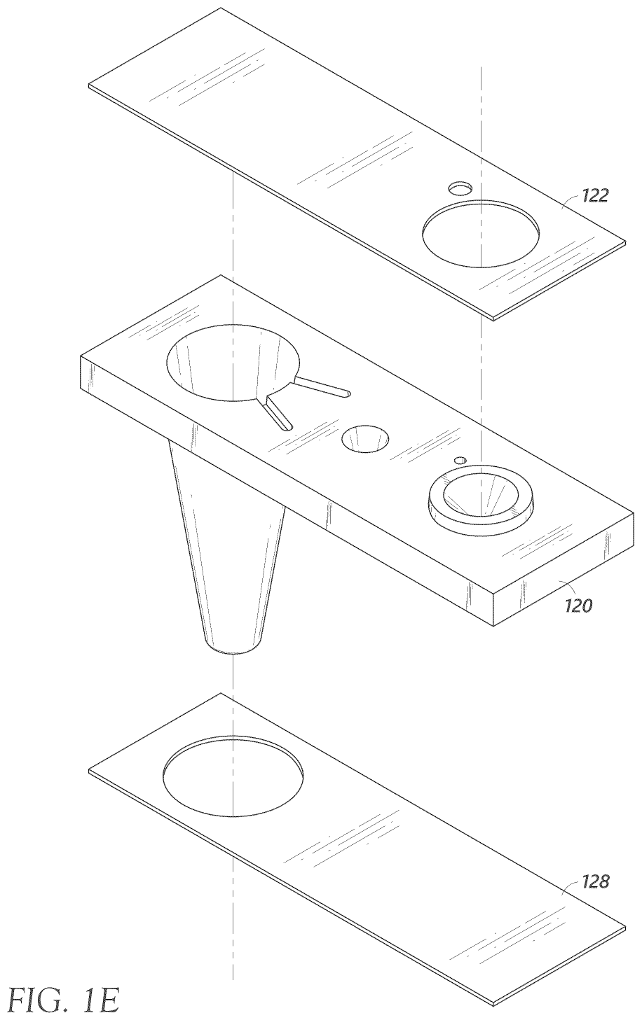

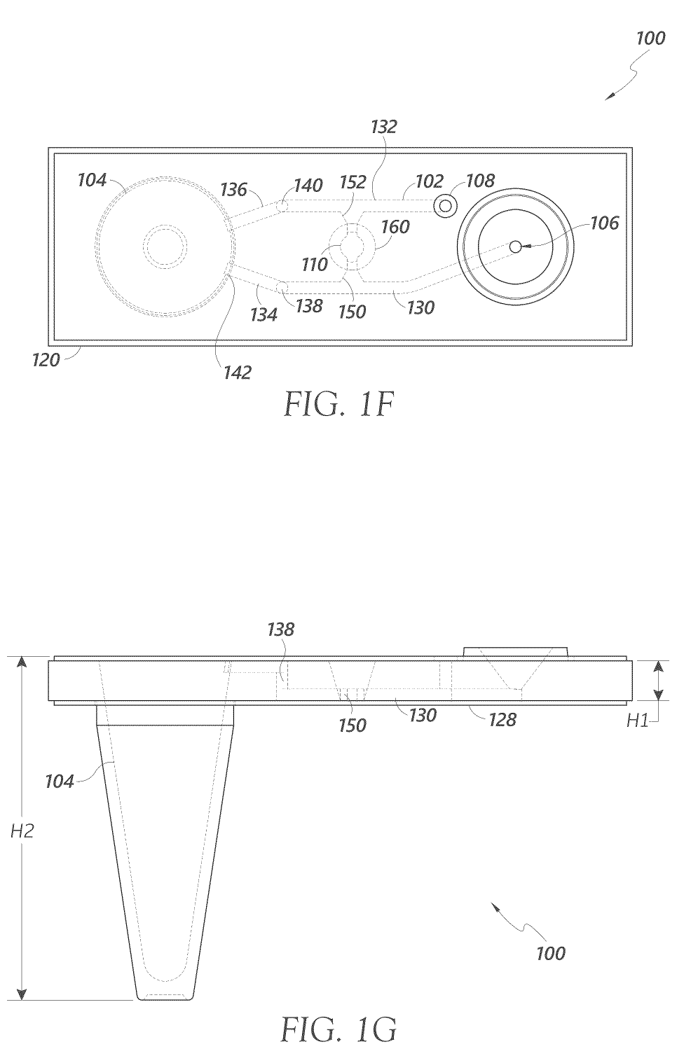

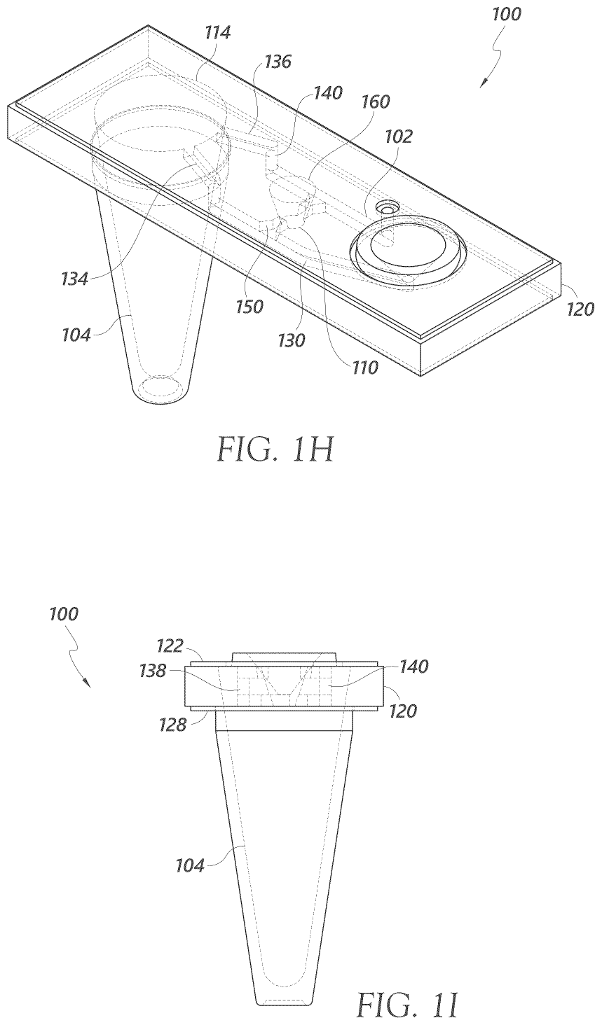

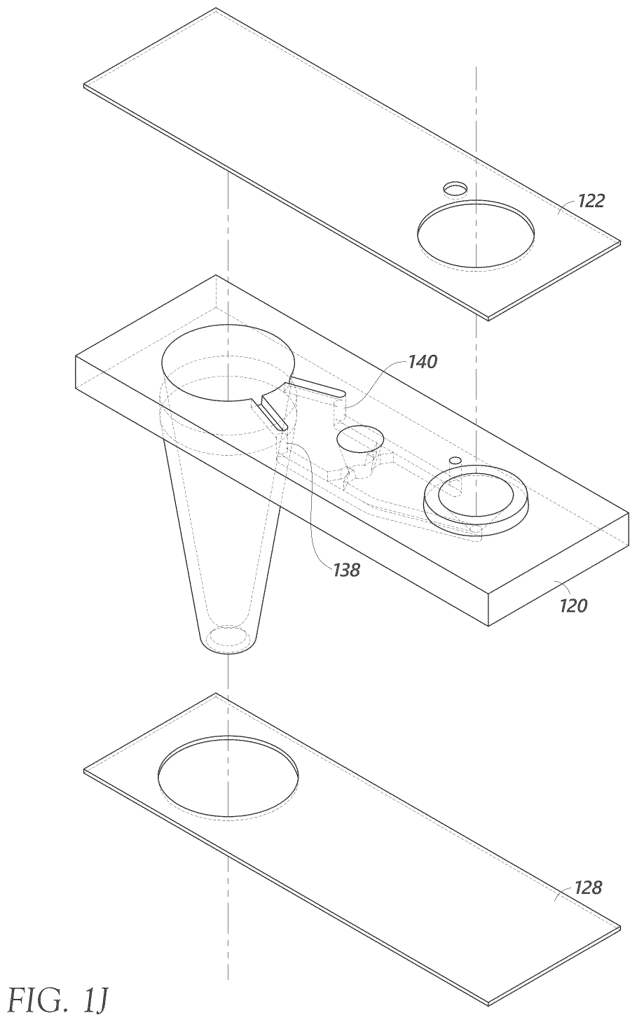

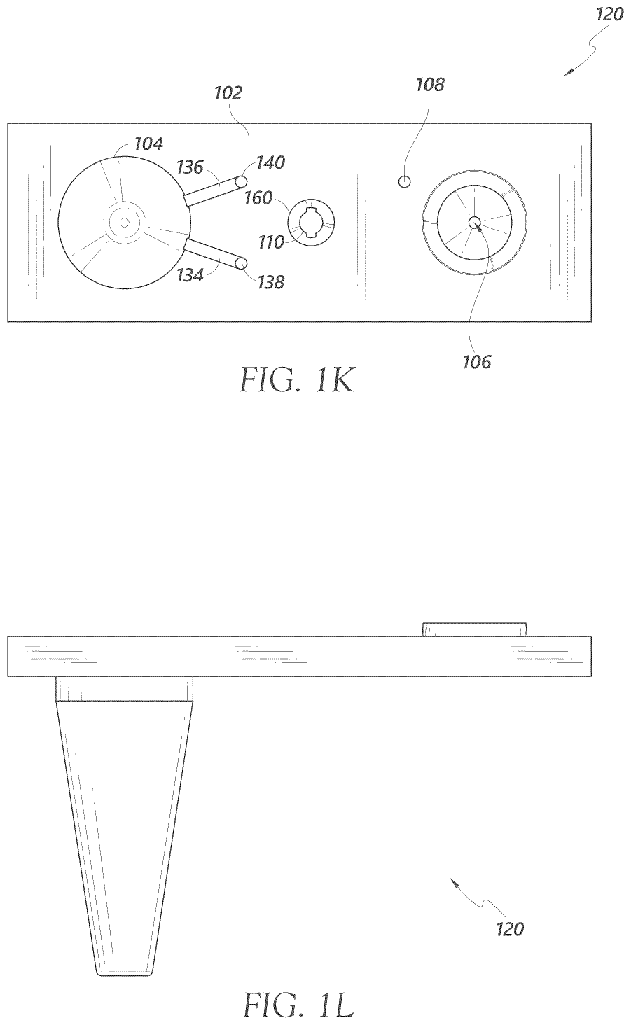

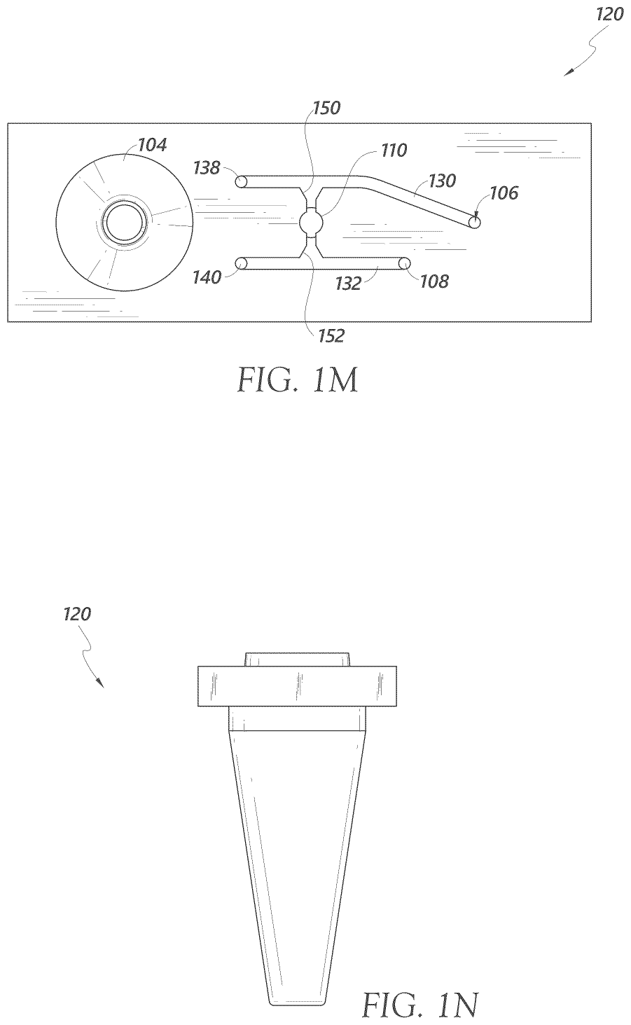

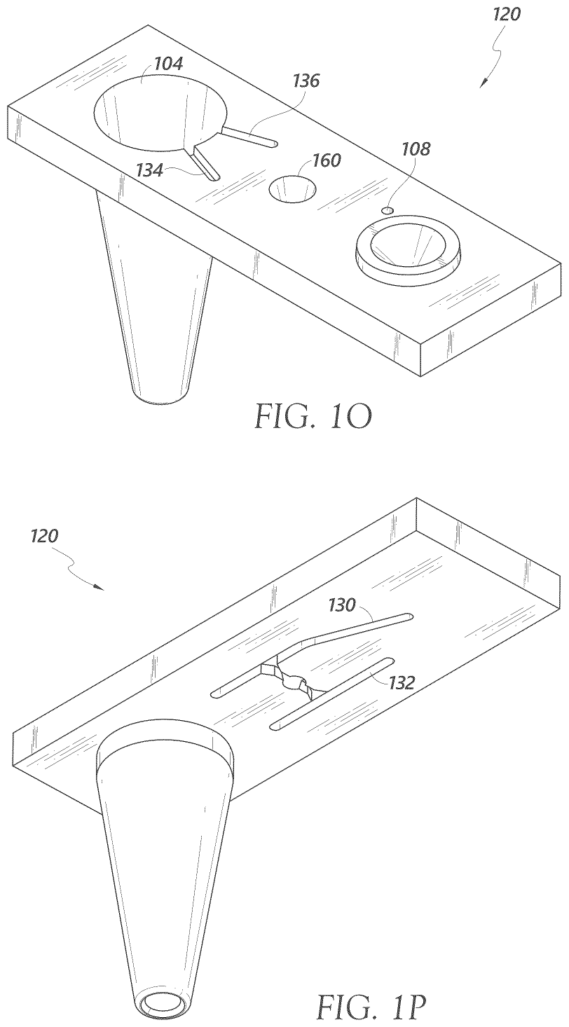

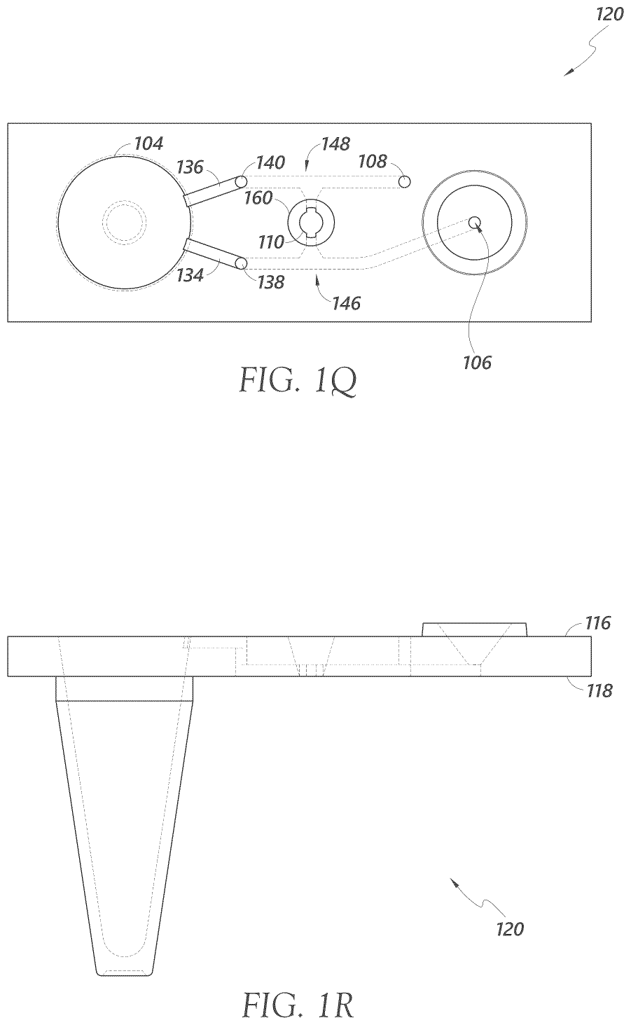

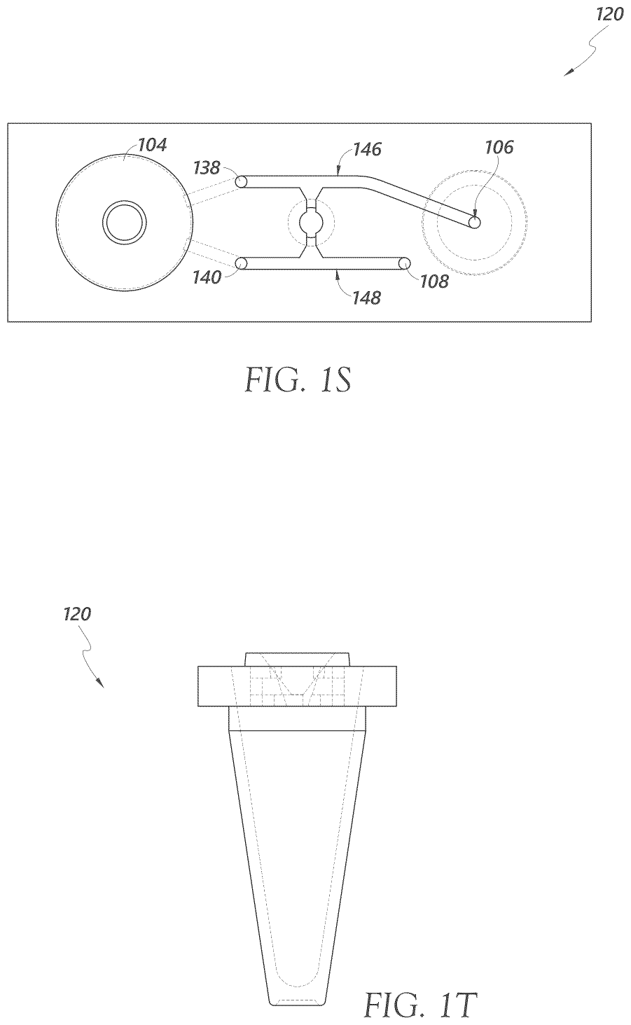

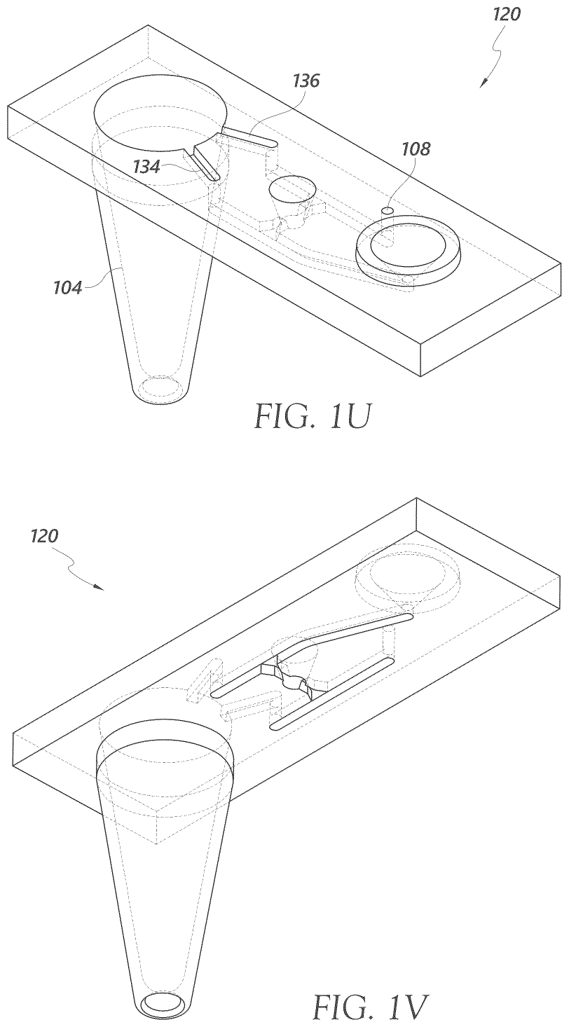

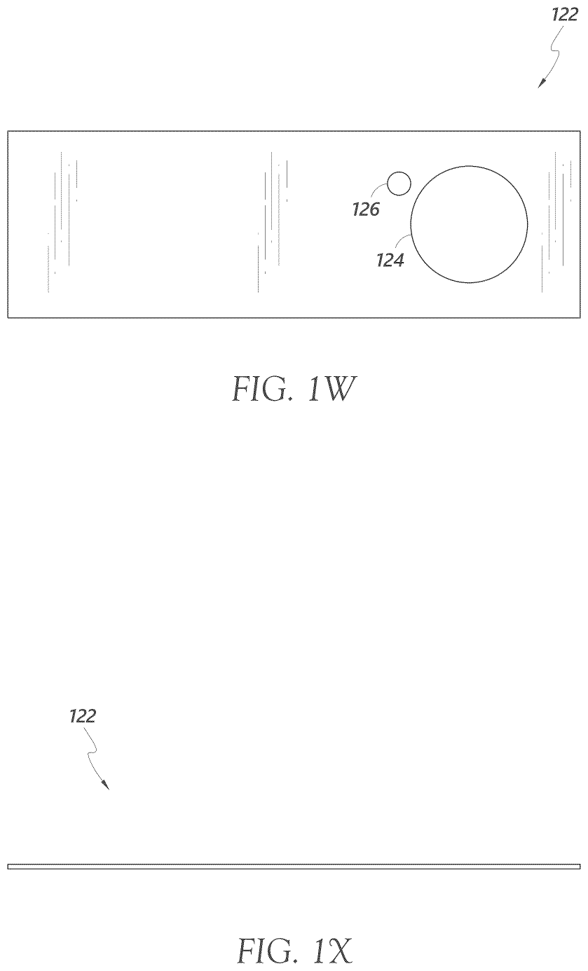

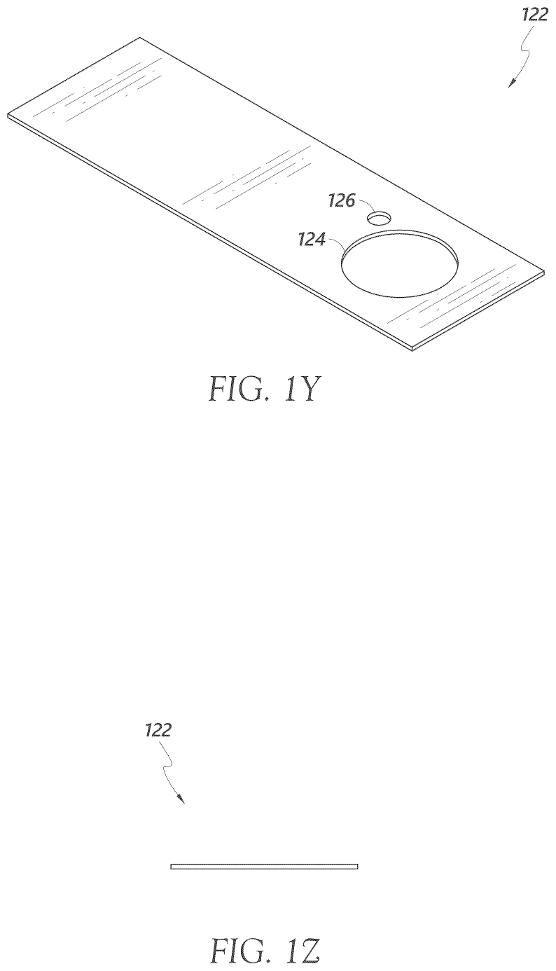

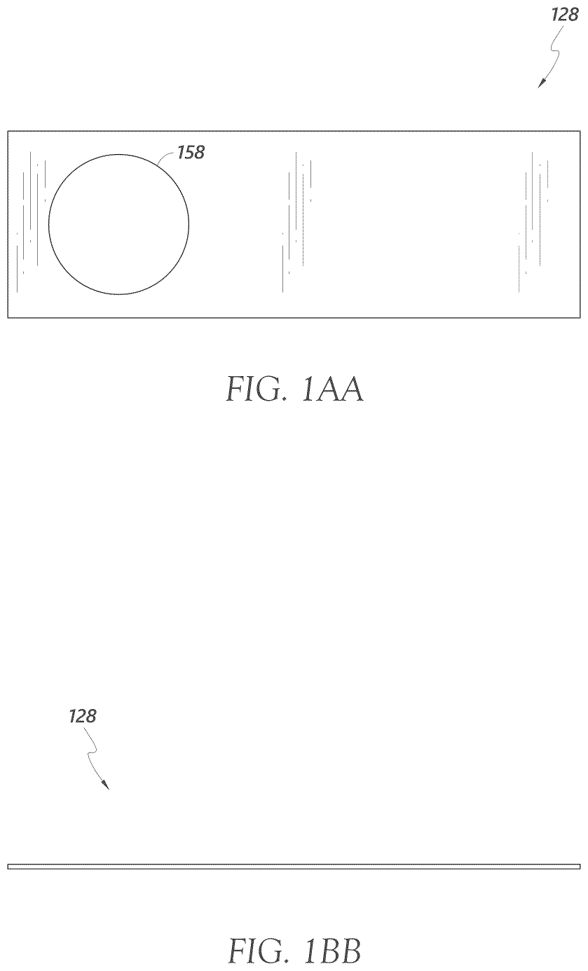

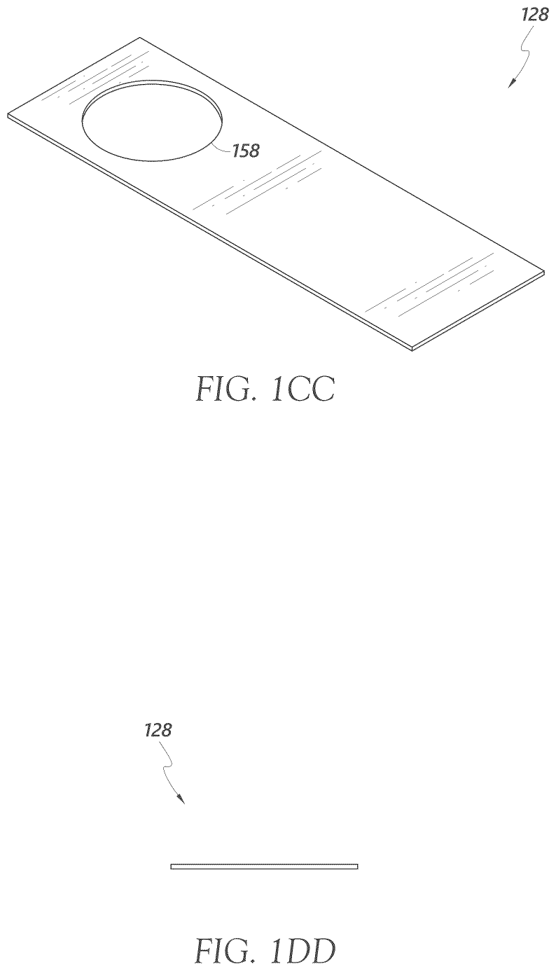

FIGS. 1A-1DD show views of an example of a single lane cartridge and components thereof;

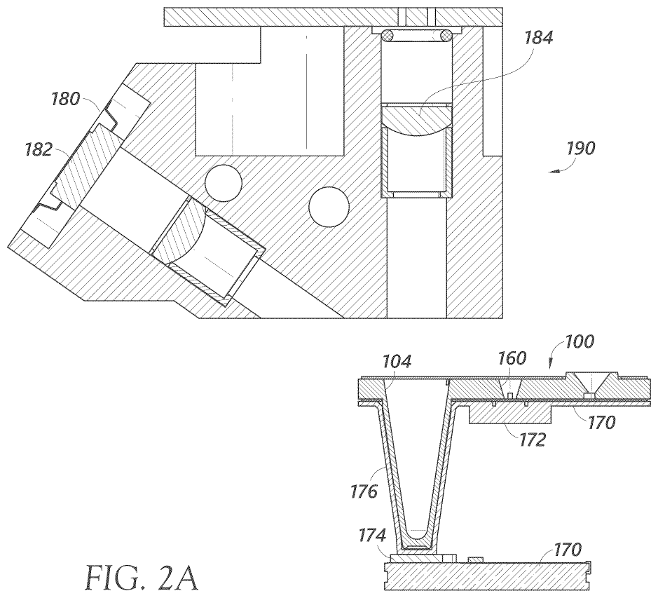

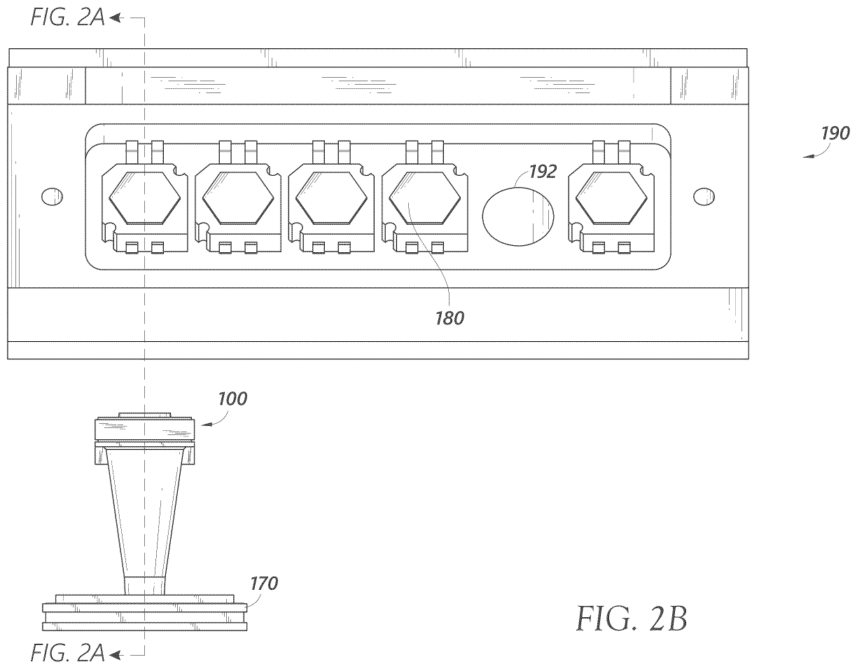

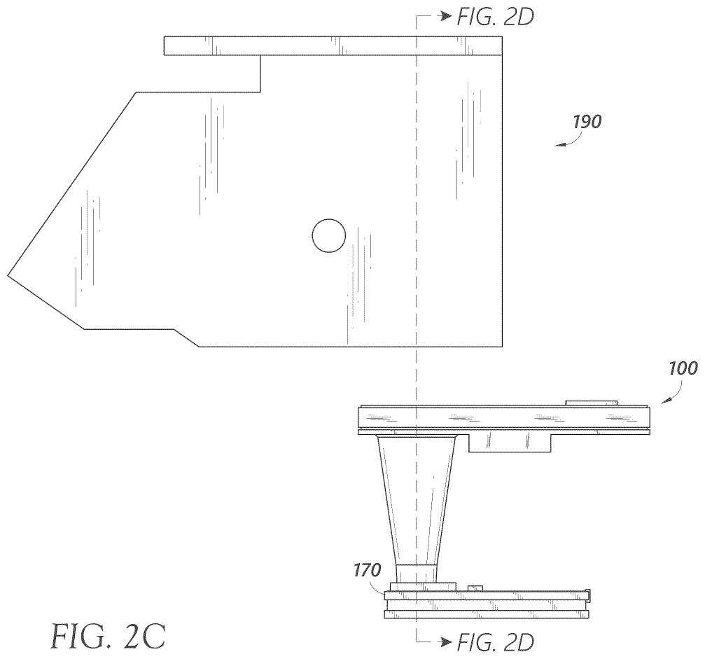

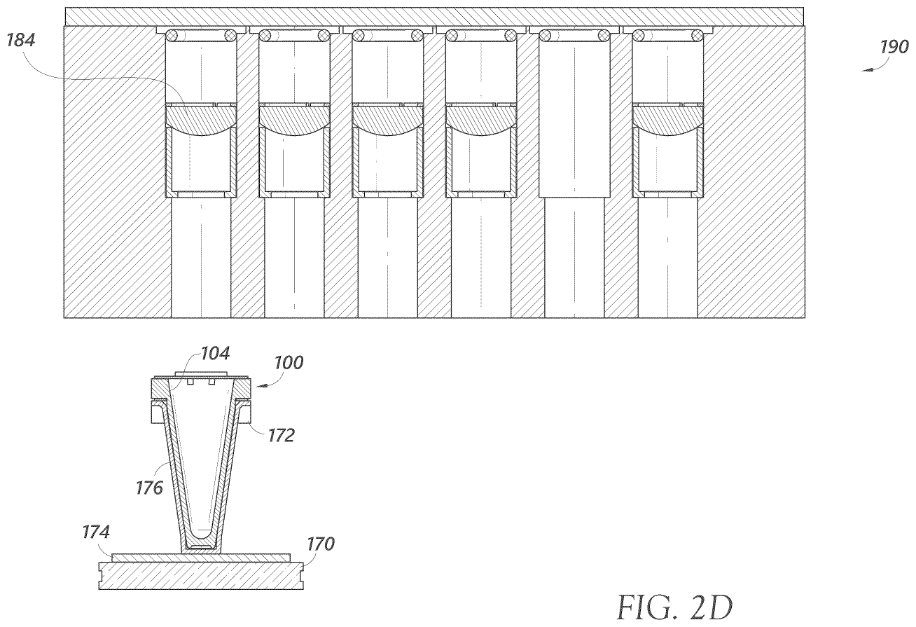

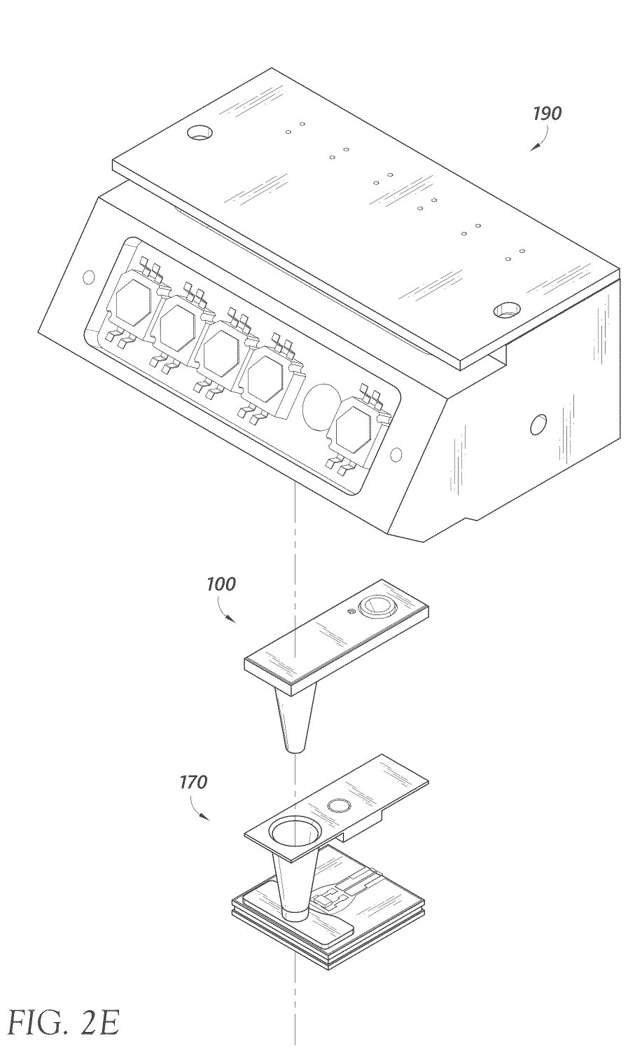

FIGS. 2A-2E show views of an example of a detector in combination of the single lane cartridge of FIGS. 1A-1DD;

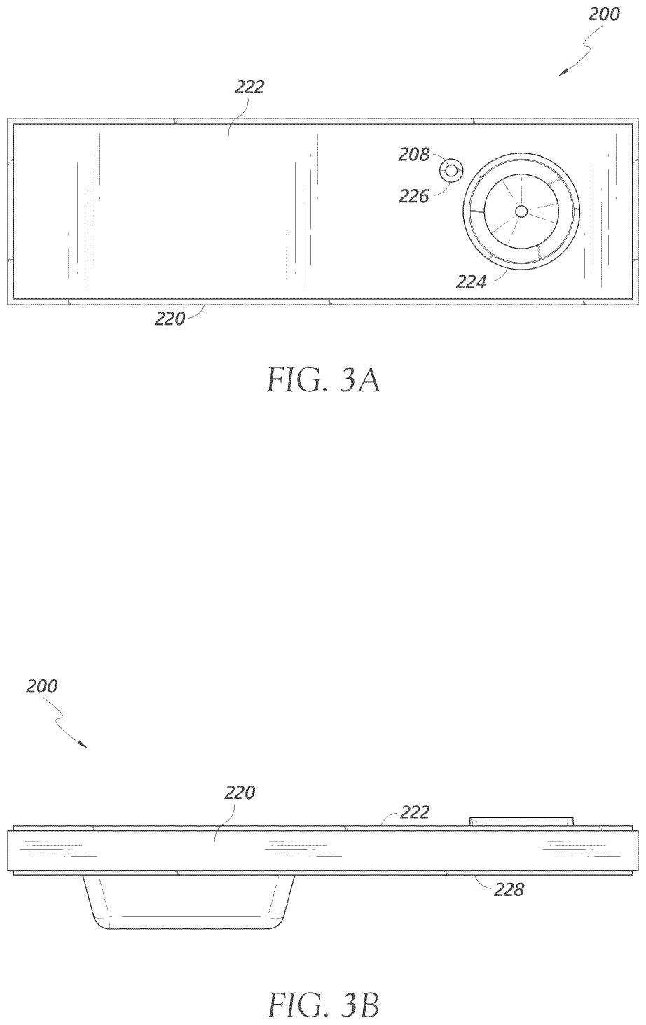

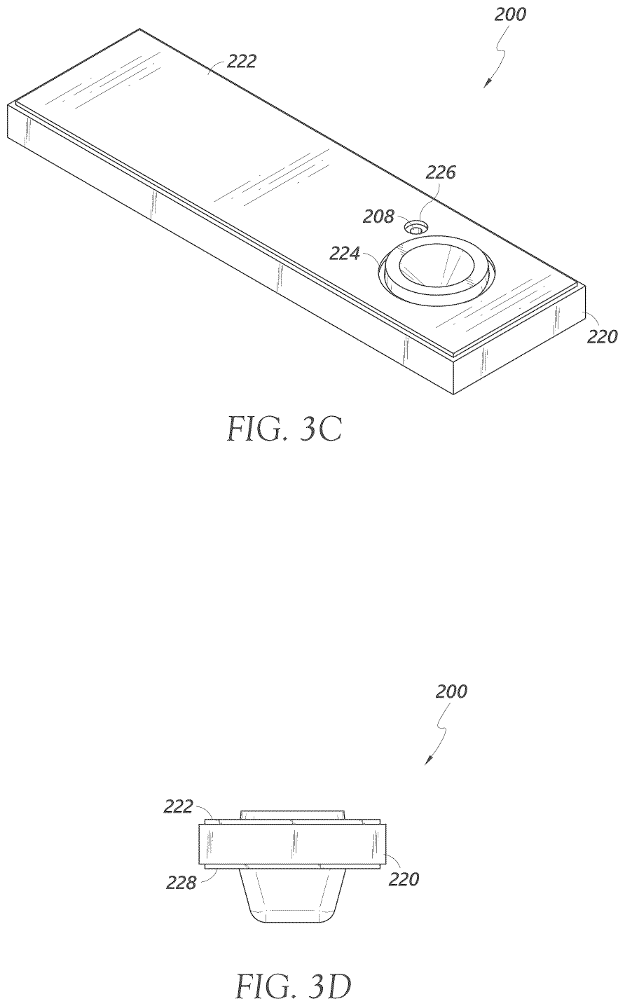

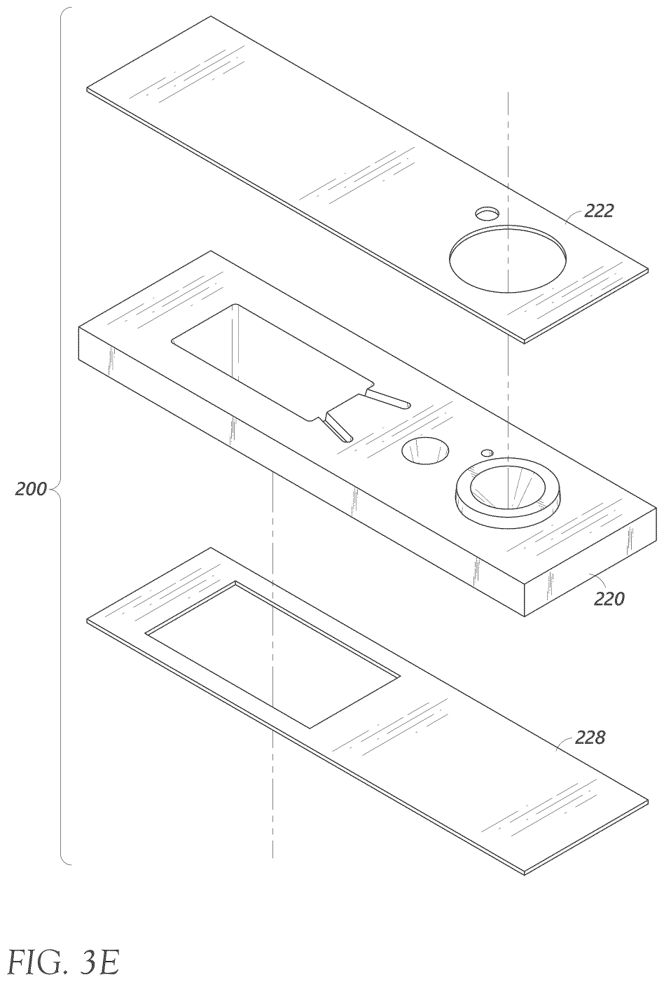

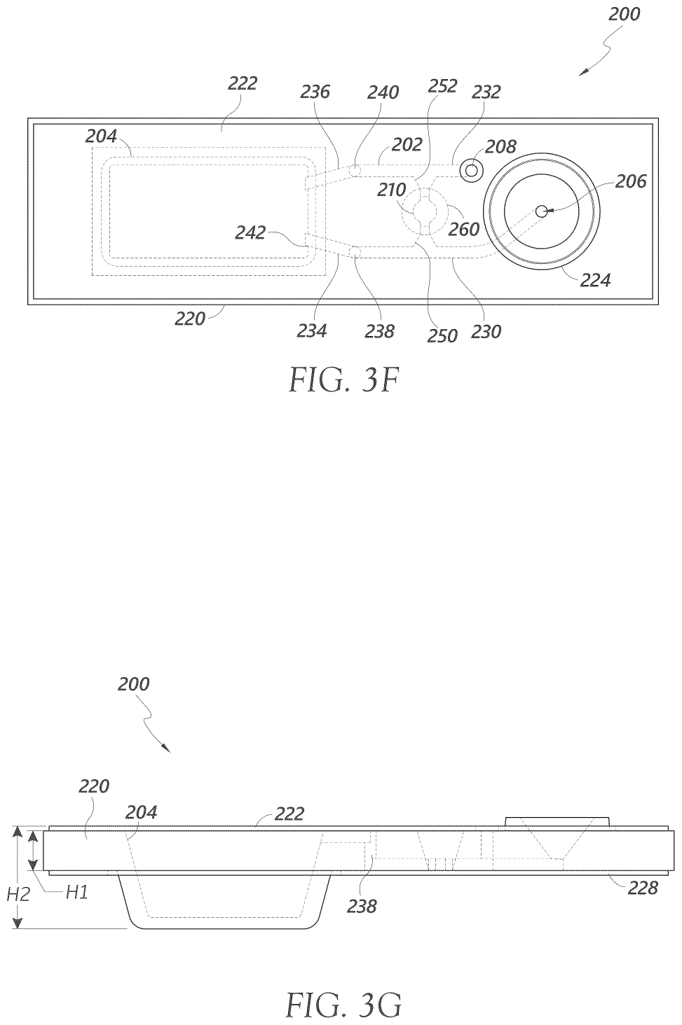

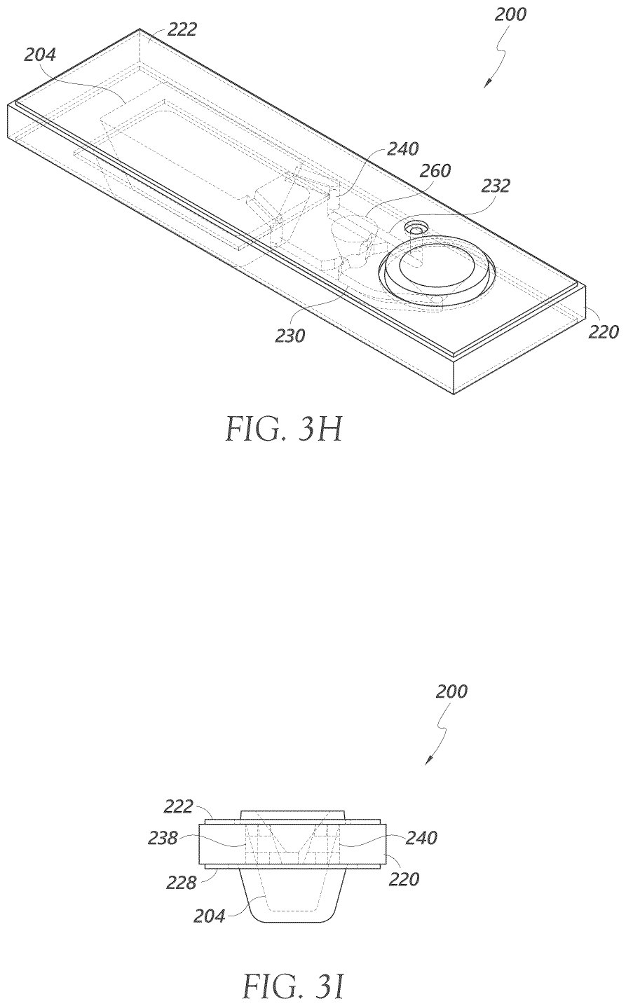

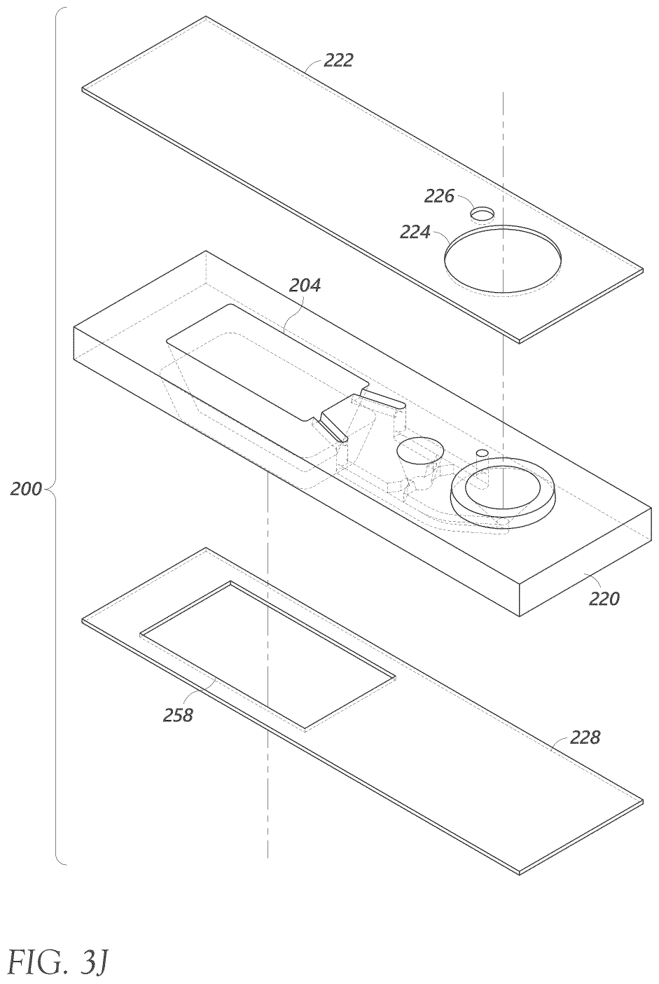

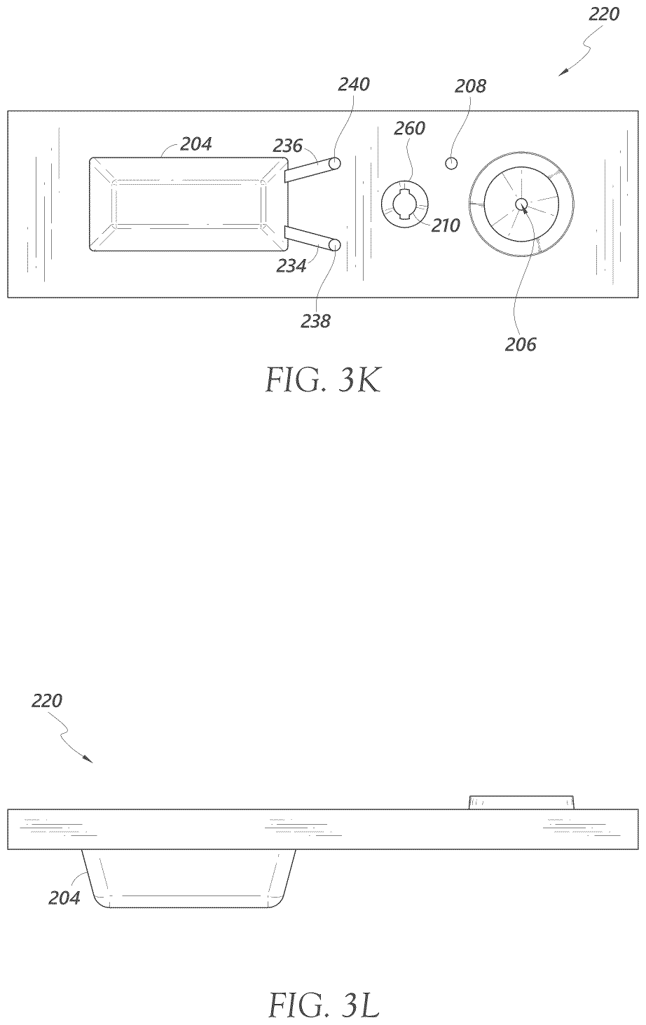

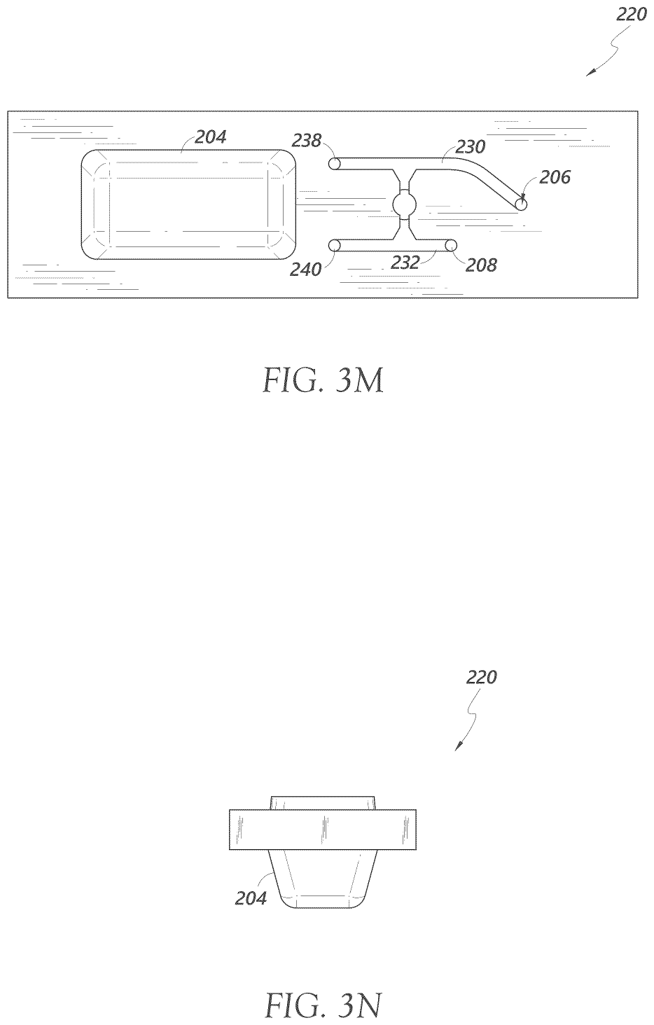

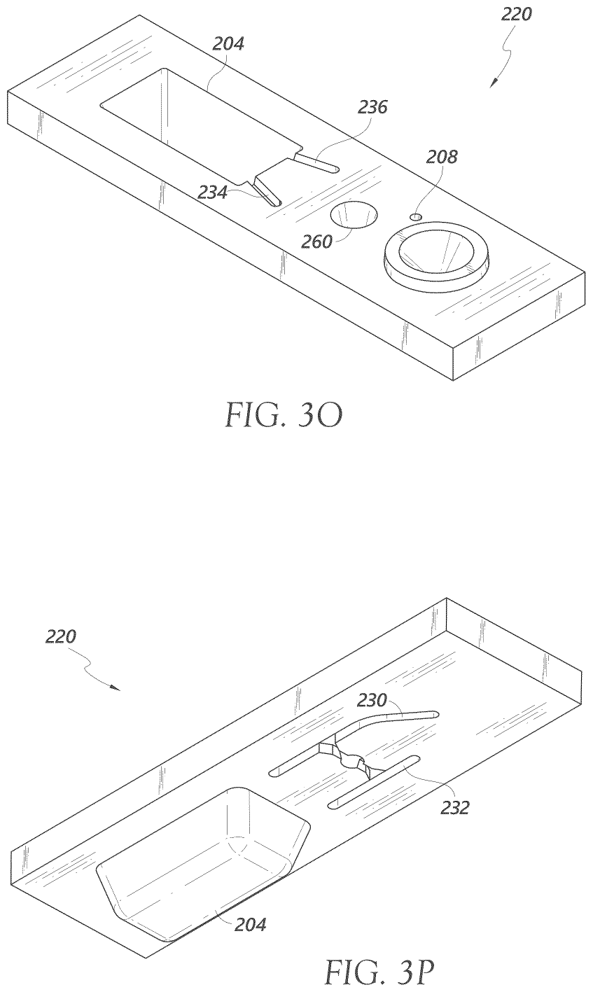

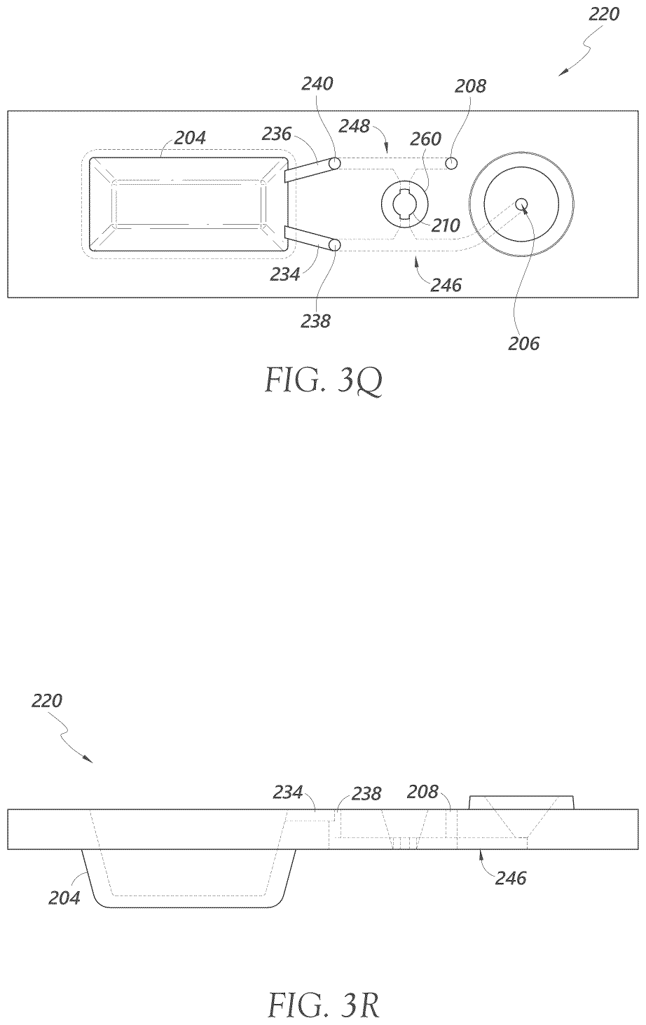

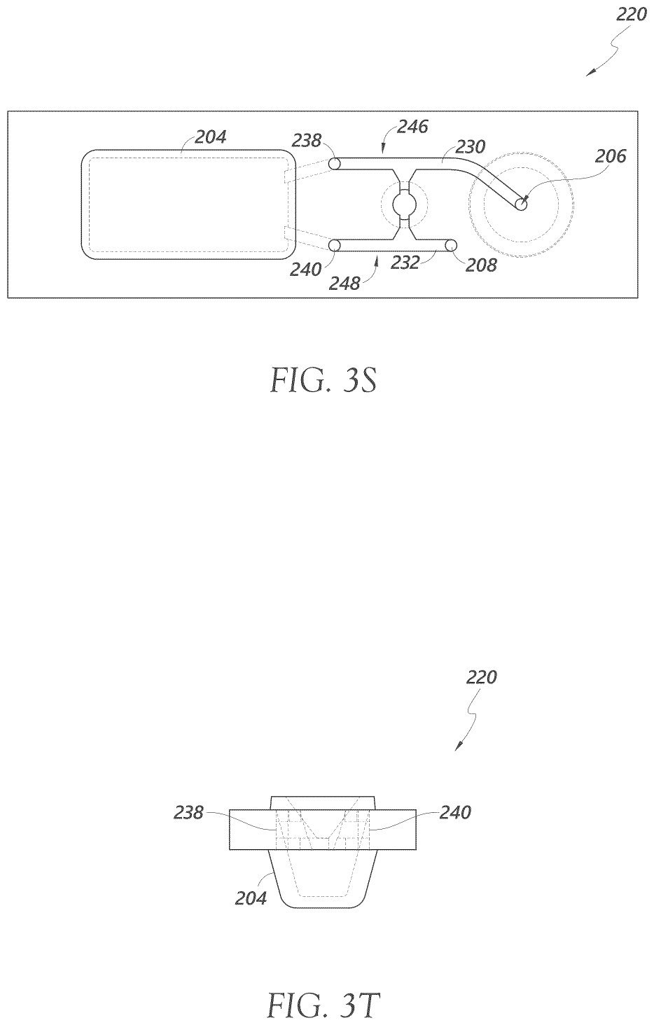

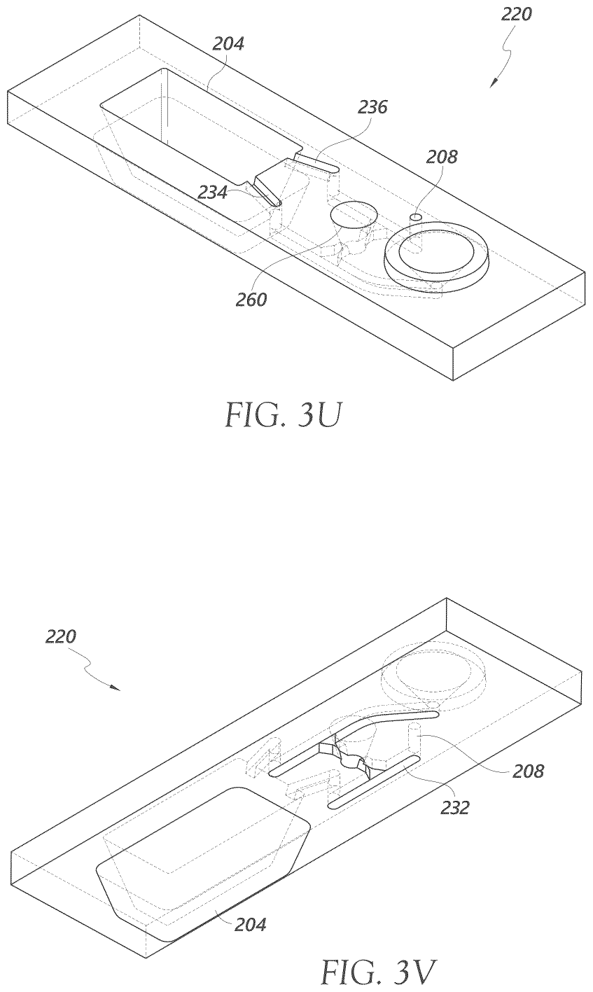

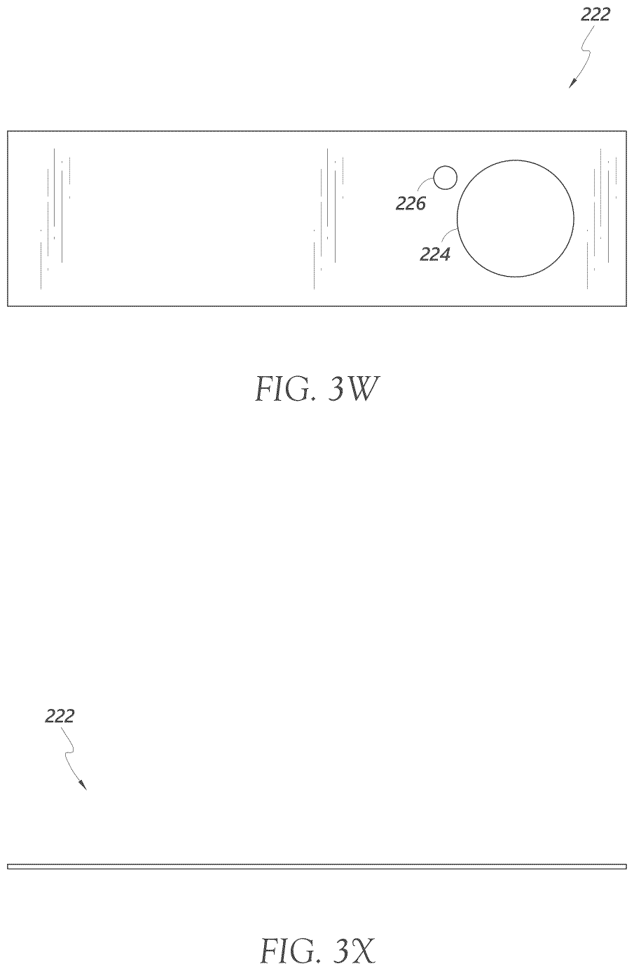

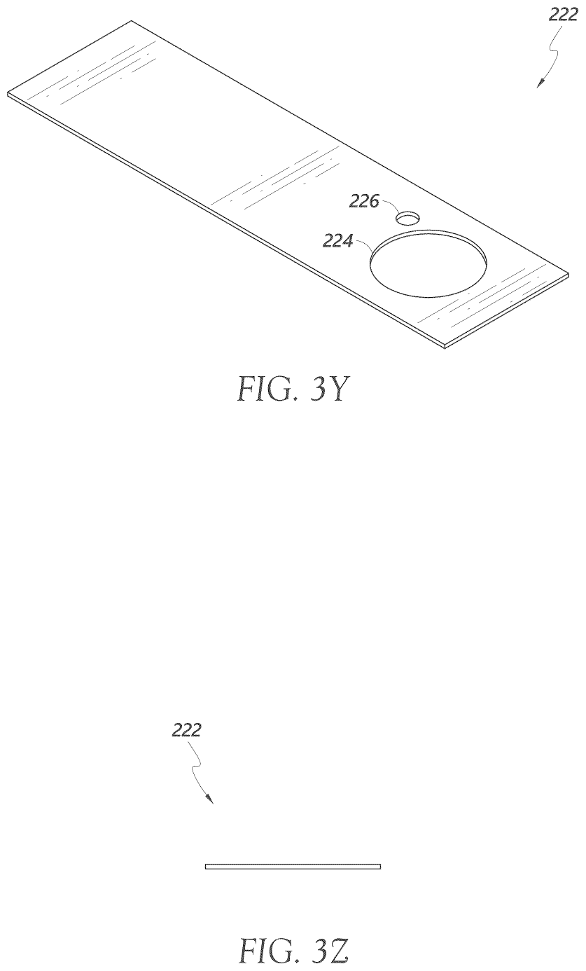

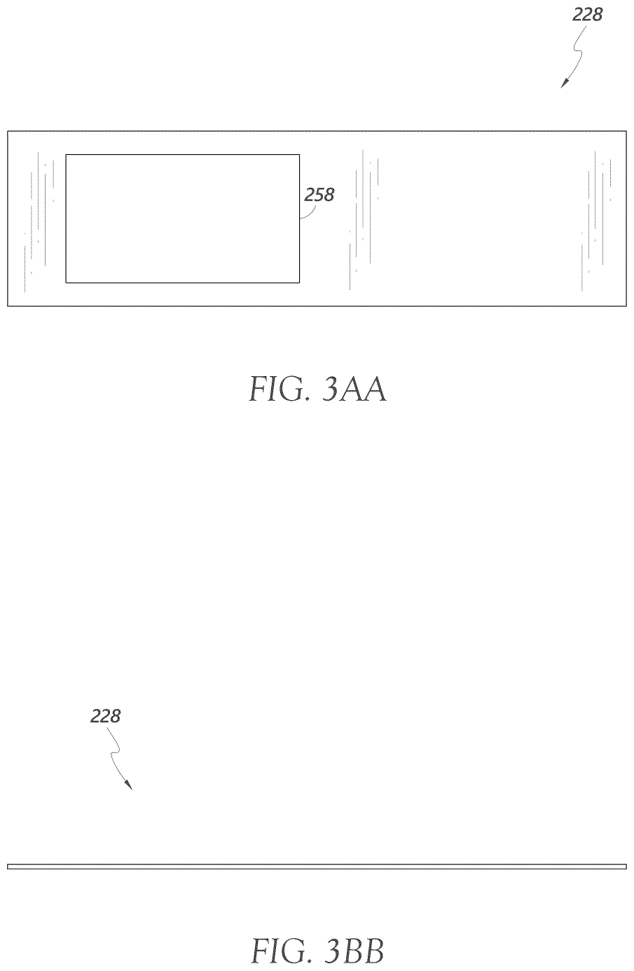

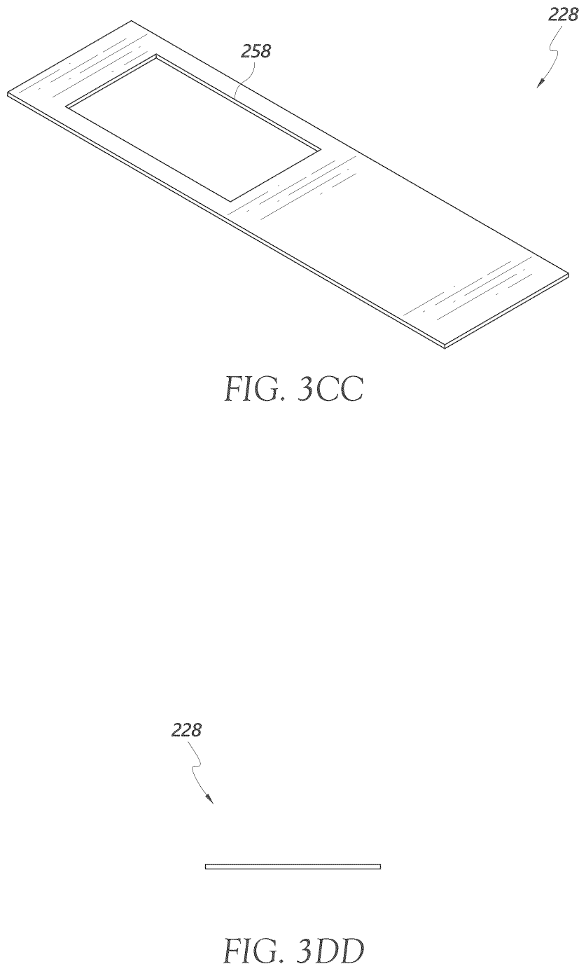

FIGS. 3A-3DD show views of an example of a single lane cartridge;

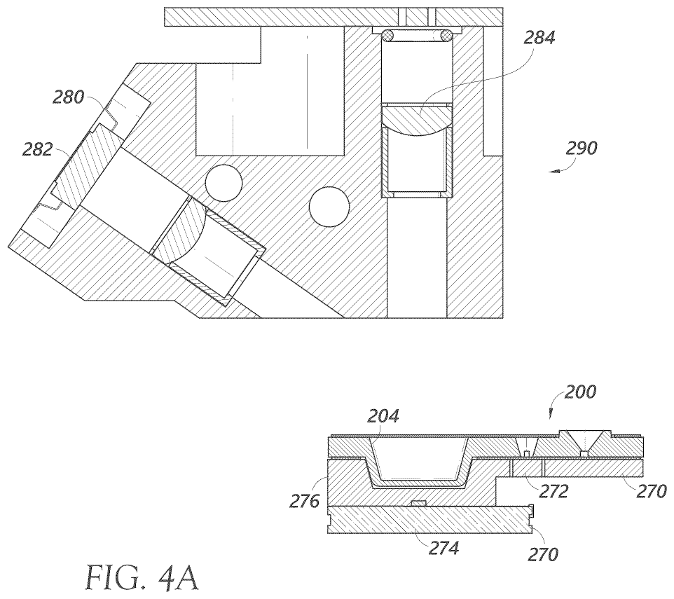

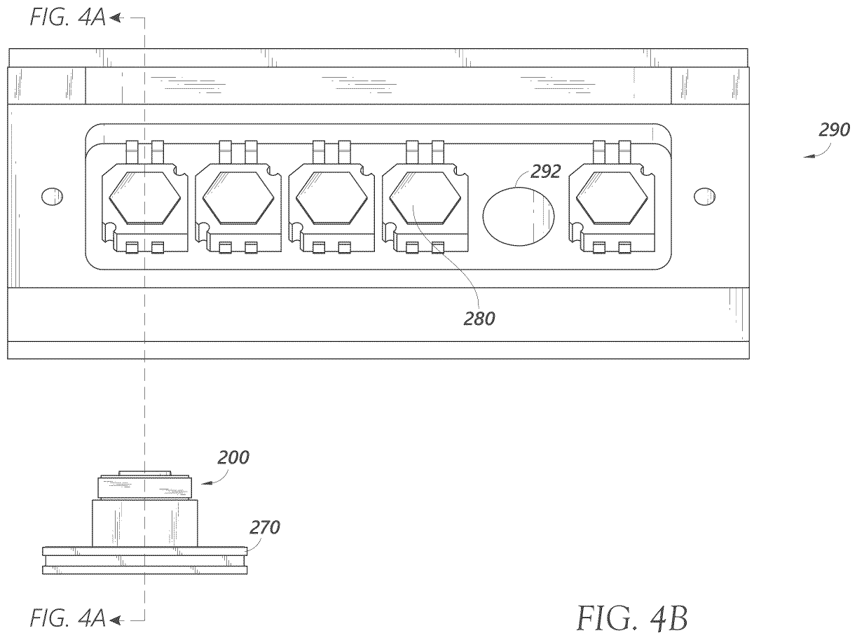

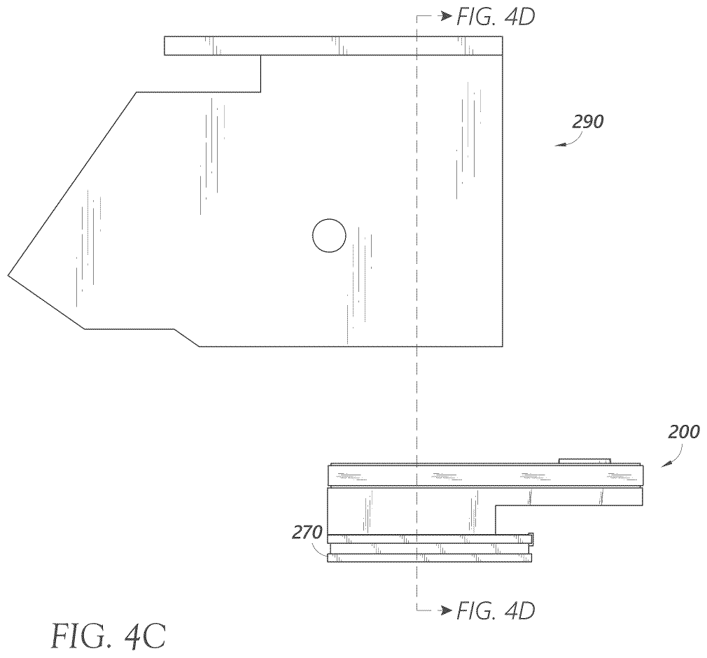

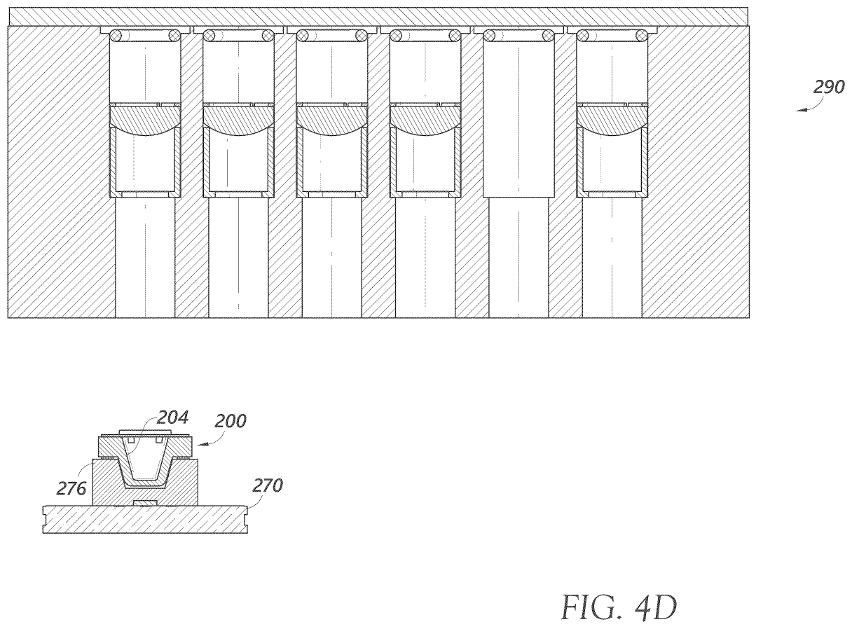

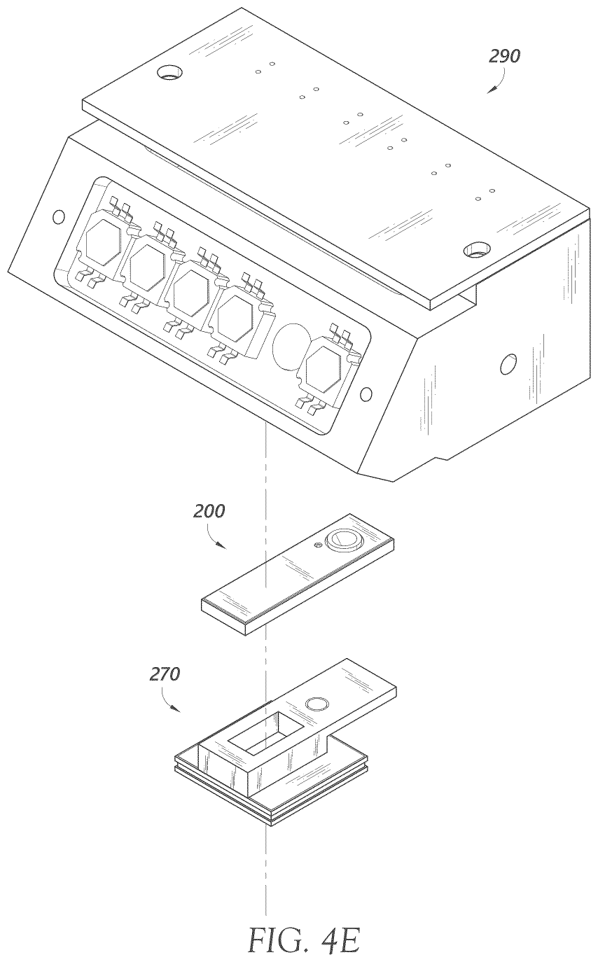

FIGS. 4A-4E show views of an example of a detector in combination of the single lane cartridge of FIGS. 3A-3DD;

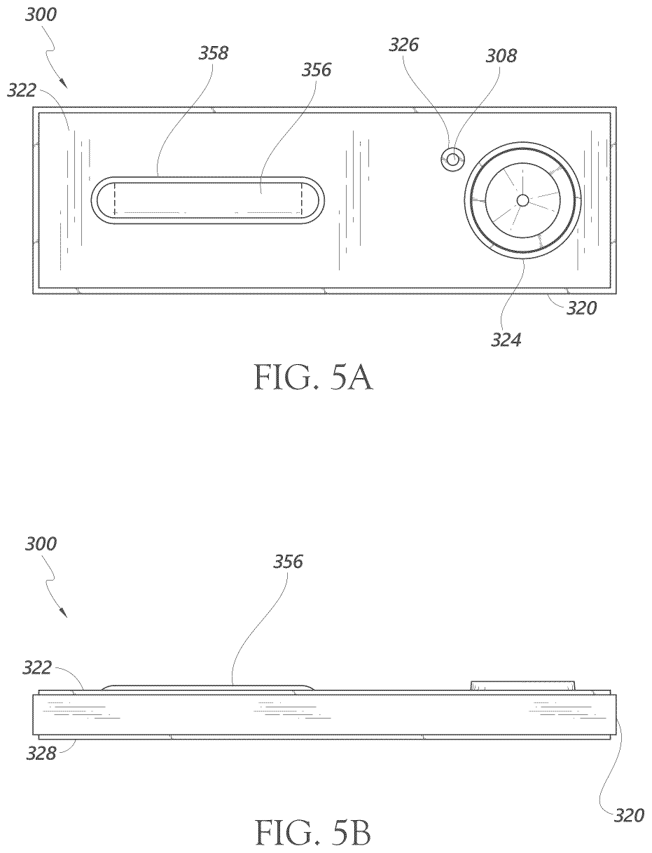

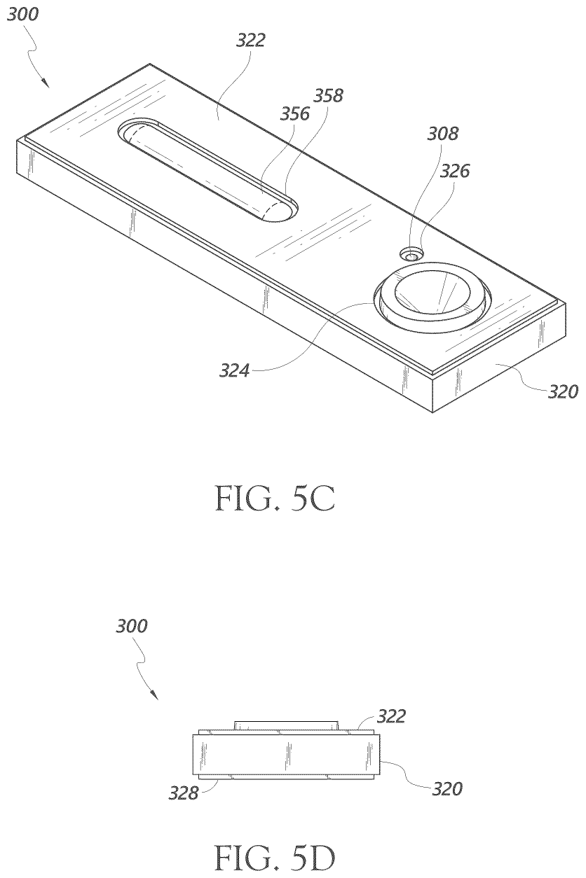

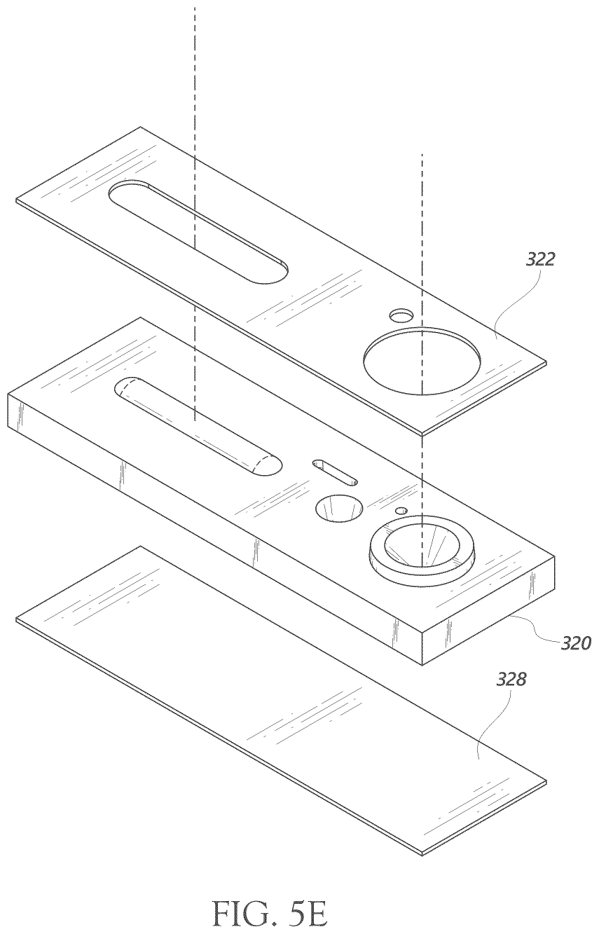

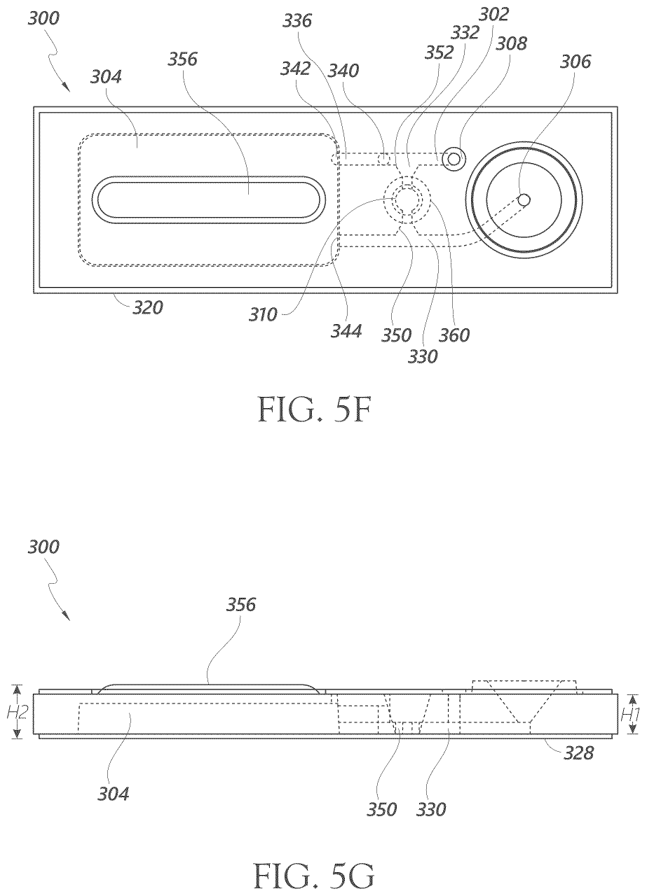

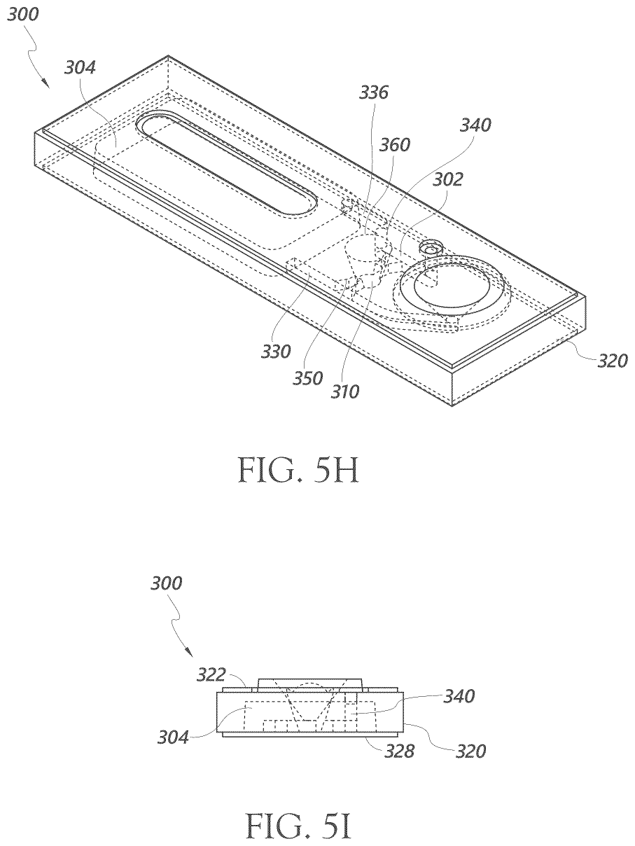

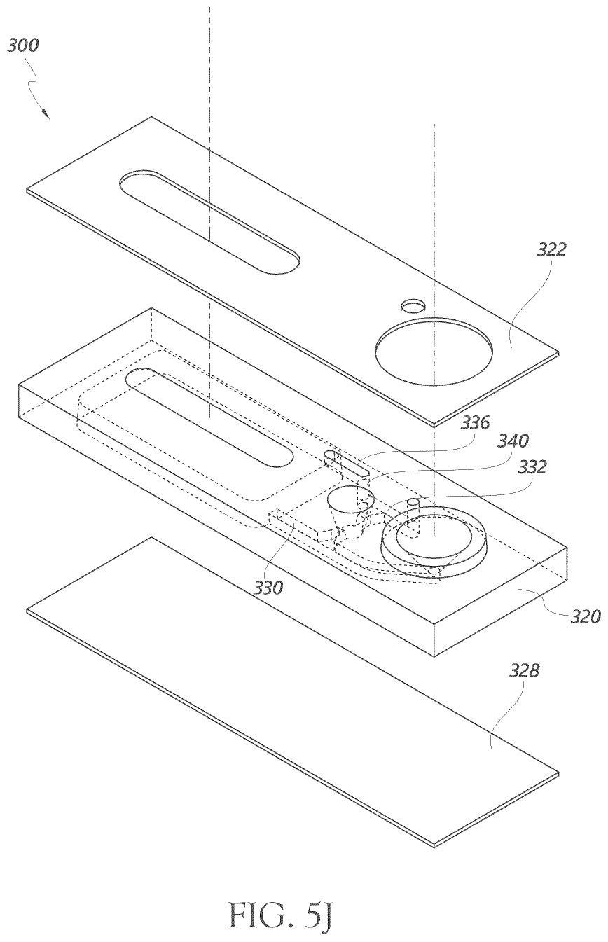

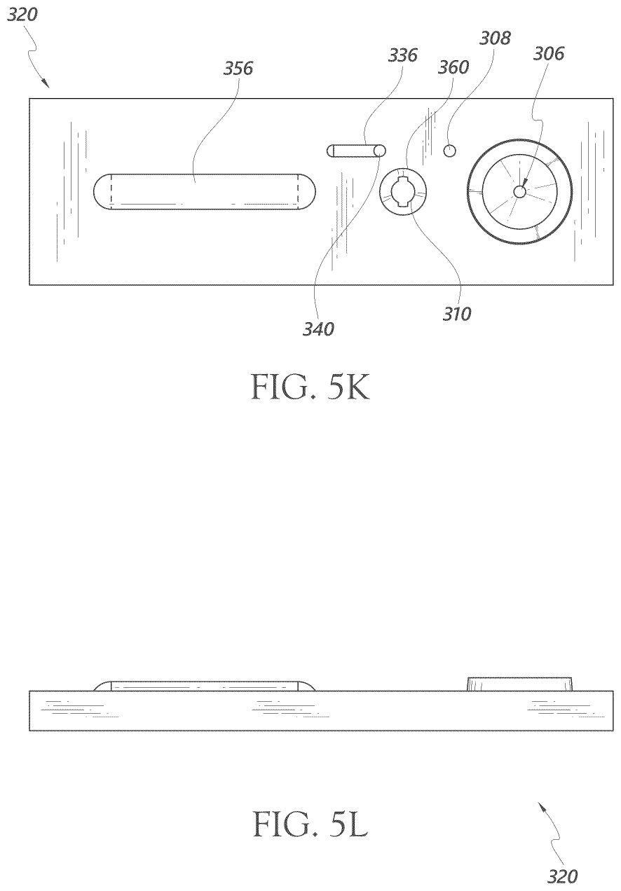

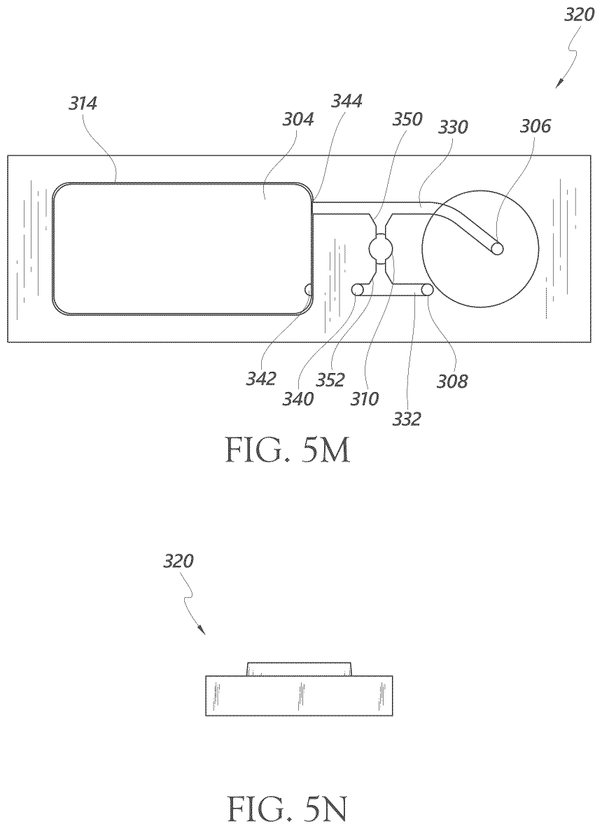

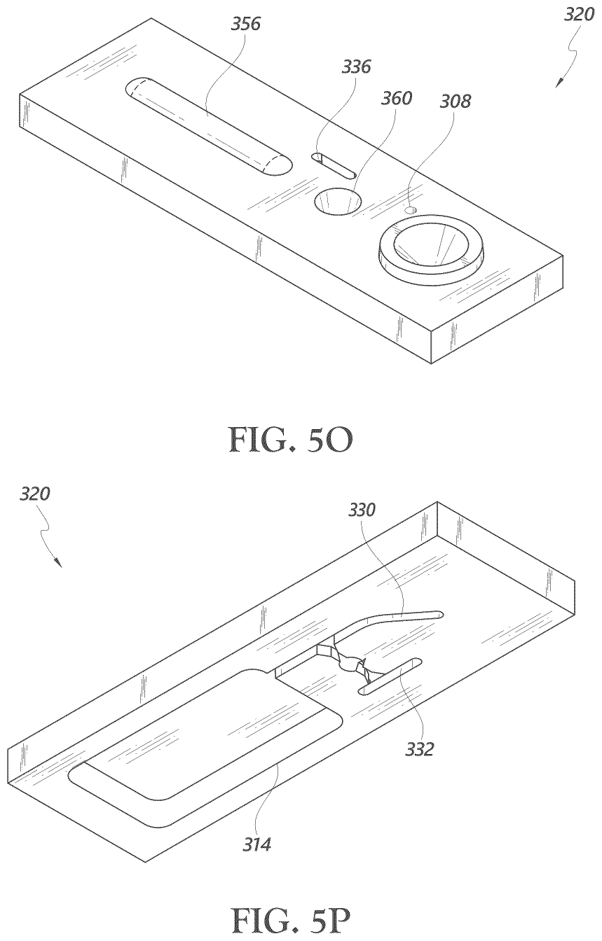

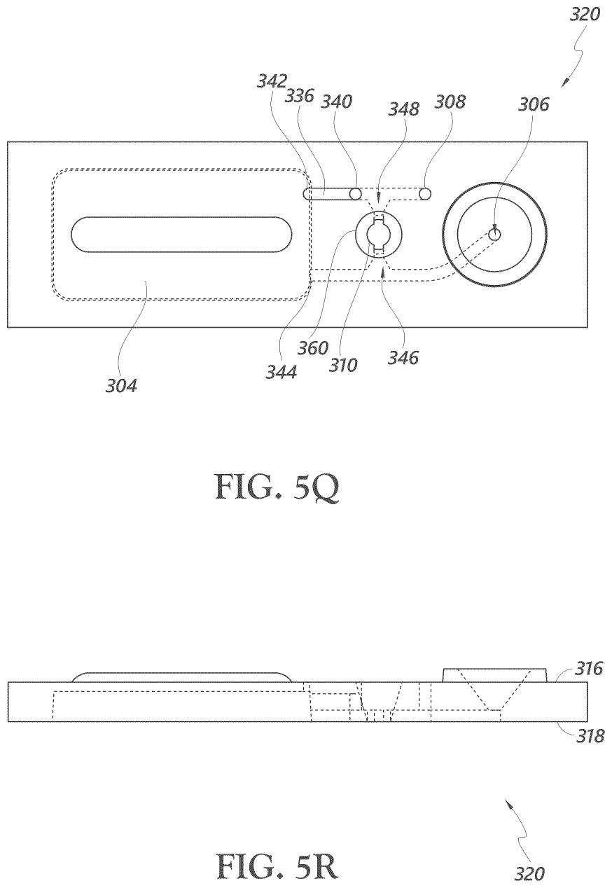

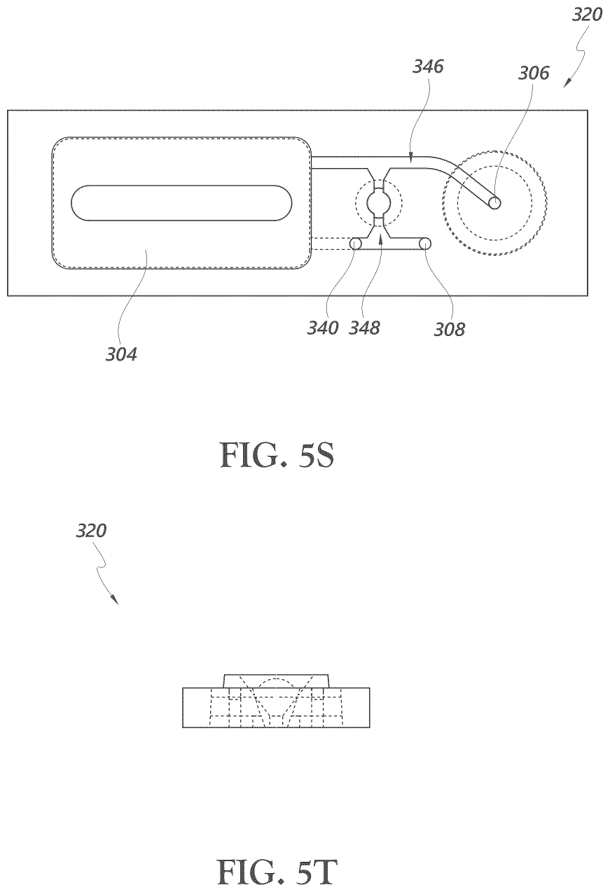

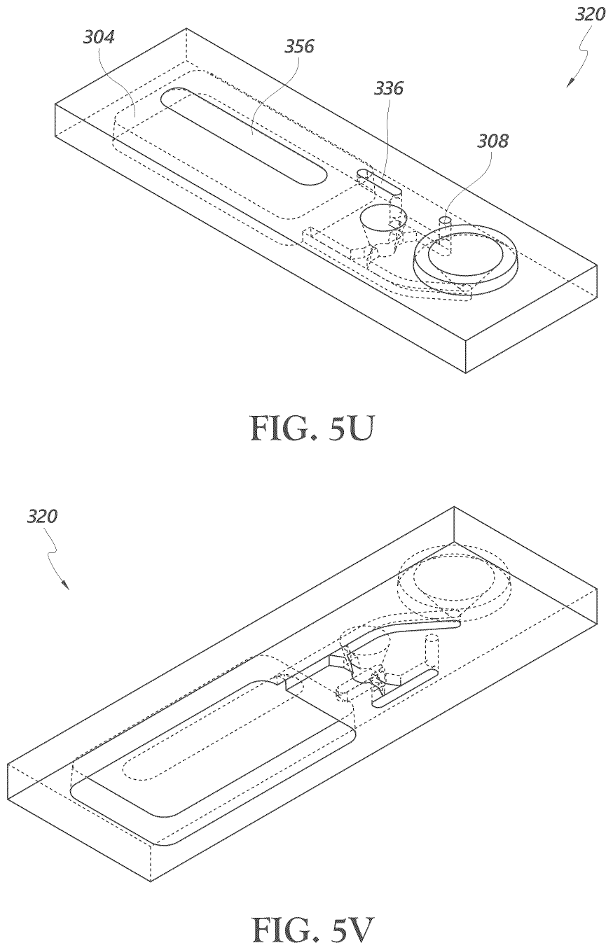

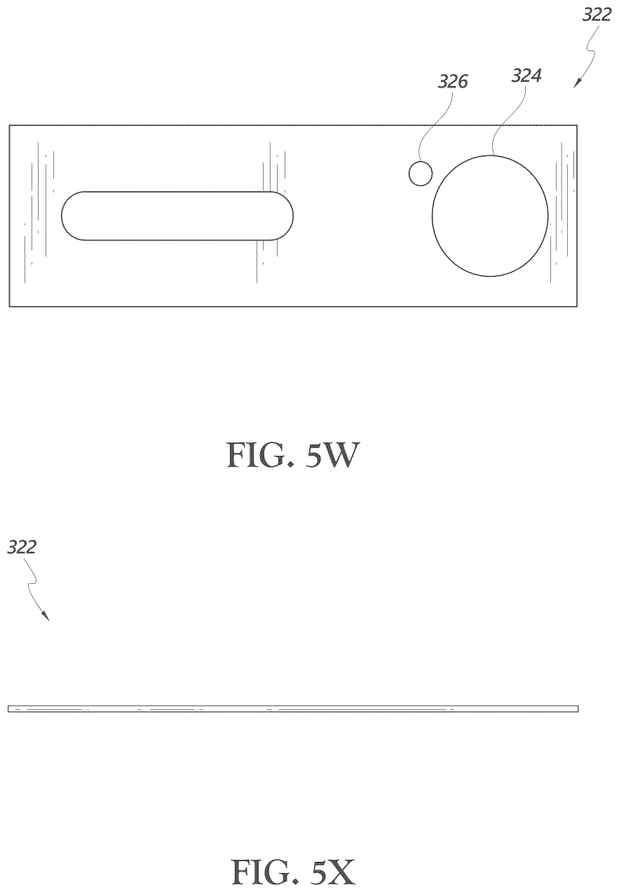

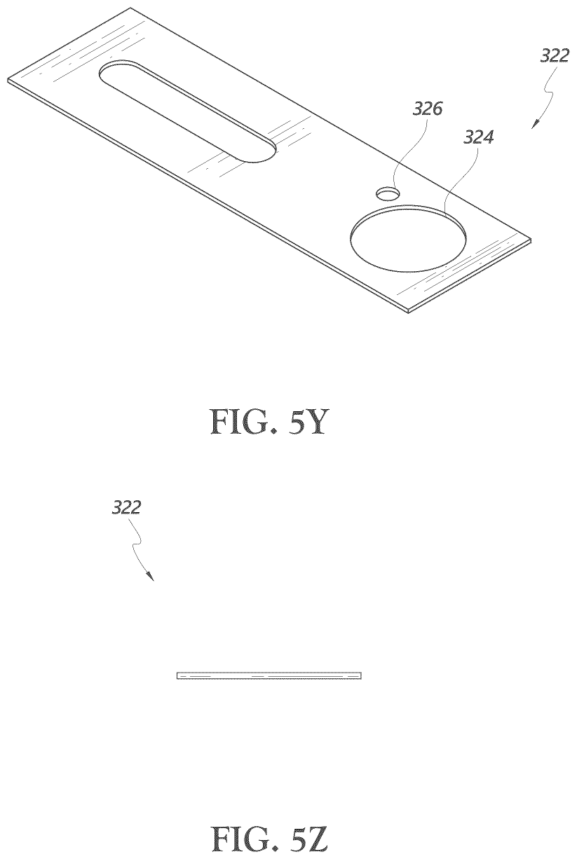

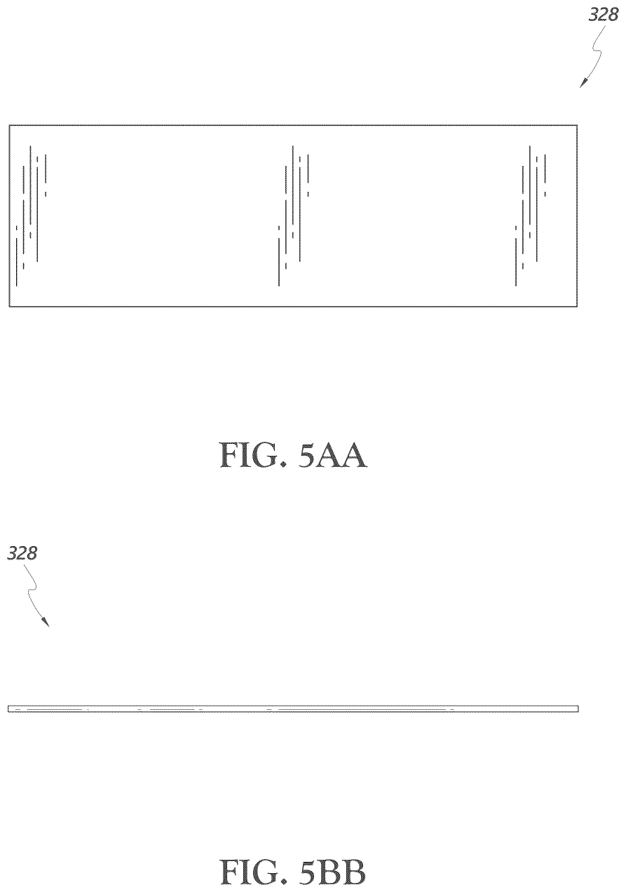

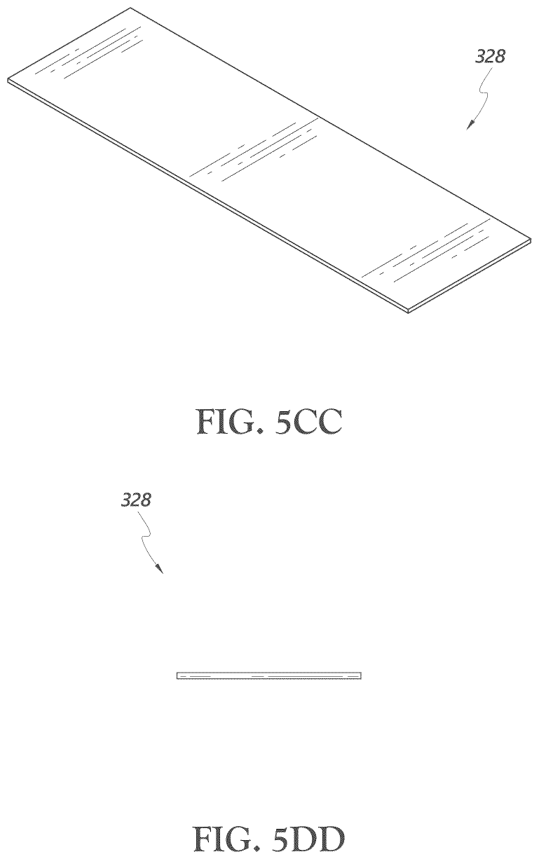

FIGS. 5A-5DD show views of an example of a single lane cartridge;

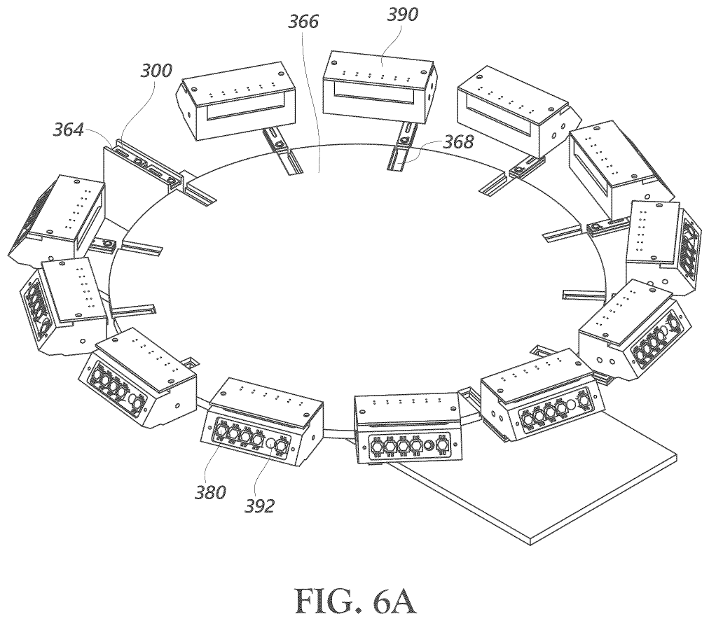

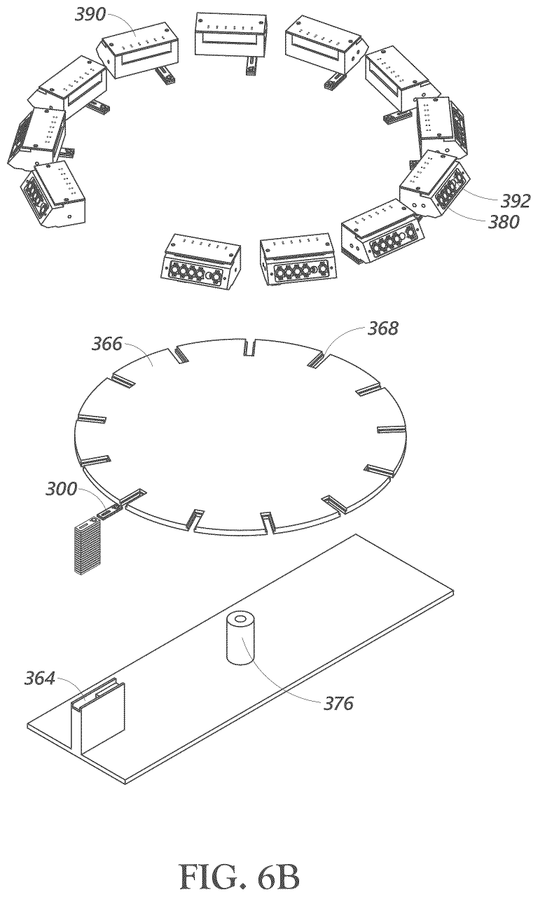

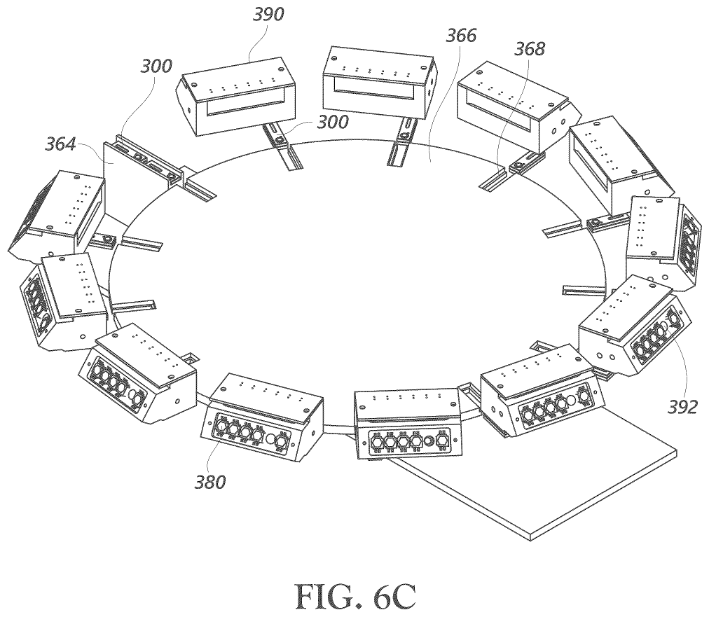

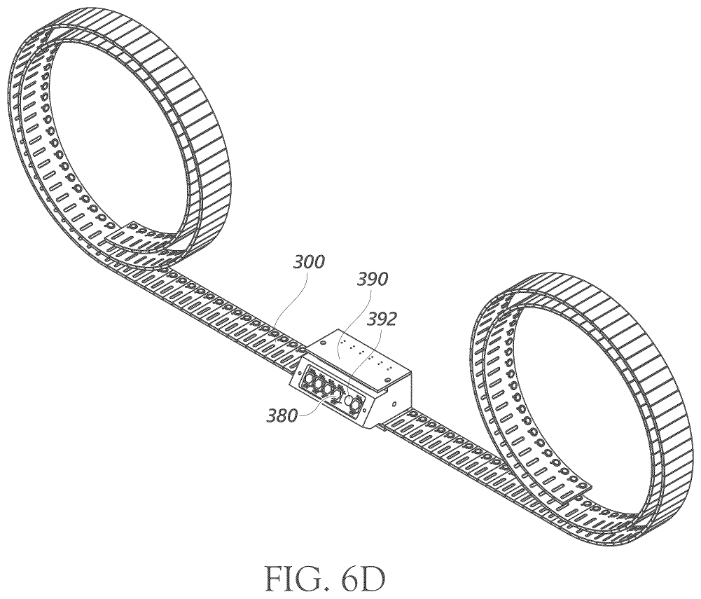

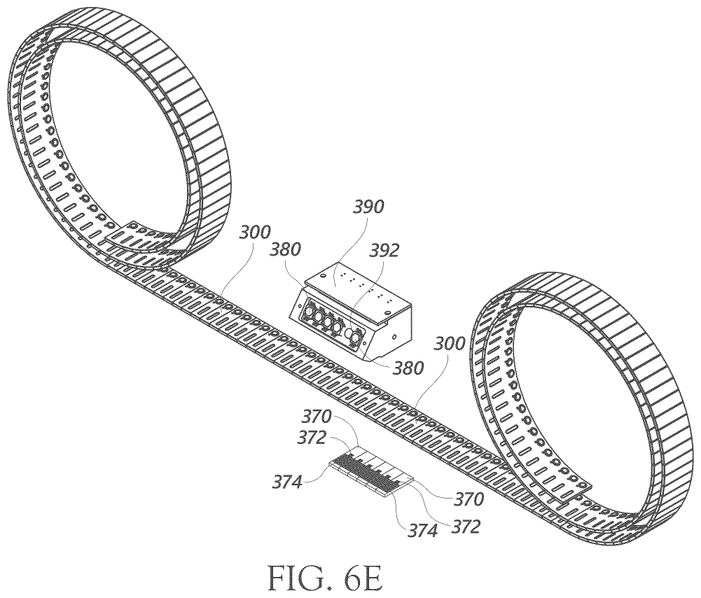

FIGS. 6A-6E show views of an example of assemblies in combination of the single lane cartridge of FIGS. 5A-5DD.

### DETAILED DESCRIPTION

The present technology relates to a device that is configured to carry out amplification, such as by PCR, of one or more polynucleotides from a sample. Unless specifically made clear to the contrary, where the term PCR is used herein, any variant of PCR including but not limited to real-time and quantitative, and any other form of polynucleotide amplification is intended to be encompassed.

The cartridge can be configured so that it receives thermal energy from one or more heating elements present in an external apparatus with which the cartridge is in thermal communication. The present technology provides for an apparatus for detecting polynucleotides in a sample, particularly from a biological sample. The technology more particularly relates to systems that carry out PCR on nucleotides of interest within amplification chambers and detect those polynucleotides. The cartridge is configured to accept a single sample. In some embodiments, the heater assembly is configured to carry out amplification on a plurality of cartridges in parallel. In some embodiments, the heater assembly is configured to carry out amplification on each cartridge individually, or carry out amplification on some cartridges individually, or carry out amplification on some cartridges simultaneously, or carry out amplification on all cartridges individually, or carry out amplification on all cartridges simultaneously.

By cartridge is meant a unit that may be disposable, or reusable, in whole or in part, and that is configured to be used in conjunction with some other apparatus that has been suitably and complementarily configured to receive and operate on (such as deliver energy to) the cartridge. The cartridge can process the sample by increasing the concentration of a polynucleotide to be determined and/or by reducing the concentration of inhibitors relative to the concentration of polynucleotide to be determined. In various embodiments, the microfluidic network can be configured to couple heat from an external heat source to a sample mixture comprising PCR reagents and a neutralized polynucleotide sample under thermal cycling conditions suitable for creating PCR amplicons from the neutralized polynucleotide sample. At least the external heat source may operate under control of one or more computer processors, configured to execute computer readable instructions for operating one or more components of the cartridge and for receiving signals from a detector that measures fluorescence from one or more of the PCR reaction chambers.

The cartridge can be configured to receive volumes of sample, and/or reagent, and/or amplified polynucleotide that are from about 1 μl to about 500 μl, such as from 1-200 μl, or from 50-150 μl, or from 50-100 μl, or from 100-150 μl. In some embodiments, the volume is greater than 50 μl for deep wells as described herein. In some embodiments, the maximum volume of the well is 84 μl. In some embodiments, the volume is greater than 100 μl for deep wells as described herein. In some embodiments, the maximum volume of the well is about 126 μl.

Certain ranges are presented herein with numerical values being preceded by the term “about.” The term “about” is used herein to provide literal support for the exact number that it precedes, as well as a number that is near to or approximately the number that the term precedes, such as variations of ±10% or less, ±1-5% or less, ±1% or less, and ±0.1% or less from the specified value. In determining whether a number is near to or approximately a specifically recited number, the near or approximating unrecited number may be a number which, in the context in which it is presented, provides the substantial equivalent of the specifically recited number.

One aspect of the present technology relates to a cartridge having a single sample lane. The single sample lane is independently associated with a given sample. The cartridges can be arranged relative to a heater assembly and a detector so that analyses can be carried out in two or more of the cartridges in parallel, for example simultaneously. A sample lane is an independently controllable set of elements by which a sample can be analyzed, according to methods described herein as well as others known in the art. A sample lane includes at least a sample inlet, and a microfluidic network having one or more microfluidic components, as further described herein.

Embodiments of the present technology include a cartridge having a single sample lane. It will be understood, however, that embodiments of the present technology can be implemented in a cartridge including a plurality of sample lanes. A multi-lane cartridge is configured to accept a number of samples in series or in parallel, simultaneously or consecutively. In some embodiments the multi-lane cartridge is configured to accept 12 samples, or any other suitable number of samples. In some instances, the multi-lane cartridge is configured to accept at least a first sample and a second sample, where the first sample and the second sample each contain one or more polynucleotides in a form suitable for amplification. The polynucleotides in question may be the same as, or different from one another, in different samples and hence in different sample lanes of the cartridge.

A non-limiting implementation of a microfluidic cartridge according to the present technology will now be described with reference to FIGS. 1A-1DD. FIGS. 1A-1E show views of a cartridge 100. FIG. 1A shows a top view of the cartridge 100. FIG. 1B shows a side view of the cartridge 100. FIG. 1C shows a perspective view of the cartridge. FIG. 1D shows another side view of the cartridge 100. FIG. 1E shows an exploded view of the cartridge 100.

FIGS. 1F-1J show views of the cartridge 100 with the phantom lines of the network of the cartridge 100. FIG. 1F shows a top view of the cartridge 100. FIG. 1G shows a side view of the cartridge 100. FIG. 1H shows a perspective view of the cartridge. FIG. 1I shows another side view of the cartridge 100. FIG. 1J shows an exploded view of the cartridge 100.

FIGS. 1K-1P show views of a substrate layer of the cartridge 100. FIG. 1K shows a top view of the substrate layer of the cartridge 100. FIG. 1L shows a side view of the substrate layer of the cartridge 100. FIG. 1M shows a bottom view of the substrate layer of the cartridge 100. FIG. 1N shows another side view of the substrate layer of the cartridge 100. FIG. 1O shows a top perspective view of the substrate layer of the cartridge 100. FIG. 1P shows a bottom perspective view of the substrate layer of the cartridge 100.

FIGS. 1Q-1V show views of the substrate layer of the cartridge 100 with phantom lines of the network. FIG. 1Q shows a top view of the substrate layer of the cartridge 100. FIG. 1R shows a side view of the substrate layer of the cartridge 100. FIG. 1S shows a bottom view of the substrate layer of the cartridge 100. FIG. 1T shows another side view of the substrate layer of the cartridge 100. FIG. 1U shows a top perspective view of the substrate layer of the cartridge 100. FIG. 1V shows another top perspective view of the substrate layer of the cartridge 100.

FIGS. 1W-1Z show views of a top layer of the cartridge 100. FIG. 1W shows a top view of the top layer of the cartridge 100. FIG. 1X shows a side view of the top layer of the cartridge 100. FIG. 1Y shows a perspective view of the top layer of the cartridge 100. FIG. 1Z shows another side view of the top layer of the cartridge 100.

FIGS. 1AA-1DD show views of a bottom layer of the cartridge 100. FIG. 1AA shows a top view of the bottom layer of the cartridge 100. FIG. 1BB shows a side view of the bottom layer of the cartridge 100. FIG. 1CC shows a perspective view of the bottom layer of the cartridge 100. FIG. 1DD shows another side view of the bottom layer of the cartridge 100.

The cartridge 100 includes a single sample lane. The cartridge 100 includes a network 102. The network 102 is typically configured to carry out amplification, such as by PCR, on a PCR-ready sample. It will be understood that embodiments of the systems, devices, and methods of the present disclosure are not limited to amplification, and can be implemented in any method that involves transfer of thermal energy to a sample. The network 102 can accept and amplify a nucleic acid-containing sample extracted from a specimen using any suitable method. In examples of cartridges that accept a PCR-ready sample, the sample can include a mixture including PCR reagents and the neutralized polynucleotide sample, suitable for subjecting to thermal cycling conditions that create PCR amplicons from the neutralized polynucleotide sample. In one example, the PCR-ready sample includes a PCR reagent mixture comprising a polymerase enzyme, a positive control plasmid, a fluorogenic hybridization probe selective for at least a portion of the plasmid and a plurality of polynucleotides, and at least one probe that is selective for a polynucleotide sequence. In embodiments of the present technology, the network is configured to couple heat from an external heat source with the mixture comprising the PCR reagent and the neutralized polynucleotide sample under thermal cycling conditions suitable for creating PCR amplicons from the neutralized polynucleotide sample.

The cartridge 100 includes a reaction chamber 104. The cartridge 100 can include a single reaction chamber 104. The cartridge 100 can include an inlet 106. The inlet 106 can be preferably configured to receive a pipette or the bottom end of a PCR tube and thereby accept sample for analysis with minimum waste, and with minimum introduction of air. In some embodiments, the inlet 106 is configured to accept a liquid transfer member such as a syringe, a pipette, or a PCR tube containing a PCR ready sample. In some embodiments, the inlet 106 can be manufactured conical in shape with an appropriate conical angle so that industry-standard pipette tips (2 μl, 20 μl, 200 μl, volumes, etc.) fit snugly therein. The cartridge 100 may be adapted to suit other, later-arising, industry standards not otherwise described herein, as would be understood by one of ordinary skill in the art. In some embodiments, the inlet 106 is configured so as to prevent subsequent inadvertent introduction of sample into a given lane after a sample has already been introduced into that lane. The configuration of the inlet 106 can be compatible with an automatic pipetting machine. The sample-containing fluid can be pumped into the reaction chamber 104 from the inlet 106 under influence of force from the sample injection operation. When transferring a sample from a liquid dispenser, such as a pipette tip, to the inlet 106 on the cartridge 100, a volume of air can be simultaneously introduced into the network 102. In some embodiments, the volume of air is between about 0.5 mL and about 5 mL. The cartridge 100 can include a vent 108. The vent 108 can facilitate expelling gas from the cartridge 100 when the reaction chamber 104 is being filled. The gas can be ambient air, for example. The cartridge 100 can include a valve 110. The valve 110 can seal the reaction chamber 104 during amplification. For example, the valve 110 can seal the reaction chamber 104 by obstructing channels leading to and from the reaction chamber 104, as explained in detail below.

The reaction chamber 104 is a deep well reaction chamber designed for amplification, such as PCR. The reaction chamber 104 can be similar to reaction chambers of multi-lane cartridge, but differs in several key aspects. Rather than having multiple lanes to carry out multiple reactions simultaneously, the cartridge 100 can be designed for carrying out single reactions. The single sample lane cartridge can provide greater random access. The single sample lane can allow the consumption of as many reaction vessels as required, leading to less waste of cartridges, reagents and other inputs for amplification.

The volume of the reaction chamber 104 is significantly larger than the reaction chambers in other known cartridges. In some embodiments, the reaction chamber 104 can hold volumes between 50 μl and 150 μl. The reaction chamber 104 advantageously can carry out reactions requiring larger sample sizes that may be necessary to detect very low analyte levels or for quantitative analysis. The reaction chamber 104 can be designed for detection of viral loads, which benefit from larger volumes of additive chemistry.

The reaction chamber 104 can be a very thin walled chamber. The thin walled chamber can reduce thermal resistance for applying heat to the reaction chamber 104. The thin walled chamber can maximize the rapid thermal cycling of the sample. The reaction chamber 104 can have uniform wall thickness. The reaction chamber 104 can have a wall of 1 mm or less, 2 mm or less, 3 mm or less, 4 mm or less, 5 mm or less, or any range of two of the foregoing values.

In some embodiments, the reaction chamber 104 can be a conical shape. The conical shape can advantageously concentrate the PCR-ready sample in the bottom of the reaction chamber 104. The reaction chamber 104 can be shaped to correspond with a heater assembly described herein. The reaction chamber 104 can be matched to the cone angles of a detector described herein. Another benefit of this shape can include greater uniformity of temperature control.

The valve 110 is configured for robust sealing of the reaction chamber 104. The valve 110 contains geometry to take advantage of microfluidic properties for effective sealing. The valve 110 can seal one or more channels. The valve 110 can seal one or more sides of the reaction chamber 104. The valve 110 can seal an upstream end and a downstream end of the reaction chamber 104. The valve 110 can seal two channels simultaneously. The valve 110 can seal two channels consecutively.

The cartridge 100 be constructed from a number of layers. The cartridge 100 can include one layer, two layers, three layers, four layers, five layers, or any range of two of the foregoing values. One or more layers can define the network 102. One or more layers can define various components configured to carry out PCR on a sample in which the presence or absence of one or more polynucleotides is to be determined.

The cartridge 100 can include a substrate layer 120. The substrate layer 120 can form the cartridge body. The substrate layer 120 can include the network 102, or a portion thereof. The substrate layer 120 can include one or more channels formed in a surface thereof. The substrate layer 120 can include one or more channels formed on a top surface thereof. The substrate layer 120 can include one or more channels formed on a bottom surface thereof. The substrate layer 120 can include one or more channels that extend the thickness of the substrate layer 120. The substrate layer 120 can include at least one channel that extends entirely through the substrate layer. The substrate layer 120 can form a portion of the reaction chamber 104. The reaction chamber 104 can include an opening 114 on a top surface of the substrate layer 120. The reaction chamber 104 can extend through the substrate layer 120. The reaction chamber 104 can extend past a bottom surface of the substrate layer 120. The reaction chamber 104 can form a closed end. The substrate layer 120 can include a first side 116. The first side 116 can be a top surface of the substrate layer 120. The substrate layer 120 can include a second, opposite side 118. The second side 118 can be a bottom surface of the substrate layer 120. The substrate layer 120 can include the channels connected to the valve 110 on the second side 118. The substrate layer 120 can include the vent 108 on the first side 116. The substrate layer 120 can include the wax loading hole or reservoir of the valve 110 on the first side 116. The substrate layer 120 can include the opening 114 of the reaction chamber 104 on the first side 116. In some embodiments, it is advantageous that all of the network defining structures are defined in the same, single substrate layer 120. This attribute facilitates manufacture and assembly of the cartridge 100.

The substrate layer 120 can be molded from a plastic or polymer. In some embodiments, the substrate layer 120 is injection molded from zeonor plastic (cyclic olefin polymer). The construction of the cartridge 100 can include a single injection molded plastic body. The substrate layer 120 can be formed from any material that is rigid and non-deformable. Rigidity is advantageous because it facilitates effective and uniform contact with the heater assembly. The substrate layer 120 can be formed from any material that is non-venting to air and other gases. Use of a non-venting material is advantageous because it reduces the likelihood that the contents of the reaction chamber will change during analysis. The substrate layer 120 can be formed from any material that has a low auto-fluorescence to facilitate detection of polynucleotides during an amplification reaction performed in the reaction chamber 104. Use of a material having low auto-fluorescence can be advantageous so that background fluorescence does not detract from measurement of fluorescence from the analyte of interest.

The cartridge 100 can further include a top layer 122. The top layer 122 can form a cover over the substrate layer 120. The top layer 122 can contact the first side 116 of the substrate layer 120 when the cartridge 100 is assembled. The top layer 122 can include an opening 124 for the inlet 106. The top layer 122 can include an opening 126 for the vent 108. The top layer 122 can cover one or more components of the network 102. The top layer 122 can include the network 102, or a portion thereof. The top layer 122 can form a top surface of the reaction chamber 104. The top layer 122 can form a top surface of one or more channels. The top layer 122 can form a top surface of the reservoir of the valve 110. The top layer 122 can include a plastic or polymer material. The top layer 122 can be transmissible to light used in any suitable detection method, for example excitation and emission light used in fluorescence detection. In other embodiments that do not detect an analyte of interest using light, the top layer 122 can be transmittal to other types of signals (for example but not limited to thermal signals, magnetic signals, electrical signals). In some embodiments, detection of an analyte of interest does not involve top layer 122. For example, after heating of a sample in the reaction chamber 104, an instrument can pierce the top layer 122 and extract sample from the reaction chamber 104 for off-cartridge detection.

The cartridge 100 can further include a bottom layer 128. The bottom layer 128 can form a cover below the substrate layer 120. The bottom layer 128 can contact the second side 118 of the substrate layer 120 when the cartridge 100 is assembled. The bottom layer 128 can include an opening 158 for the reaction chamber 104. The bottom layer 128 can underlie one or more components of the network 102. The bottom layer 128 can include the network 102, or a portion thereof. The bottom layer 128 can form a bottom surface of one or more channels. The bottom layer 128 can include a plastic or polymer material. The top layer 122 and the bottom layer 128 can be the same material. The top layer 122 and the bottom layer 128 can be different materials. The top layer 122 and the bottom layer 128 can be bonded to the substrate layer 120. The top layer 122 and the bottom layer 128 can be adhered with adhesive. The top layer 122 and the bottom layer 128 can be heat sealable.

In some embodiments, the cartridge 100 consists of three layers. In various embodiments, one or more such layers are optional. The cartridge 100 can include the substrate layer 120. The substrate layer 120 can form the cartridge body. The cartridge 100 can include the top layer 122. The cartridge 100 can include the bottom layer 128. The cartridge 100 can include one or more additional layers. The cartridge 100 can include a hydrophobic vent membrane layer. The hydrophobic vent membrane layer can be positioned over the vent 108. The hydrophobic vent membrane layer can be porous to allow gas, but not liquid, to escape the cartridge 100. The cartridge 100 can include a computer-readable label. The label can include a bar code, a radio frequency tag or one or more computer-readable characters.

The substrate layer 120 can include the inlet 106. The top layer 122 can include the opening 124 which allows entry of a pipette tip. The substrate layer 120 can include the vent 108. The top layer 122 can include the opening 126 which allows the escape of gases from the cartridge 100. The substrate layer 120 can include the reaction chamber 104. The bottom layer 128 can include the opening 158 which accommodates the downward projection of the reaction chamber 104.

The substrate layer 120 can include one or more components of the network 102. The substrate layer 120 can include a lower channel set 130, 132, molded into the bottom of the substrate layer 120. Portions of the lower channel set 130, 132 can be grooves formed in the second side 118 of the substrate layer 120. The lower channel set 130, 132 can be formed by the substrate layer 120 and the bottom layer 128. The bottom layer 128 can form a bottom surface of the lower channel set 130, 132. The lower channel set 130, 132 can include a first lower channel 130. The first lower channel 130 can connect to the inlet 106. The first lower channel 130 can connect to the valve 110. The lower channel set 130, 132 can include a second lower channel 132. The second lower channel 132 can connect to the vent 108. The second lower channel 132 can connect to the valve 110. The lower channel set 130, 132 can form an H-shape. The lower channel set 130, 132 can be sealed by the valve 110.

The substrate layer 120 can include an upper channel set 134, 136, molded into the top of the substrate layer 120. Portions of the upper channel set 134, 136 can be grooves formed in the first side 116 of the substrate layer 120. The upper channel set 134, 136 can be formed by the substrate layer 120 and the top layer 122. The top layer 122 can form a top surface of the upper channel set 134, 136. The upper channel set 134, 136 can include a first upper channel 134. The first upper channel 134 can connect to the reaction chamber 104. The upper channel set 134, 136 can include a second upper channel 136. The second upper channel 136 can connect to the reaction chamber 104. The upper channel set 134, 136 can extend radially outward from the reaction chamber 104. The upper channel set 134, 136 can connect to the upper edge 142 of the reaction chamber 104. The upper edge 142 can be formed by the opening 114.

The substrate layer 120 can include one or more through channels or vias 138, 140. The through channels 138, 140 can extend entirely through the substrate layer 120. The through channels 138, 140 can have a substantially vertical orientation relative to the first side 116 and the second side 118 of the substrate layer 120. The through channels 138, 140 need not be vertical, and can be skewed relative to vertical. The through channels 138, 140 can extend between an upper surface of the substrate layer 120 and a lower surface of the substrate layer 120. The through channels 138, 140 can include a first through channel 138. The first through channel 138 can connect the first lower channel 130 and the first upper channel 134. The through channels 138, 140 can include a second through channel 140. The second through channel 140 can connect the second lower channel 132 and the second upper channel 136.

The network 120 can include a fill channel 146. The fill channel 146 can connect the inlet 106 to the reaction chamber 104. The fill channel 146 can include the first lower channel 130. The first lower channel 130 can lead from the inlet 106. The first lower channel 130 can pass by and in close proximity to the valve 110. The fill channel 146 can include the first through channel 138. The fill channel 146 can include a transition from the lower surface to the upper surface of the substrate layer 120. The fill channel 146 can include the first upper channel 134. The fill channel 146 can allow the reaction chamber 104 to fill from the top. For example, the fill channel 146 can allow the reaction chamber 104 to fill from the upper edge 142 at the top surface of the reaction chamber 104. The fill channel 146 can be shaped to maximize the size of the reaction chamber 104. A portion of the total volume of the reaction chamber 104 can be located entirely between a plane formed by the first side 116 and a plane formed by the second side 118. The fill channel 146 can lead from the inlet 106, passing by the valve 110, leading to the first through channel 138 to the top side of the substrate layer 120, and terminating at the reaction chamber 104. Alternatively, the fill channel 146 can have any another configuration.

The network 102 can include a vent channel 148. The vent channel 148 can connect the reaction chamber 104 to the vent 108. The vent channel 148 can include the second upper channel 136. The second upper channel 136 can lead from the reaction chamber 104. The vent channel 148 can include the second through channel 140. The vent channel 148 can include the second lower channel 132. The second lower channel 132 can pass by and in close proximity to the valve 110. The second lower channel 132 can lead to the vent 108. The vent 108 can extend through the substrate layer 120. The vent 108 can be on the upper side of the substrate layer 120. The vent channel 148 can include a transition from the lower surface to the upper surface of the substrate layer 120. The vent channel 148 can allow the reaction chamber 104 to vent gases from the top of the reaction chamber 104. For example, the vent channel 148 can allow gases to escape the reaction chamber 104 from the upper edge 142 at the top surface of the reaction chamber 104. The vent channel 148 can be shaped to maximize the size of the reaction chamber 104. The vent channel 148 can lead from the reaction chamber 104, leading to the second through channel 140 to the bottom side of the substrate layer 120, passing by the valve 110, and terminating at the vent 108. The vent 108 can extend through the substrate layer 120. The vent 108 can allow gas to escape from the top side of the substrate layer 120. In other embodiments, the vent 108 does not extend through the substrate layer 120 and the vent 108 can allow gas to escape from on the bottom side of the substrate layer 120. The vent 108 can exit the cartridge 100 on either the top surface through a via as embodied here, or directly to the bottom surface. The vent 108 can be integrated with the cartridge design. The vent can be placed relative to a heater assembly as described herein to allow effective venting. Alternatively, the vent channel 148 can have any another configuration.

The valve 110 can include specially designed channels 150, 152 that promote sealing. The substrate layer 120 can include a first valve channel 150. The first valve channel 150 can be connected to the first lower channel 130. The first valve channel 150 can have increasing width as the first valve channel 150 progresses toward the first lower channel 130. The substrate layer 120 can include a second valve channel 152. The second valve channel 152 can be connected to the second lower channel 132. The second valve channel 152 can have increasing width as the second valve channel 152 progresses toward the second lower channel 132. The increasing width of the valve channels 150, 152 can promote microfluidic pull or capillary action. The valve channels 150, 152 can be configured to pull a sealable material toward the lower channels 130, 132.

The valve 110 can include a sealable material. The sealable material can be positioned at the second side 118 of the substrate layer 120. The sealable material can block passage of material from the first valve channel 150 to the second valve channel 152. The sealable material can be relatively immobile. The sealable material can be located at a defined spot at the bottom of the valve 110. The sealable material can be loaded and flow toward the defined spot. The sealable material can solidify in the defined spot. The sealable material can be positioned before a sample is loaded on the cartridge. The sealable material during filling of the reaction chamber 104 serves a function. The sealable material, before the valve 110 has even been activated, prevents the flow of sample from the fill channel 146 to the vent channel 148. The sample is prevented from flowing from the first lower channel 130 through the valve channels 150, 152 to the second lower channel 132. The sealable material prevents the filling of the vent channel 148 with sample. The sealable material facilitates the flow of sample along the fill channel 146 to the reaction chamber 104. The sealable material prevents the vent channel 148 from filling with sample, thereby keeping the vent channel 148 open for the flow of gas. The sealable material insulates the entire vent-side of the cartridge from fluid flow. The sealable material prevents sample from flowing through the valve 110 and out the vent 108.

The valve 110 isolates the fill channel 146 from the vent channel 148. The valve 110 serves an isolating purpose or function for the flow of fluid before the valve 110 is actuated. The valve 110 isolates the vent channel from the flow of fluid before the valve 110 is actuated. The valve 110 allows the fluid to flow in one direction, toward the reaction chamber 104. The valve 110 prevents the fluid from branching into two channels. The valve 110 prevents the fluid from flowing to the vent 108. The valve 110 isolates the vent 108 from the flow of fluid before actuation of the valve. The valve 110 maintains the vent channel 148 free of fluid to allow gas to pass. The valve 110 serves an isolating purpose or function after the valve 110 is actuated. The valve 110 serves an isolating purpose or function for both fluid and gas, preventing movement past the valve 110 to the inlet 106 and the vent 108. The valve 110 is actuated to provide a seal for the fill channel 146 and the vent channel 148. The valve 110 is actuated to block the channels leading from the reaction chamber 104. The valve 110 in combination with the structure of the cartridge provides two functions, one function before actuation of the valve 110 and one function after actuation of the valve 110. This two-function feature of the cartridge is distinguishable from other cartridges. In other cartridges, a valve may not serve to block or obstruct fluid flow between two channels, or two sections of a channel, before actuation. The valve can be disposed in a side channel off of the main channel. The valve has only one function to block the main channel. The sample flows through the channel until the valve is actuated.

In contrast, the valve 110 isolates an entire half of the microfluidic network from sample, without even actuating the valve 110. The position of the sealable material isolates the vent channel 148 without actuating the valve 110. The positon of the sealable material prevent fluid flow into the vent channel 148.

The valve 110 can include a mass of a thermally responsive substance (TRS). The TRS is relatively immobile at a first temperature and more mobile at a second temperature. The first and second temperatures are insufficiently high to damage materials, such as polymer layers of the cartridge 100 in which the valve 110 is situated. A mass of TRS can be an essentially solid mass or an agglomeration of smaller particles that cooperate to obstruct the passage when the valve 110 is closed. Non-limiting examples of TRS include a eutectic alloy (e.g., a solder), wax (e.g., an olefin), polymers, plastics, and combinations thereof. The TRS can also be a blend of variety of materials, such as an emulsion of thermoelastic polymer blended with air microbubbles (to enable higher thermal expansion, as well as reversible expansion and contraction), polymer blended with expancel material (offering higher thermal expansion), polymer blended with heat conducting microspheres (offering faster heat conduction and hence, faster melting profiles), or a polymer blended with magnetic microspheres (to permit magnetic actuation of the melted thermoresponsive material).

In some embodiments, the second temperature where the TRS is more mobile is less than about 90° C. and the first temperature where the TRS is relatively immobile is less than the second temperature (e.g., about 70° C. or less). Typically, a reservoir 160 is in gaseous communication with the mass of TRS. The valve 110 is in communication with a source of heat that can be selectively applied to the reservoir 160 and to the TRS. Upon heating gas (e.g., air) in the reservoir 160 and heating the mass of TRS to the second temperature, gas pressure within the reservoir 160 due to expansion of the volume of gas, forces the mass of TRS to move into the valve channels 150, 152 and to the lower channel set 130, 132, thereby obstructing material from passing along the lower channel set 130, 132.

The valve 110 can include the reservoir 160. The reservoir 160 can, in some embodiments, contain a gaseous chamber. The gas can expand upon heating thereby urging the TRS from the reservoir 160. The TRS can also move by capillary action due to the cross-sectional shape of the valve channels 150, 152. The TRS can be injected into place in the valve 5110 such that when the reservoir 160 is heated, the liquefied TRS will flow, promoted by the expansion geometry, into the fill channel 146 and vent channel 148. The geometry of the valve channels 150, 152 can promote complete and robust sealing of the lower channels 130, 132. The relatively-mobile TRS will then solidify, thereby sealing off the lower channels 130, 130 when the TRS cools back into the solid state. The valve 110 can be closed prior to thermocycling to prevent or reduce any evaporation of liquid, bubble generation, or movement of fluid from the reaction chamber 104.

In some embodiments, the valve 110 is constructed by depositing a precisely controlled amount of a sealable material (such as wax) into a loading inlet machined in the substrate 120. In some embodiments, the loading inlet can be the reservoir 160. A combination of controlled hot drop dispensing into the cartridge 100 of the right dimensions and geometry is used to accurately load sealable material into the valve channels 150, 152 the cartridge 100 to form the valve 110.

In some embodiments, a heated dispenser head can be accurately positioned over the reservoir 160 in the cartridge 100, and can dispense molten sealable material drops in volumes as small as 75 nanoliters (nl) with an accuracy of 20%. A suitable dispenser is also one that can deposit amounts smaller than 100 nl with a precision of +/−20%. The dispenser can also be capable of heating and maintaining the dispensing temperature of the sealable material to be dispensed. For example, it may have a reservoir to hold the solution of sealable material. It is also desirable that the dispense head can have freedom of movement.

The reservoir 160 can be dimensioned in such a way that the droplet of 75 nl can be accurately propelled to the bottom of the reservoir 160 using, for example, compressed air, or in a manner similar to an inkjet printing method. The microfluidic cartridge can be maintained at a temperature above the melting point of the sealable material thereby permitting the sealable material to stay in a molten state immediately after it is dispensed. After the drop falls to the bottom of the reservoir 160, the sealable material is drawn into the narrow sections of the valve channels 150, 152 by capillary action. The volume of the narrow sections of the valve channels 150, 152 can be designed to be approximately equal to a maximum typical amount that is dispensed into the reservoir 160. The narrow sections of the valve channels 150, 152 can also be designed so that even though the sealable material dispensed may vary considerably between a minimum and a maximum shot size, the sealable material always fills up to, and stops at or before, the junction with the fill channel 146 and the vent channel 148 because the junction provides a higher cross section than that of the narrow sections of the valve channels 150, 152 and thus reduces the capillary forces.

An exemplary valve is shown in FIGS. 1F-1V. The valve 110 has the reservoir 160 containing TRS in contact with, respectively, each of two channels. The reservoir 160 can also serve as a loading port for TRS during manufacture of the valve. In order to make the valve sealing very robust and reliable, the valve channel 150 can flare outward toward the fill channel 146 (along which, e.g., sample passes). The valve channel 150 can have any suitable dimensions at the valve junction (for example 300 μm wide, and 150 μm thick). The fill channel 146, in particular the first lower channel 130, can have any suitable dimensions at the valve junction (for example 150 μm wide, and 150 μm thick). The fluid dynamics of the valve channel 150 can reliably and repeatably seal the first lower channel 130. In order to make the valve sealing very robust and reliable, the valve channel 152 can flare outward toward the vent channel 148 (along which, e.g., gas passes). The valve channel 152 can have any suitable dimensions at the valve junction (for example 300 μm wide, and 150 μm thick). The vent channel 148, in particular the second lower channel 132, can have any suitable dimensions at the valve junction (for example 150 μm wide, and 150 μm thick). The fluid dynamics of the valve channel 152 can reliably and repeatably seal the second lower channel 132.

The reservoir 160 can have a symmetrical design with respect to the fill channel 146 and the vent channel 148. The valve channels 150, 152 can have the same dimensions. The valve channels 150, 152 can be mirror image channels. The valve channels 150, 152 can be diametrically opposed. The valve channels 150, 152 can be on opposite sides of the reservoir 160. The valve channels 150, 152 can substantially equally fill with TRS. The reservoir 160 can be heated by a single heat source. The reservoir 160 can be heated to maintain a uniform temperature. The reservoir 160 can be heated to cause the TRS to flow with an equal or substantially equal volume from the valve 110 to the valve channels 150, 152 and then to the fill channel 146 and the vent channel 148. The valve 110 can be heated to cause the TRS to flow with an equal or substantially equal flow rate from the reservoir 160 to the valve channels 150, 152 and then to the fill channel 146 and the vent channel 148. The valve 110 can be heated to cause the TRS to flow equally or substantially equally from the reservoir 160 to seal the fill channel 146 and the vent channel 148.

The valve channels 150, 152 can have the same or substantially the same volume. The valve channels 150, 152 can simultaneously receive TRS from the reservoir 160. The valve channels 150, 152 can simultaneously receive the same or substantially the same volume of TRS from the reservoir 160. The valve channels 150, 152 can fill at the same or substantially the same rate. The valve channels 150, 152 can allow the simultaneous flow of TRS to seal the fill channel 146 and the vent channel 148 simultaneously.

The lower channel set 130, 132 can have the same dimensions at the valve intersection. The lower channel set 130, 132 can be mirror image channels in the vicinity of the valve 110. The lower channel set 130, 132 can be diametrically opposed relative to the reservoir 160. The lower channel set 130, 132 can be on opposite sides of the reservoir 160. The lower channel set 130, 132 can be parallel or substantially parallel. The lower channel set 130, 132 can form a junction with the valve channels 150, 152. The lower channel set 130, 132 can receive a portion of the TRS to prevent fluid or gas flow through the lower channel set 130, 132. The lower channel set 130, 132 can be sealed by TRS.

The fill channel 146 and the vent channel 148 can be sealed by the single valve 110. The fill channel 146 and the vent channel 148 can be sealed at the same time. The fill channel 146 and the vent channel 148 can be sealed with the same volume of TRS. The fill channel 146 and the vent channel 148 can be sealed simultaneously. The fill channel 146 and the vent channel 148 can be sealed with TRS flowing from the single reservoir 160. The TRS can be impenetrable to the flow of gas. Gas is prevented from flowing to the vent when the vent channel 148 is sealed. The TRS can be impenetrable to the flow of fluid. Fluid sample is prevented from flowing from the inlet 106 to the reaction chamber 104 when the fill channel 146 is sealed. Fluid sample is prevented from flowing from the reaction chamber 104 to the inlet 106 when the fill channel 146 is sealed.

In some embodiments, the actuation of the valve 110 causes equal or substantially equal flow rates of sealable material and sealing of the vent channel 148 and the fill channel 146. The actuation of the valve 110 seals both the fill channel 146 and the vent channel 148. The actuation of the valve 110 seals two channels 130, 132 simultaneously or substantially simultaneously. The actuation of the valve 110 seals two lower channels 130, 132. The actuation of the valve 110 seals two channels on the same side of the substrate layer 120. In some embodiments, the actuation of the valve 110 causes unequal or substantially unequal flow rates of sealable material and sealing of the vent channel 148 and the fill channel 146. The actuation of the valve 110 seals both the upstream and downstream channels with different volumes of material. The actuation of the valve 110 seals two channels 130, 132 at different times. The actuation of the valve 110 seals two lower channels 130, 132 sequentially.

Other configurations are contemplated. In some embodiments, the valve 110 has dual reservoirs containing TRS. One of the reservoirs is in fluid communication with the valve channel 150 and another reservoir is in fluid communication with the valve channel 152. The reservoirs can serve as loading ports for TRS during manufacture of the valve. The reservoirs can have a symmetrical design with respect to the fill channel 146 and the vent channel 148. The reservoirs can have an asymmetrical design with respect to the fill channel 146 and the vent channel 148. The reservoirs can receive the same volume of TRS or different volumes. The reservoirs can receive the same composition of TRS or different compositions.

The valve channels 150, 152 can have any cross-sectional shape. The valve channels 150, 152 can have the same dimensions. The valve channels 150, 152 can have different dimensions. The valve channels 150, 152 can have different shapes. The valve channels 150, 152 can have different configurations. The valve channels 150, 152 can equally fill from the respective reservoir. The valve channels 150, 152 can unequally fill from the respective reservoir.

The valve channels 150, 152 can form a T-junction with the fill channel 146 and the vent channel 148, respectively. The valve channels 150, 152 can have any shape to promote the flow of TRS outward from the respective reservoir. The fill channel 146 can have any suitable dimensions at the valve junction. The vent channel 148 can have any suitable dimensions at the valve junction.

The reservoirs can be heated by a single heat source. The reservoirs can be heated by two or more heat sources. The reservoirs can be separately heated. The reservoirs can be independently heated. The reservoirs can be heated in series. The reservoirs can be heated in parallel. The reservoirs can be heated sequentially. The reservoirs can be heated simultaneously. The reservoirs can be heated to different temperatures. The reservoirs can be heated with different heating gradients. The reservoirs can reach the second temperature to make the TRS mobile at the same time. The reservoirs can reach the second temperature to make the TRS mobile at different times. The reservoirs can be heated to cause the TRS to flow equally or unequally from the reservoirs to the valve channels 150, 152. The reservoirs can be heated to cause the TRS to flow equally or unequally from the reservoirs to seal the fill channel 146 and the vent channel 148.

In some embodiments, the actuation of the valve 110 causes unequal flow rates and sealing of the vent channel 148 and the fill channel 146. The valve 110 can be actuated by the application of heat to the reservoirs. The application of heat can be controlled by one or more processors. The application of heat can determine when the fill channel 146 and the vent channel 148 are sealed. The actuation of the valve 110 seals both the upstream and downstream channels leading from the reaction chamber 104. The actuation of the valve 110 seals both the fill channel 146 and the vent channel 148. The actuation of the valve 110 can seal channels 146, 148 sequentially. The actuation of the valve 110 can seal the fill channel 146 first and the vent channel 148 second. The actuation of the valve 110 can seal the vent channel 148 first and the fill channel 146 second.

In some embodiments, the structure of the channels causes unequal flow rates and sealing of the vent channel 148 and the fill channel 146. The channels can have unequal dimensions or volumes which impact flow rates. The construction of the channels can determine when the fill channel 146 and the vent channel 148 are sealed. In some embodiments, the valve channels 150, 152 of the valve 110 cause unequal flow rates and sealing of the vent channel 148 and the fill channel 146 at different start times or during different time windows. The valve channels 150, 152 can have different lengths, causing the TRS to seal one channel first. The valve channels 150, 152 can have different volumes, causing the TRS to seal one channel first. The valve channels 150, 152 can have different flow characteristics causing the TRS to seal one channel first. The valve channels 150, 152 can have different shapes, causing the TRS to seal one channel first. In some embodiments, the valve channels 150, 152 can have one or more constrictions that influence the flow of TRS. In some embodiments, the valve channels 150, 152 can have one or more flares or expansions that influence the flow of TRS. The valve 110 seals the lower channels 130, 132 by any combination of one or more reservoirs and one or more channels described herein.

The substrate layer 120 can include a reaction chamber 104. The reaction chamber 104 can be conical. The reaction chamber 104 can have a profile that tapers. The reaction chamber 104 can include an exterior bottom surface that is flat. The reaction chamber 104 can have an exterior bottom surface that is curved (or any other suitable contour). The reaction chamber 104 can have an interior bottom surface that is curved (or any other suitable contour). The reaction chamber 104 can have a shape to cause liquid contents to flow downward toward the bottom of the reaction chamber 104 as the liquid contents enter the reaction chamber 104. The reaction chamber 104 can have a truncated conical shape. The reaction chamber 104 can have any pointed or generally pointed shape. The reaction chamber 104 can gradually taper downward. The reaction chamber 104 can form a well in the cartridge 100.

The reaction chamber 104 can be a thin wall reaction chamber 104. The reaction chamber 104 can have thin walls compared to the volume of the reaction chamber 104. The reaction chamber 104 can have walls with a thickness between 10 μm and 100 μm. The reaction chamber 104 can have uniform wall thickness. The reaction chamber 104 can have non-uniform wall thickness. The reaction chamber 104 can have a thicker bottom wall than side wall. The reaction chamber 104 can have generally consistently thin walls. The reaction chamber 104 can effectively transfer heat across the wall thickness to heat the contents of the reaction chamber.

The reaction chamber 104 can receive a volume of sample. The reaction chamber 104 can be considered a deep well. The reaction chamber 104 can receive a volume of fluid greater than 50 μl. In some embodiments, the volume is greater than 100 μl. In some embodiments, the maximum volume of the reaction chamber 104 is 126 μl.

The reaction chamber 104 can project perpendicularly from the bottom of the substrate layer 120. The reaction chamber 104 can include a height H2 greater than the average height H1 of the substrate layer 120. The reaction chamber 104 can extend downward between 3 and 6 times the average height H1 of the substrate layer 120.

The positioning of the upper channel set 134, 136 allows the height of the reaction chamber 104 to be maximized. The upper channel set 134, 136 are on the top side of the substrate layer 120. The fill channel 146 can include the first upper channel 134. The vent channel 148 can include the second upper channel 136. The reaction chamber 104 is filled from the top of the reaction chamber 104. The sample flows into an entrance to the reaction chamber 104 from the top side of the substrate layer 120. The reaction chamber 104 is filled under the influence of gravity. The reaction chamber 104 vents from the top of the reaction chamber 104. The reaction chamber 104 is vented with gas (e.g., air) in the reaction chamber 104 being displaced from the bottom of the reaction chamber 104 toward the top of the reaction chamber 104.

The positioning of the lower channel set 130, 132 allows TRS to flow under the influence of gravity from the reservoir 150. The reservoir 160 is within an average height H1 of the substrate layer 120. The positioning of the lower channel set 130, 132 allows the height of the reservoir 160 to be maximized within the substrate layer 120. The height of the reservoir can be equal or substantially equal to the average height H1 of the substrate layer 120. The fill channel 146 can include the first lower channel 130. The vent channel 148 can include the second lower channel 132. The positioning of the lower channel set 130, 132 and the valve channels 150, 152 on the bottom side of the substrate layer 120 allows the height of the reservoir 160 to be maximized. The valve channel 150, 152 and the lower channel set 130, 132 are on the bottom side of the substrate layer 120. The reservoir 160 spans from the top side to the bottom side of the substrate layer 120. The reservoir 160 spans the average thickness of the substrate layer 120.

The positioning of the valve 110 allows sealing of both the fill channel 146 and the vent channel 148. The actuation of the valve 110 can allow simultaneous sealing, in some embodiments. The arrangement of the one or more reservoirs, the valve channel set 150, 152, and the lower channel set 130, 132 can allow simultaneous sealing, in some embodiments. The valve 110 can be actuated to prevent sample from flowing from the inlet 106 to the reaction chamber 104 along the fill channel 146, or vice versa. In particular, the lower channel 130 can become blocked by TRS that flows into the lower channel 130 from the valve channel 150. Once cooled, the TRS is impenetrable by fluid and gas. The valve 110 can be actuated to prevent gas from flowing from the reaction chamber 104 to the vent 108 along the vent channel 148, or vice versa. In particular, the lower channel 132 can be become blocked by TRS that flows into the lower channel 132 from the valve channel 152. Once cooled, the TRS is impenetrable by gas and fluid.

The single valve 110 prevents ingress and egress from the reaction chamber 104. The only ingress to and from the reaction chamber 104 is along the fill channel 146 and the vent channel 148. The fill channel 146 and the vent channel 148 can be blocked along the lower channels 130, 132 by the flow of TRS. The single valve 110 can seal both fill channel 146 and the vent channel 148. The single valve 110 can prevent evaporation of fluid from the reaction chamber 104 during thermal cycling. The single valve 110 can maintain the fluid volume in the reaction chamber 104 during thermal cycling. The single valve 110 can maintain the fluid volume in the cartridge 100 during thermal cycling. The single valve 110 can provide a sealed zone during amplification.

A fluid sample can flow along a torturous path of the fill channel 146. The inlet 106 can be configured to mate with a pipette tip of a liquid dispenser. The liquid dispenser can provide an actuation force to move fluid from the inlet 106 to the reaction chamber 104. The fill channel 146 can include the through channel 138. The sample can be forced upward toward the first side 116 of the substrate layer 120 via the through channel 138. The through channel 138 can allow the passage of the sample from the second side 118 of the substrate layer 120 to the first side 116 of the substrate layer 120. The upper channel 134 can allow the passage of the sample into the reaction chamber 104. The position of the upper channel 134 can reduce backflow from the reaction chamber 104 toward the inlet 106. The reaction chamber 104 can fill from the top. The reaction chamber 104 can be partially filled for amplification. The reaction chamber 104 can be substantially filled up to the connection with the upper channel set 134, 146. The reaction chamber 104 can receive up to a maximum volume for amplification. Amplification can be performed on a partially filled reaction chamber 104.

A gas within the cartridge 100 can flow along a torturous path of the vent channel 148. The gas can pass from the reaction chamber 104 to the vent 108. The vent channel 148 can include the through channel 140. The gas can pass downward via the through channel 140 due to the pressure gradient formed by the vent 108. The through channel 140 can allow the passage of gas from the top side of the substrate layer 120 to the second side 118 of the substrate layer 120. The upper channel 136 can allow the passage of gas from the reaction chamber 104. The upper channel 136 can vent gas from the reaction chamber 104. The gas displaced by fluid sample in the reaction chamber 104 can rise within the reaction chamber and pass through the vent channel 148 to the vent 108. The upper channel 136 can be positioned relative to the reaction chamber 104 reduce the flow of sample from the reaction chamber 104 to the vent 108. The upper channel 136 can be positioned above the sample when the sample is within the reaction chamber 104.

The network 102 can be partially formed within the substrate layer 120. The lower channel set 130, 132 can be open on the bottom of the substrate layer 120. The valve channel set 150, 152 can be open on the bottom of the substrate layer 120. The reservoir 160 can be open on the bottom of the substrate layer 120 in some embodiment. The bottommost portion of the through channel set 138, 140 can be open on the bottom of the substrate layer 120. The reaction chamber 104 can be open on the top of the substrate layer 120. The upper channel set 134, 136 can be open on the top of the substrate layer 120. The uppermost portion of the through channel set 138, 140 can be open on the top of the substrate layer 120. The reservoir 160 can be open on the top of the substrate layer 120. The vent 108 can be open on the top of the substrate layer 120. The network 102 can include one or more portions that are fluidically sealed with one or more additional layers.

The top layer 122 can form a portion of the network 102. The top layer 122 can be a top cover that is a thin polymer sheet. The top layer 122 can include a pressure sensitive adhesive on the side that mates to the substrate layer 120. The top layer 122 can fluidically seal the upper channel set 134, 136. The top layer 122 can fluidically seal the reservoir 160. The top layer 122 can fluidically seal the reaction chamber 104. The top layer 122 can fluidically seal the through channel set 138, 140. The top layer 122 can fluidically seal a portion of the fill channel 146 and the vent channel 148. The opening 124 of the top layer 122 is aligned with the inlet 106 to allow for filling. The opening 126 of the top layer 122 is aligned with the vent 108 to allow for venting. The top layer 122 does not fluidically seal the inlet 106 or the vent 108.

The bottom layer 128 can form a portion of the network 102. The bottom layer 128 can be a bottom cover that is a thin polymer sheet. The bottom layer 128 can include a pressure sensitive adhesive on the side that mates to the substrate layer 120. The bottom layer 128 can fluidically seal the lower channel set 130, 132. The bottom layer 128 can fluidically seal the valve channels 150, 152. The bottom layer 128 can fluidically seal the through channel set 138, 140. The bottom layer 128 can fluidically seal the reservoir 160 in some embodiments. The bottom layer 128 can fluidically seal a portion of the fill channel 146 and the vent channel 148. The opening 158 of the bottom layer 128 is aligned with the reaction chamber 104. The reaction chamber 104 is a thin-walled chamber formed from the substrate layer 120. The bottom layer 128 can receive the reaction chamber 104 through the opening 158.

The cartridge 100 combines various principles including a consumable cartridge design with a shaped reaction chamber for uniform temperature control. The cartridge 100 includes features that ease manufacturing by positioning networking-defining structures on opposite sides of the substrate layer 120. The reaction chamber 104 can include a larger reservoir to facilitate amplification of larger sample volume. The enhanced valve 110 can seal the reaction chamber 104 by simultaneously sealing the fill channel 146 and the vent channel 148. The valve 110 can isolate a first portion of the network 102 from a second portion of the network 102 prior to actuating the valve 110. After actuating the valve 110, a third portion of the network 102 is isolated from a fourth portion of the network 102, where the third portion is different from (not coextensive with) the first portion and the fourth portion is different from (not coextensive with) the second portion.

Before actuation, the sealable material prevents passage of fluid directly from the fill channel 146 to the vent channel 148. Before actuation, the sealable material closes off a bypass. The sealable material prevent fluid from flowing directly from the fill channel 146 to the vent channel 148 along the valve 110. The sealing material isolates portions of the vent channel 148 from portions of the fill channel 146. On the portions of the network 102 positioned on the second side 118 of the substrate 120, the sealing material does serve an isolating function to block or obstruct fluid flow between two channels. Fluid is prevented from flowing from along the second side 118 of the substrate 120 between the lower channel set 130, 132 by the sealable material of the valve 110. The positon of the sealable material can be at the second side 118 of the substrate 120. Fluid thus flows from the inlet 106 to the reaction chamber 104 along the fill channel 146. As the reaction chamber 104 is filled, the fluid pushes gas along the vent channel 148 to the vent 108. There is access between the vent channel 148 and the fill channel 146 via the reaction chamber 104, but that involves portions of the network 102 that are not on the second side 118 of the substrate. Access specifically designed for the flow of gas is provided through the network 102, specifically, moving from the second side 118 of the substrate along the flow channel 146, then to the first side 116 of the substrate 120 to the reaction chamber, and then back down to the second side 118 of the substrate to the vent channel 148. With regard to liquid sample, the only way liquid sample reaches the vent channel 148 along this circuit is if the cartridge is not operated as intended, for instance if the reaction chamber 104 is filled to capacity and still more sample is added until sample reaches the vent 108. Viewed from the perspective of the liquid sample, and the intended operation of the cartridge, the sealing material serves an isolating function between portions of the vent channel 148 and portion of the fill channel 146. The sealing material does not completely isolate the vent channel 148 from the fill channel 146 for gases which travel along a tortuous path along the network 102 to the vent 108.

The sealable material serves an isolating function for the fluid sample. The sealable material blocks or obstructs a direct connection between the vent channel 148 and the fill channel 146 through the valve 110. The sealable material blocks or obstructs flow of fluid between the vent channel 148 and the fill channel 146 through the valve 110. The sealable material blocks or obstructs flow of fluid between the vent channel 148 and the fill channel 146 through the valve 110 both before actuation and after actuation of the valve 110.

The single lane nature can reduce waste associated with unused lanes or unused inputs compared with a multi-lane cartridge. The single-lane, single-sample design can be utilized for a point of care setting for individual testing.

In some embodiments, the reaction consumables are added to the reaction chamber 104 via the fill channel 146. The cartridge 100 can be utilized for any amplification test based on the sample and the reagents added by the user. The configuration of keeping the reaction consumable separate from the cartridge 100 provides the ability to support multiple reactions from a single sample extraction. For example, a single sample extraction can be added to a plurality of cartridges 100, each supporting one of a plurality of multiple reactions performed on the single sample extraction. The configuration of keeping the reaction consumable separate from the cartridge 100 provides the ability to run specific tests without inducing waste of extraneous reaction chambers that may remain unused. The configuration of keeping the reaction consumable separate from the cartridge 100 provides the ability to run specific tests without inducing waste of reagents due to only using a specific required amount of reagent required.

A non-limiting implementation of a microfluidic cartridge according to the present technology will now be described with reference to FIGS. 2A-2E. FIG. 2A shows a cross-section view of the cartridge 100 with a heater assembly 170, and a detector 180. FIG. 2B shows a side view of the cartridge 100, the heater assembly 170, and the detector 180. FIG. 2C shows another side view of the cartridge 100, the heater assembly 170, and the detector 180. FIG. 2D shows another cross-sectional view of the cartridge 100, the heater assembly 170, and the detector 180. FIG. 2E shows an exploded view of the cartridge 100, the heater assembly 170, and the detector 180.

The heater assembly 170 can be platform or bay that receives the cartridge 100. The heater assembly 170 can include shaped orifices to receive the cartridge 100. The heater assembly 170 can include one or more heaters. The heater assembly 170 can include a frame that connects one or more heaters into a unit. The cartridge 100 can be received in a receiving bay. The receiving bay can be configured so that various components that can operate on the cartridge (heat pumps, peltier coolers, heat-removing electronic elements, detectors, force members, and the like) can be positioned to properly operate on the cartridge. For example, the heater assembly 170 can be situated in the receiving bay such that it can be thermally coupled to one or more distinct locations of the cartridge 100 that can be selectively received in the receiving bay. The heater assembly 170 can include one or more contact heat sources.

The heater assembly 170 can be fabricated from one or more heater units. The heater assembly can include a plurality of independently controllable heaters. The one or more heaters can be made from a single piece of metal or other material. The one or more heaters can be made separately from one another. The one or more heaters can be mounted independently of one another or connected to one another by a receiving bay. The heater assembly 170 can be configured so that each heater unit independently heats a separate portion of the cartridge 100. The heater assembly 170 can apply heat to a single cartridge. The heater assembly 170 can include a heater unit that heats the valve 110. The heater assembly 170 can include a heater unit that heats the reaction chamber 104.

The heater assembly 170 can include a valve heater 172. The valve heater 172 can be a heater unit that independently heats a separate portion of the cartridge 100. The valve heater 172 can be positioned relative to the valve 110 when the cartridge 100 is received by the heater assembly 170. The valve heater 172 can heat to a temperature to soften the TRS of the valve 110. The valve heater 172 can stop heating to allow the TRS to solidify. The valve heater 172 is configured to align with and deliver heat to the valve 110. The valve heater 172 is configured to apply heat to TRS within the reservoir 160.

The heater assembly 170 can include a reaction chamber heater 174. The reaction chamber heater 174 can be a heater unit that independently heats a separate portion of the cartridge 100. The reaction chamber heater 174 can be a thermoelectric heater. The reaction chamber heater 174 can be a thermoelectric cooler. Other reaction chamber heaters can be suitably implemented. The reaction chamber heater 174 can be configured to subject the reaction chamber 104 to heating and cooling. The reaction chamber heater 174 is configured to align with and deliver heat to the reaction chamber 104. The heating and cooling functions of the reaction chamber heater 174 can be controlled by one or more processors.

An example of thermal cycling performance in the reaction chamber can include heating to a first temperature, maintaining the first temperature for a first period of time, cooling to a second temperature, and maintaining the second temperature for a second period of time. This cycle is repeated, wherein the time for each cycle is minimized. In some embodiments, cycle times can be in the range of 15 seconds to 30 seconds. In some embodiments, the temperatures can vary about 30 degrees. It will be understood that this example is non-limiting and the reaction chamber heater 174 can be programmed to perform any suitable thermocycling protocol. The reaction chamber heater 174 can be controlled for any thermocycling protocol by one or more processors.

The reaction chamber heater 174 can include a conductive element 176. The conductive element 176 can include an electroform. The conductive element 176 can be formed from any conductive material. In some embodiments, the reaction chamber heater 174 is positioned underneath the conductive element 176. The reaction chamber heater 174 can be in any position to effectively deliver heat to the conductive element 176.

The conductive element 176 can closely match the shape of the reaction chamber 104. The conductive element 176 can include any shape configured to deliver heat. The larger reservoir of the conductive element 176 can be matched to the geometry of the reaction chamber 104. The conductive element 176 is configured to have an internal cavity that partially or fully surrounds the lower portion of the reaction chamber 104. The internal cavity can surround the reaction chamber 104 circumferentially. The internal cavity can surround the reaction chamber 104 to provide rapid and uniform heating of the contents of the reaction chamber 104. The conductive element 176 can have a conical cavity. The conductive element 176 can have a flat bottom cavity. The reaction chamber 104 can be seated within the conductive element 176. FIG. 2E illustrates an exploded view illustrating how the cartridge 100 can be lowered into the conductive element 176.

The reaction chamber 104 can have a thin wall between the conductive element 176 and the contents of the reaction chamber 104. The conductive element 176 can contact the thin wall of the reaction chamber 104. The conductive element 176 is shaped to conform closely to the shape of the reaction chamber 104 so as to increase the surface area that is in contact with the reaction chamber 104 during heating of the reaction chamber 104. In some embodiments, the conductive element 176 surrounds a portion of the height of the reaction chamber. The conductive element 176 can surround at least 50% of the height, at least 60% of the height, at least 70% of the height, at least 80% of the height, at least 90% of the height, or any range of two of the foregoing values. The conductive element 176 can surround the portion of the reaction chamber 104 that extends below the average thickness of the substrate layer 120. The conductive element 176 can surround the portion of the reaction chamber 104 that is configured to be filled in some embodiments.

The valve heater 172 and the reaction chamber heater 174 can be independently controlled. The valve heater 172 and the reaction chamber heater 174 can be positioned at different heights from one another. The valve heater 172 and the reaction chamber heater 174 can operate in series. The valve heater 172 can be actuated to seal the fill channel 146 and vent channel 148 before the reaction chamber heater 174 thermal cycles the contents of the reaction chamber 104.

The detector 180 is configured to monitor fluorescence coming from one or more species involved in a biochemical reaction. The detector 180 can be an optical detector. The detector 180 can include a light source that selectively emits light in an absorption band of a fluorescent dye. The detector 180 can include a light detector that selectively detects light in an emission band of the fluorescent dye. The fluorescent dye corresponds to a fluorescent polynucleotide probe or a fragment thereof. In some embodiments, the detector 180 can include a bandpass-filtered diode that selectively emits light in the absorption band of the fluorescent dye and a bandpass filtered photodiode that selectively detects light in the emission band of the fluorescent dye. The detector 180 can be configured to independently detect a plurality of fluorescent dyes having different fluorescent emission spectra, wherein each fluorescent dye corresponds to a fluorescent polynucleotide probe or a fragment thereof. The detector 180 can be configured to independently detect a plurality of fluorescent dyes in the reaction chamber 104 of the cartridge 100 or in the reaction chambers 104 of a plurality of cartridges 100, wherein each fluorescent dye corresponds to a fluorescent polynucleotide probe or a fragment thereof. The detector 180 can have the potential for 1 color, 2 color, 3 color, 4 color, 5 color, 6 color, 7 color, 8 color detection, or detection of more than 8 colors. The detector 180 can be controlled by one or more processors. The detector 180 can be capable of detecting one or more fluorescence signals from any volume from the amplification reaction within the reaction chamber 104.

The detector 180 can include light emitting diodes (LED's), photodiodes, and filters/lenses for monitoring, in real-time, one or more fluorescent signals emanating from the reaction chamber 104. The detector 180 can include a detection system having a modular design that couples with the reaction chamber 104 of a single cartridge 100. The detector 180 can detect a single color of light. The detector 180 can include a light source 182 and a light detector 184. The detector 180 can include any additional optical components including filters and lenses. The detector 180 can include one LED and one photodiode. The LED is configured to transmit a beam of focused light on to a particular region of the cartridge 100. The photodiode is configured to receive light that is emitted from the region of the cartridge 100. In some embodiments, two or more colors can be detected from a single location. The detector 180 can include two or more LEDs and two or more photodiodes. The detector 180 can include five LEDs and five photodiodes. Other numbers of LEDs and photodiodes can be suitably implemented. The LEDs can be different colors and the photodiodes can receive the corresponding light. The filters can be bandpass filters. The filters at the light sources can correspond to the absorption band of one or more fluorogenic probes and the filters at the light detector can correspond to the emission band of the fluorogenic probes.

The detector 180 can be stationary. The detector 180 can have no movable parts. The assembly can include multiple detectors 180 corresponding to the number of cartridges 100 received in an assembly 190. The assembly 190 can interact with six cartridges 100 in some embodiments. The assembly 190 can include a dock 192 to receive a detector 180. In the illustrated embodiments, the assembly 190 can include up to six detectors 180. The number of detectors 180 can correspond to the number of cartridges 100 that the assembly 190 can receive. In the illustrated embodiments, the assembly 190 has five mounted detectors 180 and is configured to receive up to five cartridges 100. There is one dock 192 that does not have a corresponding detector 180. The assembly can include any number of detectors 180 including 1, 2, 3, 4, 5, 6, 7, 8, 9, 10, 12, 14, 16, 18, 20, 22, 24, 26, 28, 30, 36, 48, 60, 72, 84, 96, or any multiple of 3, 6, 12, or any range of two of the foregoing values.

In some embodiments, the detector 180 can be mounted on an assembly that permits the detector 180 to slide over multiple cartridges 100. The detector 180 can scan across one or more cartridges 100 mounted in the assembly. Such a detection system can be configured to receive light from multiple cartridges 100 by being mounted on an assembly that permits it to slide over multiple reaction chambers 104.

FIG. 2A shows a cross-section view of the cartridge 100 with the detector 180. The light source 182 is at an angle relative to the reaction chamber 104. The light detector 184 is vertically oriented relative to the reaction chamber 104. The detector 180 can be a single-color detection system configured to mate with the cartridge 100. The detector 180 can be spaced from the cartridge 100. The detector 180 can be in contact with the cartridge 100. In some embodiments, the detector 180 or the assembly 190 can apply a force to the cartridge 100 to seat the cartridge 100 relative to the heater assembly 170. FIGS. 2B-2D illustrate the alignment between the detector 180 and the cartridge 100. These figures show additional detectors 180 within the assembly 190. While only one cartridge 100 is illustrated, the assembly 190 can receive multiple cartridges 100. Each cartridge 100 is configured to receive a single sample. Each cartridge 100 can comprise a single lane. The plurality of cartridges 100 can have the contents of the respective reaction chambers 104 processed sequentially or simultaneously. The assembly 190, the detector 180, and the heater assembly 170 can do parallel processing. The assembly 190 can do parallel detection. Each cartridge 100 can be independently processed based on the amplification protocol necessitated by the ordered tests. The assembly 190 can include one or more processors to control heating and detecting operations relative to the one or more cartridges 100.

The LED light can pass through a filter before passing through the sample in the reaction chamber 104. The generated fluorescence then can go through a second filter, and into the photodiode. The detector 180 is sensitive enough to collect fluorescence light from the reaction chamber 104 of the cartridge 100.

The detector 180 can be used to detect the presence of liquid in the reaction chamber 104 or the presence of the cartridge 100 itself. These measurements can provide a determination of whether or not to carry out an amplification cycle for that cartridge 100. For example, in the assembly 190, not all cartridges 100 will have been loaded into the assembly 190; for those that are not, it would be unnecessary to apply a heating protocol from the corresponding heating assembly 170. In some embodiments, a background reading is taken. The presence of liquid alters the fluorescence reading from the reaction chamber 104. A programmable threshold value can be used to tune an algorithm programmed into a processor that controls operation of the apparatus (for example, the threshold value has to exceed the background reading by 20%). If the two readings do not differ beyond the programmed margin, the liquid is deemed to not have entered a corresponding reaction chamber 104 of a corresponding cartridge 100, and an amplification cycle is not initiated for that reaction chamber 104.

The assembly 190 can combine the principles of a consumable cartridge design with a reusable heater assembly 170 and a reusable detector 180. The larger reservoir of the reaction chamber 104 can be utilized for various tests including those detecting viral loads. The larger reaction chamber 104 is matched to the geometry of the conductive element 176 of the heater assembly 170. The valve 110 applies microfluidic principles to the geometry at the exit of the reservoir 160. The enhanced valve 110 and the single lane nature of the cartridge 100 can ease on-cartridge operations. The valve 110 can simultaneously seal two channels, thereby sealing the reaction chamber 104 for amplification. The single lane nature of the cartridge 100 can load a single sample for amplification and detection.

In some uses, the user can divide the sample and run multiple tests by utilizing multiple cartridges 100. The single lane nature of the cartridge 100 can be designed for point of care settings. The configuration of keeping the reaction consumable separate from the disposable cartridge 100 provides the ability to support multiple reactions from a single sample extraction without wasting unused lanes of a multi-lane cartridge or excess solutions if the reagents were embedded with the cartridge. The extraction solutions and necessary reagents can be added to the cartridge 100 based on the specific one or more tests to be run. The cartridge 100 can be considered a universal cartridge 100. In some embodiments, the cartridge 100 is not pre-loaded with reagents, thereby rending the cartridge 100 useful for any test.

In some embodiments, extraction of polynucleotides and preparation of an amplification ready sample are done on an extraction strip. The sample can be processed with a reagent holder configured to include one or more components including a process tube, a socket to receive a pipette tip, a pipette sheath, one or more reagent tubes, and/or one or more receptacles configured to receive a container. The reagent holder can be operated on by a heater and separator configured to prepare the sample for amplification. The amplification-ready sample can loaded into the cartridge 100 by a pipette tip or any other suitable implement. The amplification-ready sample can include amplification probes and primers for the one or more target analytes under consideration. Other methods for sample preparation can be suitable implemented.

The heater assembly 170 and the cartridge 100 can be shaped to maximize thermal transfer. The shapes can be optimized for manufacturability by creating a more uniform wall thickness in the substrate layer 120 for the reaction chamber 104. This could be accomplished by selective coring. In some embodiments, the substrate layer 120 is cored around the reaction chamber 104. The conductive element 176 can extend into the substrate layer 120. The conductive element 176 can extend a larger portion of the height of the reaction chamber 104 by extending into the thickness of the substrate layer 120.

A non-limiting implementation of a microfluidic cartridge according to the present technology will now be described with reference to FIGS. 3A-3DD. FIGS. 3A-3E show views of a cartridge 200. The cartridge 200 can include any features of the cartridge 100 described herein. FIG. 3A shows a top view of the cartridge 200. FIG. 3B shows a side view of the cartridge 200. FIG. 3C shows a perspective view of the cartridge 200. FIG. 3D shows another side view of the cartridge 200. FIG. 3E shows an exploded view of the cartridge 200.

FIGS. 3F-13J show views of the cartridge 200 with the phantom lines of a network of the cartridge 200. FIG. 3F shows a top view of the cartridge 200. FIG. 3G shows a side view of the cartridge 200. FIG. 3H shows a perspective view of the cartridge. FIG. 1I shows another side view of the cartridge 200. FIG. 3J shows an exploded view of the cartridge 200.

FIGS. 3K-3P show views of a substrate layer of the cartridge 200. FIG. 3K shows a top view of the substrate layer of the cartridge 200. FIG. 3L shows a side view of the substrate layer of the cartridge 200. FIG. 3M shows a bottom view of the substrate layer of the cartridge 200. FIG. 3N shows another side view of the substrate layer of the cartridge 200. FIG. 3O shows a top perspective view of the substrate layer of the cartridge 200. FIG. 3P shows a bottom perspective view of the substrate layer of the cartridge 200.

FIGS. 3Q-3V show views of the substrate layer of the cartridge 200 with phantom lines of the network. FIG. 3Q shows a top view of the substrate layer of the cartridge 200. FIG. 3R shows a side view of the substrate layer of the cartridge 200. FIG. 3S shows a bottom view of the substrate layer of the cartridge 200. FIG. 3T shows another side view of the substrate layer of the cartridge 200. FIG. 3U shows a top perspective view of the substrate layer of the cartridge 200. FIG. 3V shows another top perspective view of the substrate layer of the cartridge 200.

FIGS. 3W-3Z show views of a top layer of the cartridge 200. FIG. 3W shows a top view of the top layer of the cartridge 200. FIG. 3X shows a side view of the top layer of the cartridge 200. FIG. 3Y shows a perspective view of the top layer of the cartridge 200. FIG. 3Z shows another side view of the top layer of the cartridge 200.

FIGS. 3AA-3DD show views of a bottom layer of the cartridge 200. FIG. 3AA shows a top view of the bottom layer of the cartridge 200. FIG. 3BB shows a side view of the bottom layer of the cartridge 200. FIG. 3CC shows a perspective view of the bottom layer of the cartridge 200. FIG. 3DD shows another side view of the bottom layer of the cartridge 200.

The cartridge 200 can include a single sample lane. The cartridge 200 includes a network 202 for loading a sample and carrying out amplification on a sample. The network 202 can accept and amplify a polynucleotide containing sample using any suitable method. The amplification ready sample can include one or more of a polymerase enzyme, a positive control plasmid, a fluorogenic hybridization probe selective for at least a portion of the plasmid and a plurality of polynucleotides, and/or at least one probe that is selective for a polynucleotide sequence. The amplification ready sample can be configured for syndromic testing.

The cartridge 200 includes a reaction chamber 204. The cartridge 200 can include a single reaction chamber 204. The reaction chamber 204 can have a rectangular shape. The reaction chamber 204 can have a have a profile that tapers. The reaction chamber 204 can gradually form a smaller rectangular shape. The reaction chamber 204 can be any polygonal shape. The reaction chamber 204 can be trapezoidal. The reaction chamber 204 can gradually narrow. The reaction chamber 204 can have rounded edges. The reaction chamber 204 can have an exterior bottom surface that is flat. The reaction chamber 204 can have a longer horizontal dimension than the reaction chamber 104. The reaction chamber 204 can have a shorter vertical dimension than the reaction chamber 104. The reaction chamber 204 can have a different shape than the reaction chamber 104. The reaction chamber 204 is a deep well reaction chamber designed for amplification, such as PCR.

The reaction chamber 204 is significantly larger than the reaction chambers in the other systems. In some embodiments, the reaction chamber 204 can hold volumes between 50 μl and 100 μl. In some embodiments, the reaction chamber 204 can hold volumes about 84 μl. The reaction chamber 204 advantageously can carry out reactions requiring larger sample sizes. The reaction chamber 204 can be designed for detection of viral loads, which benefit from larger volumes.

The reaction chamber 204 can be a thin-walled chamber. The thin-walled chamber can effectively transfer heat to the contents of the reaction chamber 204. The reaction chamber 204 can have a constant wall thickness or variable wall thickness. The reaction chamber 204 can have a wall thickness of 1 mm or less, 2 mm or less, 3 mm or less, 4 mm or less, 5 mm or less, or any range of two of the foregoing values.

In some embodiments, the reaction chamber 204 can be three-dimensional trapezoidal shape. The shape of the reaction chamber 204 can advantageously concentrate the PCR-ready sample in the bottom of the reaction chamber 204. The reaction chamber 204 can be shaped to correspond with a heater assembly. The reaction chamber 204 can be matched to the angles of a detector described herein. The benefit of this shape can include a larger target for detection. Another benefit of this shape can include that the reaction chamber 204 can receive a larger sample for amplification and detection.

The cartridge 200 can include an inlet 206 and can have any of the features of the inlet 106. The cartridge 200 can include a vent 208. The vent 208 can facilitate expelling gas from the network 202 and can have any of the features of the vent 108. The cartridge 200 can include a valve 210. The valve 210 can seal the reaction chamber 204 during amplification and can have any of the feature of the valve 110. The valve 210 can include a shape configured for effective sealing. The valve 210 can seal a vent channel 248 and a fill channel 246.

The cartridge 200 be constructed from a number of layers. The cartridge 200 can include a substrate layer 220. The substrate layer 220 can include the network 202, or a portion thereof. The substrate layer 220 can include fluidic components formed in a surface thereof. The substrate layer 220 can include the first side 216 and the second side 218.

The cartridge 200 can further include a top layer 222. The top layer 222 can include an opening 224 corresponding to the inlet 206. The top layer 222 can include an opening 226 corresponding to the vent 208. The top layer 222 can fluidically seal a portion of the network 202.

The cartridge 200 can further include a bottom layer 228. The bottom layer 228 can include an opening 258 corresponding to the reaction chamber 204. The opening 258 can be rectangular. The bottom layer 228 can fluidically seal a portion of the network 202.

The substrate layer 220 can include a lower channel set 230, 232. The lower channel set 230, 232 can include a first channel 230. The first channel 230 can connect to the inlet 206. The first lower channel 230 can connect to the valve 210. The lower channel set can include a second lower channel 232. The second lower channel 232 can connect to the vent 208. The second lower channel 232 can connect to the valve 210. The lower channel set 230, 232 can be sealed by the valve 210.

The substrate layer 220 can include an upper channel set 234, 236. The upper channel set can include a first upper channel 234. The first upper channel 234 can connect to the reaction chamber 204. The upper channel set can include a second upper channel 236. The second upper channel 236 can connect to the reaction chamber 204.

The substrate layer 220 one or more vias or through channels 238, 240. The through channels 238, 240 can extend entirely through the substrate layer 220. The through channels 238, 240 can include a first through channel 238. The through channels can include a second through channel 240.

The network 220 can include a fill channel 246. The fill channel 246 can connect the inlet 206 to the reaction chamber 204. The fill channel 246 can include the first lower channel 230, the first through channel 238, and the first upper channel 234. The fill channel 246 can allow the reaction chamber 204 to fill from the top. For example, the fill channel 246 can allow the reaction chamber 204 to fill from the upper edge 242 at the top surface of the reaction chamber 204.

The network 202 can include a vent channel 248. The vent channel 248 can connect the reaction chamber 204 to the vent 208. The vent channel 248 can include the second upper channel 236, the second through channel 240, and the second lower channel 232. The vent 208 can extend through the substrate layer 220 and vent gas on the first side 216 of the substrate layer 220.

The valve 210 can include channels that promote sealing of the fill channel 146 and the vent channel 148. The substrate layer 220 can include a first valve channel 250. The first valve channel 250 can be connected to the first lower channel 230. The first valve channel 250 can have increasing cross-section toward the first lower channel 230. The substrate layer 220 can include a second valve channel 252. The second valve channel 252 can be connected to the second lower channel 232. The second valve channel 252 can have increasing cross-section toward the second lower channel 232. The increasing cross-section of the valve channels 250, 252 can promote fluidic capillary action of the TRS toward the lower channels 230, 232. The valve 210 can include a reservoir 260. The geometry of the valve channels 250, 252 promotes complete and robust sealing of the lower channels 230, 232.

The substrate layer 220 can include the thin wall reaction chamber 204. The reaction chamber 204 can project perpendicularly from the bottom of the substrate layer 220. The reaction chamber 204 can include a height H2 greater than the average height H1 of the substrate layer 220. The reaction chamber 204 can extend below a general plane of the second side 218 of the substrate layer 220. The reaction chamber 204 can include a larger reservoir to facilitate amplification of larger sample volume. The valve 210 can seal the reaction chamber 204 by sealing the fill channel 146 and the vent channel 148.

A non-limiting implementation of a microfluidic cartridge according to the present technology will now be described with reference to FIGS. 4A-4E. FIG. 4A shows a cross-section view of a cartridge 200 with a heater assembly 270, and a detector 280. FIG. 4B shows a side view of the cartridge 200, the heater assembly 270, and the detector 280. FIG. 4C shows another side view of the cartridge 200, the heater assembly 270, and the detector 280. FIG. 4D shows another cross-sectional view of the cartridge 200, the heater assembly 270, and the detector 280. FIG. 4E shows an exploded view of the cartridge 200, the heater assembly 270, and the detector 280. The heater assembly 270 can include any of the features of the heater assembly 170. The detector 280 can include any of the features of the detector 180.

The heater assembly 270 can be platform or bay that receives the cartridge 200. The heater assembly 270 can include shaped orifices to receive the profile of the cartridge 200. The heater assembly 270 can include one or more heaters. The heater assembly 270 can include one or more contact heat sources. The heater assembly 270 can include a valve heater 272. The valve heater 272 can be positioned relative to the valve 210 when the cartridge 200 is received by the heater assembly 270. The valve heater 272 can apply heat to soften the TRS. The valve heater 272 can apply heat to allow the flow of the TRS into the fill channel 246 and the vent channel 248. The protocol can cease the application of heat to allow the TRS to solidify. The valve heater 272 is configured to align with and deliver heat to the valve 210.

The heater assembly 270 can include a reaction chamber heater 274. The reaction chamber heater 274 can be configured to subject the reaction chamber 204 to heating. The reaction chamber heater 274 can be configured to subject the reaction chamber 204 to cooling. The reaction chamber heater 274 is configured to apply heat to the reaction chamber 204. The reaction chamber heater 274 can be positioned under the reaction chamber 204. The reaction chamber heater 274 can extend a greater length than the reaction chamber 204. The reaction chamber heater 274 can extend a greater width than the reaction chamber. The reaction chamber heater 274 can have a similar shape as the reaction chamber 204. The reaction chamber heater 274 can undergo any thermal cycling protocol.

The heater assembly 270 can include a conductive element 276. The conductive element 276 can couple to the reaction chamber heater 274. The conductive element 276 can receive and distribute heat from the reaction chamber heater 274. The conductive element 276 can closely match the shape of the reaction chamber 204. The conductive element 276 can include any polygonal shape. The conductive element 276 is configured to have an internal cavity that partially or fully surrounds the lower portion of the reaction chamber 204. The internal cavity can be adjacent to the reaction chamber 204 on one side, one or more sides, two sides, two or more sides, three sides, three or more sides, or four sides. The internal cavity can surround the reaction chamber 204 to provide a substantially uniform temperature. The conductive element 276 can have a rectangular cavity. The conductive element 276 can have a flat bottom cavity. The reaction chamber 204 can be seated within the conductive element 276. FIG. 2E illustrates an exploded view illustrating how the cartridge 200 can be positioned relative to the heater assembly 270.

The reaction chamber 204 can have a thin wall between the conductive element 276 and the contents of the reaction chamber 204. The conductive element 276 is shaped to conform closely to the shape of the reaction chamber 204 so as to increase the surface area during heating of the reaction chamber 204. In some embodiments, the conductive element 276 surrounds a portion of the height of the reaction chamber 204. The conductive element 276 can surround at least 30% of the height, at least 40% of the height, at least 50% of the height, at least 60% of the height, at least 70% of the height, at least 80% of the height, at least 90% of the height, or any range of two of the foregoing values. The conductive element 276 can surround the portion of the reaction chamber 104 that extends below the average thickness of the substrate layer 220. The conductive element 276 can surround the portion of the reaction chamber 204 that is configured to be filled in some embodiments.

The detector 280 is configured to detect fluorescence from the reaction chamber 204. The detector 280 can have any of the features of the detector 180. The detector 280 can include a light source 282 and a light detector 284. The detector 280 can include any additional optical components including filters and lenses. The detector 280 can include one LED and one photodiode. The LED is configured to transmit a beam of focused light onto the reaction chamber 204. The photodiode is configured to receive light that is emitted from the reaction chamber 204. The detector 280 can be stationary. The detector 280 can be movable. The light source 282 is at an angle relative to the reaction chamber 204. The light detector 284 is vertically oriented relative to the reaction chamber 204. The detector 280 can be a single-color detection system configured to mate with the cartridge 200. The detector 280 can be a multi-color detection system configured to mate with the cartridge 200. The detector 280 can include multiple LEDs and multiple photodiodes. The detector 280 can be used to detect the presence of liquid in the reaction chamber 204 and/or the presence of the cartridge 200.

The assembly 290 can combine the principles of a consumable cartridge design with a reusable heater assembly 270 and detector 280. The larger reservoir of the reaction chamber 204 can be utilized for one or more tests including those detecting viral loads. The larger reaction chamber 204 and the heater assembly 270 can have a matched geometry. The valve 210 can utilize microfluidic principles to promote the flow of TRS at the exit of the reservoir 160. The valve 210 and the single lane nature of the cartridge 200 can simplify on-cartridge operations. The valve 210 can simultaneously seal two channels, thereby sealing the reaction chamber 204 for amplification. The single lane nature of the cartridge 100 can load a single sample for both amplification and detection.

The heater assembly 280 and the cartridge 200 can be shaped to maximize thermal transfer. The cartridge 200 can include a uniform wall thickness in the substrate layer 220 surrounding the reaction chamber 204. The substrate layer 220 can be selectively cored to provide a cutout around the reaction chamber 204. The conductive element 276 can extend into the substrate layer 220. The conductive element 276 can extend a larger portion of the height of the reaction chamber 204 by extending into the thickness of the substrate layer 220.

A non-limiting implementation of a microfluidic cartridge according to the present technology will now be described with reference to FIGS. 5A-5DD. FIGS. 5A-5E show views of a cartridge 300. The cartridge 300 can include any features of the cartridge 100, 200 described herein. FIG. 5A shows a top view of the cartridge 300. FIG. 5B shows a side view of the cartridge 300. FIG. 5C shows a perspective view of the cartridge 300. FIG. 5D shows another side view of the cartridge 300. FIG. 5E shows an exploded view of the cartridge 300.

FIGS. 5F-5J show views of the cartridge 300 with the phantom lines of a network of the cartridge 300. FIG. 5F shows a top view of the cartridge 300. FIG. 5G shows a side view of the cartridge 300. FIG. 5H shows a perspective view of the cartridge. FIG. 5I shows another side view of the cartridge 300. FIG. 5J shows an exploded view of the cartridge 300.

FIGS. 5K-5P show views of a substrate layer of the cartridge 300. FIG. 5K shows a top view of the substrate layer of the cartridge 300. FIG. 5L shows a side view of the substrate layer of the cartridge 300. FIG. 5M shows a bottom view of the substrate layer of the cartridge 300. FIG. 5N shows another side view of the substrate layer of the cartridge 300. FIG. 5O shows a top perspective view of the substrate layer of the cartridge 300. FIG. 5P shows a bottom perspective view of the substrate layer of the cartridge 300.

FIGS. 5Q-5V show views of the substrate layer of the cartridge 300 with phantom lines of the network. FIG. 5Q shows a top view of the substrate layer of the cartridge 300. FIG. 5R shows a side view of the substrate layer of the cartridge 300. FIG. 5S shows a bottom view of the substrate layer of the cartridge 300. FIG. 5T shows another side view of the substrate layer of the cartridge 300. FIG. 5U shows a top perspective view of the substrate layer of the cartridge 300. FIG. 5V shows another top perspective view of the substrate layer of the cartridge 300.

FIGS. 5W-5Z show views of a top layer of the cartridge 300. FIG. 5W shows a top view of the top layer of the cartridge 300. FIG. 5X shows a side view of the top layer of the cartridge 300. FIG. 5Y shows a perspective view of the top layer of the cartridge 300. FIG. 5Z shows another side view of the top layer of the cartridge 300.

FIGS. 5AA-5DD show views of a bottom layer of the cartridge 300. FIG. 5AA shows a top view of the bottom layer of the cartridge 300. FIG. 5BB shows a side view of the bottom layer of the cartridge 300. FIG. 5CC shows a perspective view of the bottom layer of the cartridge 300. FIG. 5DD shows another side view of the bottom layer of the cartridge 300.

The cartridge 300 can include a single sample lane. The cartridge 300 includes a network 302. The network 302 can be configured to receive heat for processing a sample. In some embodiments, the network 302 can be configured to receive a sample for thermal cycling. The network 302 can accept and amplify polynucleotides in a sample using any suitable method. In some embodiments, the network 302 can be configured to carry out amplification on an amplification ready sample. The amplification ready sample can include one or more enzymes, one or more plasmids, and one or more probes. The amplification ready sample can include one or more polynucleotides. The amplification ready sample can be configured for syndromic testing.

The cartridge 300 includes a reaction chamber 304. The cartridge 300 can include a single reaction chamber 304. The single sample lane can include one reaction chamber 304. The reaction chamber 304 is a large surface area reaction chamber designed for amplification, such as PCR. The cartridge 300 can be designed for carrying out a reaction within the single reaction chamber 304. The single reaction chamber 304 can provide greater random access. The single reaction chamber 304 can be preloaded with the necessary reagents. The single reaction chamber 304 can receive an amplification ready sample with the necessary reagents. The single sample lane cartridge 300 can allow the consumption of as many reaction chambers 304 as required in a one reaction-to-one cartridge-to-one reaction chamber ratio. The volume of the reaction chamber 304 is significantly larger than the reaction chambers in other known cartridges. In some embodiments, the reaction chamber 304 can hold volumes between 50 μl and 150 μl. In some embodiments, the reaction chamber 304 can hold a volume of approximately 79 μl. The reaction chamber 304 advantageously can carry out reactions requiring larger sample volumes. The larger sample volumes may be necessary to detect very low analyte levels or for quantitative analysis. The larger sample volumes may be necessary to detect viral loads.

The reaction chamber 304 can include a large surface area. The reaction chamber 304 can have a length. The length can extend along the longitudinal axis of the cartridge 300. The length can be along the longest axis of the cartridge 300. The reaction chamber 304 can be elongate in the direction of the length. The reaction chamber 304 can have a width. The width can extend transverse to the longitudinal axis of the cartridge 300. The width can be across the cartridge 300. The reaction chamber 304 can have a height. The height can extend transverse to the longitudinal axis of the cartridge 300. The height can extend through all layers of the cartridge 300. The height can be the thickness of the cartridge 300. The length can be greater than the width. The length can be greater than the height. The width can be greater than the height. The reaction chamber 304 can define a large surface area. The surface area can be defined by the length and the width of the reaction chamber 304. The surface area can be elongate. The reaction chamber 304 can include a thin top wall. The thin walled chamber can increase the volume of the reaction chamber 304. The reaction chamber can extend through the majority of the height of the cartridge 300. In some embodiments, the top of the reaction chamber 304 can have uniform wall thickness. In some embodiments, the top of the reaction chamber 304 can have non-uniform wall thickness. In some embodiments, the top of the reaction chamber 304 can include a projection of greater thickness. The reaction chamber 304 can have a maximum top wall thickness of 1 mm or less, 2 mm or less, 3 mm or less, 4 mm or less, 5 mm or less, or any range of two of the foregoing values.

The reaction chamber 304 can have a rectangular shape. The reaction chamber 304 can have an elongate shape. The reaction chamber 304 can have generally vertical sidewalls. The reaction chamber 304 can have rounded corners. The reaction chamber 304 can have an exterior bottom surface that is flat. The reaction chamber 304 can have a shorter vertical dimension than the reaction chamber 104 of the microfluidic cartridge 100. The reaction chamber 304 can have a shorter vertical dimension than the reaction chamber 204 of the microfluidic cartridge 200. The reaction chamber 304 can have a larger bottom surface area than the reaction chamber 104. The reaction chamber 304 can have a larger bottom surface area than the reaction chamber 204. The reaction chamber 304 can have a different shape than the reaction chambers 104, 204. The reaction chamber 304 is a large surface area reaction chamber designed for amplification.

In some embodiments, the reaction chamber 304 can be a three-dimensional elongate shape. In some embodiments, the reaction chamber 304 can be a flat bottom shape. The shape of the reaction chamber 304 can advantageously concentrate a PCR-ready sample along a larger surface area than the reaction chamber 104, 204. The bottom of the reaction chamber 304 can be shaped to correspond with a heater assembly. The benefit of the shape of the reaction chamber 304 can include a larger target for heating. The top of the reaction chamber 304 can be shaped to correspond with a detector. The benefit of the shape of the reaction chamber 304 can include a larger target for detection. The benefit of the shape of the reaction chamber 304 can include that the reaction chamber 304 can receive a larger volume of sample for amplification and detection.

The cartridge 300 can include an inlet 306 configured to receive fluid. The inlet 306 can have any of the features of the inlet 106, 206. The inlet 306 can be configured to receive a pipette from an automatic dispensing system or manually, by a user. The cartridge 300 can include a vent 308. The vent 308 can facilitate the passage of gas from the network 302. The vent 308 can have any of the features of the vent 108, 208.

The cartridge 300 can include a valve 310. The valve 310 can be configured to seal the reaction chamber 304 during processing. The valve 310 can have any of the features of the valve 110, 210. The valve 310 can include a shape configured for effective sealing. The valve 310 can seal one or more channels leading to the reaction chamber 304. The valve 310 can seal an entry and exit to the reaction chamber 304. In some embodiments, the valve 310 can seal two channels independently. In some embodiments, the valve 310 can seal two channels simultaneously. In some embodiments, the valve 310 can seal two channels sequentially.

The cartridge 300 be constructed from a number of layers. The cartridge 300 can include one layer, two layers, three layers, four layers, five layers, or any range of two of the foregoing values. In some embodiments, the cartridge 300 can be constructed of one or more layers. In some embodiments, the network 302 can be constructed of one or more layers. The one or more layers can allow the escape of gas from the network 302. The one or more layers can prevent the escape of liquid from the network 302. The one or more layers can allow the entry of fluid into the network 302. The one or more layers can define the reaction chamber 304. The one or more layers can define the inlet 306. The one or more layers can define the vent 308. The one or more layers can define the valve 310. The cartridge 300 can include one or more additional layers that do not form the network 302. The one or more additional layers that do not form the network 302 can include a label.

The cartridge 300 can include a substrate layer 320. The substrate layer 320 can include the network 302, or a portion thereof. The substrate layer 320 can include one or more channels formed in a surface thereof. The substrate layer 320 can include at least a portion of the reaction chamber 304. The substrate layer 320 can include at least a portion of the inlet 306. The substrate layer 320 can include at least a portion of the vent 310.

The substrate layer 320 can include the first side 316 and the second side 318. The first side 316 can be an upper surface. The second side 318 can be a lower surface. The substrate layer 320 can include one or more channels formed on the first side 316. The substrate layer 320 can include one or more channels formed on the second side 318. The substrate layer 320 can include one or more channels that extend the thickness or height of the substrate layer 320. The substrate layer 320 can include at least one channel that extends entirely through the substrate layer 320. The substrate layer 320 can form a portion of the reaction chamber 304. The reaction chamber 304 can include an opening 314 on the second side 318 of the substrate layer 320. The reaction chamber 304 can extend at least partially through the substrate layer 320. The reaction chamber 304 can form a closed end. The reaction chamber 304 can be closed on the first side 316 of the substrate layer 320. The vent 308 can extend through the substrate layer 320. The vent 308 can be configured to open to the first side 316. The valve 310 can extend through the substrate layer 320. The substrate layer 320 can include a reservoir of the valve 310 on the first side 316. The substrate layer 320 can include channels connected to the valve 310 on the second side 318. In some embodiments, it is advantageous that at least a portion of every component of the network 302 is defined in the same, single substrate layer 320. The substrate layer 320 can be molded from a moldable material, such as a plastic or polymer. The substrate layer 320 can be formed from any material that is non-venting to gas. The substrate layer 320 can be formed from any material that is non-porous to liquid. The substrate layer 320 can be formed from any material that enables detection in the reaction chamber, such as a material with low auto-fluorescence.

The cartridge 300 can further include a top layer 322. The top layer 322 can couple to the first side 316 of the substrate layer 320 when the cartridge 300 is assembled. The top layer 322 can overlie one or more components of the substrate 320. The top layer 322 can form the top of the cartridge 300, or a portion of the top of the cartridge 300. The top layer 322 can form the network 302, or a portion thereof. The top layer 322 can include an opening 324. The opening 324 can have a corresponding shape and size to the inlet 306. The opening 324 can be larger than the inlet 306 to allow the substrate layer 320 forming the inlet 306 to extend through. The top layer 322 can include an opening 326. The opening 326 can have a corresponding shape and size to the vent 308. The opening 326 can be larger than the vent 308. The substrate layer 320 forming the vent 308 can be disposed entirely below the top layer 322. The top layer 322 can fluidically seal a portion of the network 302. The top layer 322 can form, in part, one or more channels. The top layer 322 can form, in part, a reservoir of the valve 310. The top layer 322 can include an opening 358. The opening 358 can facilitate the passage of signals for detection. The opening 358 can accommodate an upward projection of the reaction chamber 304. The opening 358 can accommodate a lens. In some embodiments, the top layer 322 can cover a portion of the reaction chamber 304. The opening 358 can be disposed over the reaction chamber 304. In some embodiments, the top layer 322 covers at least a portion of the reaction chamber 304. The top layer 322 can be transmissible to light or other signals. The top layer 322 can cover at least a portion of the first side 316 of the substrate layer 320. In some embodiments, the top layer 322 does not cover any portion of the reaction chamber 304. The top layer 322 can facilitate on-cartridge detection. In some embodiments, the cartridge 300 does not include the top layer 322. The top surface of one or more components of the network 302 can be formed by the substrate 320.

The cartridge 300 can include a bottom layer 328. The bottom layer 328 can couple to the second side 318 of the substrate layer 320 when the cartridge 300 is assembled. The bottom layer 328 can underlie one or more components of the substrate 320. The bottom layer 328 can form the bottom of the cartridge 300, or a portion of the bottom of the cartridge 300. The bottom layer 328 can form the network 302, or a portion thereof. The bottom layer 328 can form a flat external bottom surface of the cartridge 300. In some embodiments, the bottom layer 328 does not include an opening. The bottom layer 328 can fluidically seal a portion of the network 302. The bottom layer 328 can form, in part, one or more channels. The bottom layer 328 can form, in part, the valve 310. The bottom layer 328 can form, in part, the reaction chamber 304. The bottom layer 328 can seal the reaction chamber 304. The bottom layer 328 can cover the opening 314 of reaction chamber 304. The bottom layer 328 can cover at least a portion of the second side 318 of the substrate layer 320. In some embodiments, the bottom layer 328 can be transmissible to light or other signal. In some embodiments, the bottom layer 328 is not transmissible to light or other signal. In some embodiments, detection of an analyte of interest does not involve the bottom layer 328. In some embodiments, after heating of a sample in the reaction chamber 304, an instrument can pierce the top layer 322 or the bottom layer 328 and extract sample from the reaction chamber 304 for off-cartridge detection. In some embodiments, the cartridge 300 does not include the bottom layer 328. The bottom surface of one or more components of the network 302 can be formed by the substrate 320.

In some embodiments, the cartridge 300 can have a flat or substantially flat external surface. The bottom layer 328 can be planar. The bottom layer 328 can have a flat bottom surface. The bottom layer 328 can define the reaction chamber 304. The reaction chamber 304 can have a flat or substantially flat external surface. The reaction chamber 304 can be planar. The reaction chamber 304 can have a flat bottom surface. The cartridge 300 can be shaped to correspond with a heater assembly described herein. The bottom layer 328 can define the valve 310. The valve 310 can have a flat or substantially flat external surface. The valve 310 can be planar. The valve 310 can have a flat bottom surface. The cartridge 300 can be shaped to correspond with a heater assembly described herein. The heater assembly can be configured to be positioned under the cartridge 300. The heater assembly can be configured to be positioned under the reaction chamber 304. The heater assembly can be configured to be positioned under the valve 310. The heater assembly can have a corresponding flat surface to mate with the flat bottom of the cartridge 300. A benefit of this flat shape of the external surface can include greater uniformity of temperature control.

In some embodiments, the reaction chamber 304 can be a flat bottom chamber. The lower surface of the reaction chamber 304 can be formed from the bottom layer 328. The bottom layer 328 can have a flat upper surface. The bottom layer 328 can form the flat bottom of the reaction chamber 304. The flat shape of the bottom layer 328 can advantageously concentrate the PCR-ready sample along the surface area of the reaction chamber 304. The flat shape of the bottom layer 328 can prevent or limit pooling of fluid. The flat shape of the bottom layer 328 can spread the fluid across a greater surface area for heating. The flat shape of the bottom layer 328 can promote uniform heating of the fluid. A benefit of this flat shape of the internal surface can include greater uniformity of temperature control.

The top layer 322 and the bottom layer 328 can be the same material. The top layer 322 and the bottom layer 328 can be different materials. In some embodiments, the top layer 322 and the bottom layer 328 can be bonded to the substrate layer 320. In some embodiments, the top layer 322 and the bottom layer 328 can be bonded to one or more intermediate layers. The top layer 322 and the bottom layer 328 can be adhered with adhesive. The top layer 322 and the bottom layer 328 can be heat sealable.

The cartridge 300 can include a lower channel set 330, 332. The lower channel set 330, 332 can be formed by the substrate layer 320 and the bottom layer 328. The bottom of the lower channel set 330, 332 can be formed by the bottom layer 328. The lower channel set 330, 332 can extend from the second side 318 of the substrate layer 320. The bottom of the lower channel set 330, 332 can be formed by the bottom layer 328. The lower channel set 330, 332 can include a first lower channel 330. The first lower channel 330 can connect to the inlet 306. The first lower channel 330 can connect to the valve 310. The first lower channel 330 can connect to the reaction chamber 304. The first lower channel 330 can connect to a lower edge 344 of the reaction chamber 304. The lower channel set 330, 332 can include a second lower channel 332. The second lower channel 332 can connect to the vent 308. The second lower channel 332 can connect to the valve 310. The lower channel set 330, 332 can form an H-shape. The lower channel set 330, 332 can be non-symmetric. The lower channel set 330, 332 can be sealed by the valve 310.

The cartridge 300 can include an upper channel 336. The upper channel 336 can be formed by the substrate layer 320 and the top layer 322. The top of the upper channel 336 can be formed by the top layer 322. The upper channel 336 can extend from the first side 316 of the substrate layer 320. The upper channel 336 can connect to the reaction chamber 304. The upper channel 336 can connect to an upper edge 342 of the reaction chamber 304.

The cartridge 300 can include a through channel 340. The through channel 340 can be formed by the substrate layer 320, the top layer 322, and the bottom layer 328. The through channel 340 can extend entirely through the substrate layer 320. The top of the through channel 340 can be formed by the top layer 322. The bottom of the through channel 340 can be formed by the bottom layer 328. In some embodiments, the through channel 340 can have a substantially vertical orientation relative to the first side 316 and the second side 318 of the substrate layer 320. In some embodiments, the through channel 340 can be skewed relative to vertical. The through channel 340 can connect the second lower channel 332 and the upper channel 336. The through channel 340 can be associated with the vent 308.

The network 320 can include a fill channel 346. The fill channel 346 can connect the inlet 306 to the reaction chamber 304. The fill channel 346 can include the first lower channel 330. The first lower channel 330 can lead from the inlet 306. The first lower channel 330 can pass by and in close proximity to the valve 310. The fill channel 346 can extend along the bottom layer 328. The fill channel 346 can be formed by the substrate layer 320 and the bottom layer 328. The fill channel 346 can extend to the bottom surface of the reaction chamber 304. The fill channel 346 can allow the reaction chamber 304 to fill from the bottom of the reaction chamber 304. The fill channel 346 can connect to the lower edge 344 of the reaction chamber 304. The fill channel 346 can be along the second side 318 of the substrate 320. The fill channel 346 can lead from the inlet 306, passing by the valve 310 and terminating at the reaction chamber 304. The fill channel 346 can be linear or substantially linear. The fill channel 346 can be planar. The fill channel 346 can be formed by the planar surface of the bottom layer 328. Alternatively, the fill channel 346 can have any another configuration described herein.

The network 302 can include a vent channel 348. The vent channel 348 can connect the reaction chamber 304 to the vent 308. The vent channel 348 can include the upper channel 336. The upper channel 336 can lead from the reaction chamber 304. The vent channel 348 can connect to the upper edge 342 of the reaction chamber 304. The vent channel 348 can be along the first side 316 of the substrate 320. The vent channel 348 can include the through channel 340. The vent channel 348 can pass through the substrate layer 320. The vent channel 348 can include the second lower channel 332. The second lower channel 332 can pass by and in close proximity to the valve 310. The second lower channel 332 can lead to the vent 308. The vent 308 can extend through the substrate layer 320. The vent 308 can be open on the first side 316 of the substrate layer 320. The vent channel 348 can include a transition from the upper surface to the lower surface of the substrate layer 320. The vent 308 can extend through the substrate layer 320 from the second side 318 to the first side 316. The vent 308 can allow gas to escape from the first side 316 of the substrate layer 320. In other embodiments, the vent 308 can allow gas to escape from the second side 318 of the substrate layer 320. The vent 308 can exit the cartridge 300 on either the top surface through a via as embodied here, or directly to the bottom surface.

The vent channel 348 can form a tortuous path. The vent channel 348 can vent gas from the upper edge 342 of the reaction chamber 304. The vent channel 348 can be shaped to maximize the fill volume of the reaction chamber 304. The vent channel 348 can be connected to the upper edge 342. The reaction chamber 304 can fill to the upper edge 342 without allowing liquid to enter the vent channel 348. Thus the fluid capacity of the reaction chamber 304 extends to the upper edge 342. The vent channel 348 can be positioned to limit fluid flow into the vent channel 348. The vent channel 348 can be positioned to allow gas to escape from the upper portion of the reaction chamber 304. The vent channel 348 can allow the reaction chamber 304 to vent gases from the upper edge 342 of the reaction chamber 304. The vent channel 348 can be formed from the substrate layer 320, the top layer 322, and the bottom layer 328. The vent channel 348 can extend along the first side 316 and the second side 318 of the substrate layer 320. The upper channel 336 can lead from the reaction chamber 304 along the first side 316, to the through channel 340 to the second side 318 of the substrate layer 320, passing by the valve 310, and terminating at the vent 308. Alternatively, the vent channel 348 can have any another configuration described herein.

The cartridge 300 can include channels configured to facilitate the sealing of the fill channel 346 and the vent channel 348. The valve 310 can include a first valve channel 350. The first valve channel 350 can be connected to the first lower channel 330. The first valve channel 350 can have increasing cross-section toward the first lower channel 330. The first valve channel 350 can be formed from the substrate layer 320 and the bottom layer 328. The valve 310 can include a second valve channel 352. The second valve channel 352 can be connected to the second lower channel 332. The second valve channel 352 can have increasing cross-section toward the second lower channel 332. The second valve channel 352 can be formed from the substrate layer 320 and the bottom layer 328. The increasing cross-section of the valve channels 350, 352 can promote fluidic capillary action of a sealable material from the valve 310 toward the lower channels 330, 332. The valve 310 can include a reservoir 360. The valve 310 can include the sealable material. The sealable material can block passage of material from the first valve channel 350 to the second valve channel 352 before the valve 310 is actuated. The sealable material, before the valve 310 has been actuated, prevents the flow of fluid from the fill channel 346 to the vent channel 348. The sealable material can flow from the valve channels 350, 352 to the lower channels 330, 332 when actuated. The sealable material, after the valve 310 has been actuated, prevents the flow of fluid to the inlet 306 and the vent 308. The geometry of the valve channels 350, 352 and the reservoir 360 promotes complete and robust sealing of the lower channels 330, 332. In some embodiments, the reservoir 360 is heated from the top, such as through the top layer 322. In some embodiments, the reservoir 360 in heated from the bottom, such as through the bottom layer 328. The reservoir 360 can be heated by one or more heat sources. The valve 310 can include any of the features of valve 110, 210 described herein.

The cartridge 300 can include the reaction chamber 304. The reaction chamber 304 can be formed from the substrate layer 320 and the bottom layer 328. The reaction chamber 304 can include an exterior bottom surface that is flat. The bottom layer 328 can form a flat or substantially flat surface. The reaction chamber 304 can have a flat shape to cause liquid contents to spread along a surface area of the reaction chamber 304 as the fluid enters the reaction chamber 304. The reaction chamber 304 can have a height that is slightly less than the total height of the cartridge 304. The first side 316 can form the top surface of the reaction chamber 304. The bottom layer 328 can form the bottom surface of the reaction chamber 304. The reaction chamber 304 can be a thin wall reaction chamber 304. The first side 316 can form a thin wall. The first side 316 can be a thin wall to facilitate detection. The reaction chamber 304 can effectively transfer light across the wall thickness of the first side 316 of the substrate layer 320 to detect signals from the contents of the reaction chamber. The bottom layer 328 can form a thin wall. The bottom layer 328 can be a thin wall to facilitate the transfer of heat to the contents of the reaction chamber 304. The reaction chamber 304 can effectively transfer heat across the wall thickness of the bottom layer 328 to heat the contents of the reaction chamber. The reaction chamber 304 can have thin walls compared to the volume of the reaction chamber 304. The reaction chamber 304 can have walls with a thickness between 10 μm and 100 μm. The reaction chamber 304 can have uniform wall thickness at the first side 316. The reaction chamber 304 can have non-uniform wall thickness at the first side 316 due to a projection. The reaction chamber 304 can have uniform wall thickness at the bottom layer 328. The reaction chamber 304 can have generally uniform wall thickness at the first side 316 and at the bottom layer 328. The reaction chamber 304 can have non-uniform wall thickness, for instance the reaction chamber 304 can have a thicker top wall than bottom wall.

The reaction chamber 304 can have any elongate shape. The reaction chamber 304 can have curved edges. The reaction chamber 304 can form a well in the cartridge 300. The reaction chamber 304 can receive a volume of amplification ready sample. The reaction chamber 304 can receive a volume of fluid greater than 50 μl. The reaction chamber 304 can receive a volume of fluid greater than 75 μl. The reaction chamber 304 can receive a volume of fluid greater than 100 μl. In some embodiments, the maximum volume of the reaction chamber 304 is 79 μl. The cartridge can be configured to receive volumes of fluid, such as an amplification ready sample, that is about 1 μl to about 500 μl, such as from 1-200 μl, or from 60-80 μl, or from 50-100 μl, or from 25-125 μl.

The substrate layer 320 can include a projection 356. The projection 356 can extend from the reaction chamber 304. The reaction chamber 304 can include a height H2 greater than the average height H1 of the substrate layer 320. The projection 356 can extend above a general plane of the first side 316 of the substrate layer 320. The reaction chamber 304 can include a larger reservoir to facilitate amplification of larger sample volume.

A non-limiting implementation of a microfluidic cartridge according to the present technology will now be described with reference to FIGS. 6A-6E. FIGS. 6A-6C illustrate an indexer assembly. FIG. 6A shows an isometric view of cartridges 300 with the indexer assembly. FIG. 6B shows an exploded view of the cartridges 300 with the indexer assembly. FIG. 6C shows another view of the cartridges 300 with the indexer assembly. FIGS. 6D-6E illustrates a reel assembly. FIG. 6D shows an isometric view of the cartridges 300 with the reel assembly. FIG. 6E shows an exploded view of the cartridges 300 with the reel assembly.

The cartridge 300 can be configured to interact with one or more assemblies. The assemblies can allow for sample processing, as described herein. Cartridges of the present technology can include a single lane cartridge to process a single sample in a single network. The cartridge 300 can include an inlet 306 configured to receive fluid. The inlet 306 can be configured to receive a pipette at any time during processing. The sample can be added to a cartridge 300 at any suitable location in the indexer assembly. The sample can be added to the cartridge 300 manually or by an automated sample input device. The sample can be added to a cartridge 300 at any suitable location in the reel assembly. The sample can be added to the cartridge 300 manually or by an automated sample input device. The sample can enter the cartridge 300 before interacting with assembly. The sample can enter the cartridge 300 while interacting with assembly. The assembly can facilitate the application of heat for processing. The assembly can facilitate the projection of light for detection.

The assembly can perform one or more functions to process the sample. The indexer assembly can be used for amplification of samples. The indexer assembly can be used for detection of samples. The indexer assembly can be used for amplification of samples, but not detection. The indexer assembly can be used for detection of samples, but not amplification. The reel assembly can be used for amplification of samples. The reel assembly can be used for detection of samples. The reel assembly can be used for amplification of samples, but not detection. The reel assembly can be used for detection of samples, but not amplification. The assembly can omit one or more functions described herein.

The projection 356 can align with a detector 380. The detector 380 can be configured for monitoring, in real-time, one or more fluorescent signals emanating from the reaction chamber 304. The detector 380 can include a light source and a light detector. The light source and the light detector can have any feature of the light source 182, 282 and light detector 184, 284 described herein. The detector 380 can include one LED and one photodiode. The LED is configured to transmit a beam of focused light on to the projection 356 of the cartridge 300. The photodiode is configured to receive light that is emitted from the projection 356 of the cartridge 300. The detector 380 can include any feature of the detector 180, 280 described herein. The top layer 322 can include the opening 358. The projection 356 can extend through the opening 358. In some embodiments, the projection 356 can be solid. In some embodiments, the projection 356 can be hollow. In some embodiments, the projection 356 can function as a lens to direct light toward the reaction chamber 304. In some embodiments, the projection 356 can function as a lens to amplify a signal from the reaction chamber 304.

The heater assembly 370 can include any of the features of the heater assembly 170, 270. The detector 380 can include any of the features of the detector 180, 280. The detector 380 can include any of the features of the assembly 190, 290. The indexer assembly and the reel assembly are examples of systems to process one or more cartridges 300. The cartridges 300 can be processed independently. The cartridges 300 can be processed sequentially. The cartridges 300 can be processed simultaneously. While cartridge 300 is illustrated, the indexer assembly and the reel assembly can be configured to process any cartridge, including cartridge 100, 200.

The heater assembly 370, as shown in FIG. 6E, can be a platform or bay that receives the cartridge 300. The heater assembly 370 can include a flat surface to receive the flat bottom of the cartridge 300. In some embodiments, the heater assembly 370 can apply heat to the flat external surface of the cartridge 300. The heater assembly 370 can apply heat to the bottom layer 328 of the cartridge 300. The heater assembly 370 can apply heat to the second side 318 of the substrate layer 320. The heater assembly 370 can be positioned below the cartridge 300. In some embodiments, the heater assembly 370 can apply heat to the top layer 322 of the cartridge 300. The heater assembly 370 can apply heat to the first side 316 of the substrate layer 320. The heater assembly 370 can be positioned above the cartridge 300. The heater assembly 370 can include one or more heaters. The heater assembly 370 can include one or more contact heat sources. The heater assembly 370 can include a valve heater 372. The valve heater 372 can be positioned relative to the valve 310 when the cartridge 300 is received by the heater assembly 370. The valve heater 372 can apply heat to soften the sealable material. The valve heater 372 can apply heat to allow the flow of the sealable material into the fill channel 346 and the vent channel 348. The protocol can cease the application of heat to allow the sealable material to solidify within the fill channel 346 and the vent channel 348. The sealable material can seal the fill channel 346 and the vent channel 348 to prevent the escape of fluid past the sealable material to the inlet 306 and the vent 308. The valve heater 372 is configured to align with and deliver heat to the valve 310. The valve heater 372 is configured to align with and deliver heat to one or more of the reservoir 360, the first valve channel 350, the second valve channel 352, the first lower channel 330 and the second lower channel 332. The heater assembly 370 can apply heat to the flat bottom of the cartridge 300 to the valve 310.

The heater assembly 370 can include a reaction chamber heater 374. The reaction chamber heater 374 is configured to apply heat to the contents of the reaction chamber 304. The reaction chamber heater 374 can apply heat to the flat bottom of the cartridge 300. The reaction chamber heater 374 can apply heat to the bottom layer 328. The bottom layer 328 can transfer heat to the fluid in the reaction chamber 304. The fluid in the reaction chamber 304 can spread along the surface area of the reaction chamber 304. The reaction chamber 304 can have a large surface area, thereby increasing the surface area to receive heat. The fluid can form a fluidic layer with a large surface area within the reaction chamber 304. The large surface area can facilitate uniform heating and cooling. The large surface area can ensure efficient energy transfer. The large surface area can promote uniform heating. The large surface area can be rapidly heated and cooled, leading to faster processing times. The reaction chamber heater 374 can have a similar surface area as the surface area of the reaction chamber 304. The reaction chamber heater 374 can have a larger surface area than the reaction chamber 304. The reaction chamber heater 374 can uniformly heat the reaction chamber 304 through the bottom layer 328. The reaction chamber heater 374 can be a contact heat source. The reaction chamber heater 374 can undergo or apply any thermal cycling protocol. In some embodiments, the heater assembly 370 can be stationary relative to the cartridge 300. In some embodiments, the heater assembly 370 can move relative to the cartridge 300. In some embodiments, the cartridge 300 can move relative to the heater assembly 370.

The bottom layer 328 can cover the opening 314 of the reaction chamber 304. The bottom layer 328 can be positioned between the reaction chamber heater 374 and the contents of the reaction chamber 304. The bottom layer 328 can be formed of a material that facilitates the transfer of heat. The bottom layer 328 can be conductive. The bottom layer 328 can have an external planar surface. The external planar surface can facilitate moving the cartridge 300. For example, the external planar surface can facilitate moving the cartridge 300 in a substantially horizontal direction or orientation. The external planar surface can increase contact between the heater assembly 370 and the cartridge 300. The external planar surface can increase contact between the reaction chamber heater 374 and the reaction chamber 304. The external planar surface can increase contact between the valve heater 372 and the valve 310. The bottom layer 328 can have internal planar surface. The internal planar surface forms the flat bottom of the reaction chamber 304. The internal planar surface can increase the surface area during heating of the reaction chamber 304. The amplification ready sample can spread along the surface area of the internal planar surface for substantially uniform heating. In some embodiments, the bottom layer 328 forms a thin wall of the reaction chamber 304. The thin wall can increase the efficiency of heat transfer. The thin wall can shorten processing time.

The detector 380 is configured to detect fluorescence from the reaction chamber 304. The detector 380 can have any of the features of the detector 180, 280. The detector 380 can include a light source and a light detector. The detector 380 can include any additional optical components. The detector 380 can be configured to transmit a beam of focused light onto the reaction chamber 304. The detector 380 can be configured to transmit a bean of diffuse light onto the reaction chamber 304. The detector 380 can transmit light onto the projection 356. The projection 356 can function as a lens to direct light to the reaction chamber 304. The photodiode is configured to receive light that is emitted from the reaction chamber 304. The photodiode can receive light from the projection 356. The projection 356 can function as a lens to amplify light from the reaction chamber 304. The light source can be at an angle relative to the reaction chamber 304. The light detector can be vertically oriented relative to the reaction chamber 304. The detector 380 can be a single-color detection system configured to detect a single probe. The detector 380 can be a multi-color detection system configured to detect multiple probes. The detector 380 can be used to detect the presence of liquid in the reaction chamber 304 and/or the presence of the cartridge 300.

The systems can include an assembly 390. The assembly 390 can include one or more detectors 380. The number of detectors 380 can correspond to the number of cartridges 300 received in the assembly 390. In some embodiments, the detector 380 can be stationary within the assembly. In the illustrated embodiments, each assembly 390 can include up to six detectors 380. The number of detectors 380 can correspond to the maximum number of cartridges 300 that the assembly 390 can receive. The assembly 390 can interact with six cartridges 300 in some embodiments. The assembly 390 can interact with multiple cartridges simultaneously. The assembly 390 can interact with multiple cartridges sequentially. The assembly 390 can include a dock 392 to receive a detector 380. In the illustrated embodiments, the assembly 390 can include six docks 392. In the illustrated embodiments, the assembly 390 has five mounted detectors 380 and is configured to receive up to six detectors 380. There is one dock 392 that does not have a corresponding detector 380 in order to show the dock 392.

The system can combine the principles of a consumable cartridge design with a reusable heater assembly 370, a reusable detector 380, and a reusable assembly 390. The larger surface area of the reaction chamber 304 can be utilized for one or more tests including those detecting viral loads. The flat-bottomed reaction chamber 304 and the heater assembly 370 can have a matched geometry. The heater assembly 370 and the cartridge 300 can be shaped to maximize thermal transfer. The cartridge 300 can include a uniform wall thickness in the bottom layer 328 forming the reaction chamber 304. The substrate layer 320 can be selectively cored to provide a cutout for the reaction chamber 304. The heater assembly 370 can heat a larger surface area of the reaction chamber 304 based on the geometry of the reaction chamber 304. The projection 356 of the reaction chamber 304 and the detector 380 can facilitate detection by the detector 380 mounted in the assembly 390. The projection 356 can function as a lens to transfer or amply light.

The single lane nature of the cartridge 300 can simplify on-cartridge operations. The valve 310 can simultaneously seal two channels, thereby sealing the reaction chamber 304 for amplification. The single lane nature of the cartridge 300 can load a single sample for both amplification and detection. The single lane nature of the cartridge 300 can process a single sample. The single lane nature of the cartridge 300 can undergo a single amplification protocol. The single lane nature of the cartridge 300 can undergo a single detection protocol. The single lane nature of the cartridge 300 is used when the single sample is processed. The single lane nature of the cartridge 300 can be disposed after processing a single sample. The single lane nature of the cartridge 300 can utilize only the reagents necessary for the diagnostic test, without excess waste of reagents. The single lane nature of the cartridge 300 can utilize the single reaction chamber 304, without waste of excess reaction chambers.

The indexer assembly of FIGS. 6A-6C is configured for automated amplification and detection of one or more cartridges 300. The indexer assembly can include a stack of cartridges 300. The stack of cartridges can be loaded into a cartridge loading station 364. The cartridge loading station 364 can stack two or more cartridges 300 vertically. The flat bottom of the cartridge 300 via the bottom layer 328 can allow the cartridges 300 to stack. The cartridges 300 can be stacked directly on top of each other. The cartridges 300 can be stacked on a vertical conveyor or shelf. The cartridges 300 are configured to be lifted to the top of the cartridge loading station 364.

The indexer assembly can include a cartridge transfer mechanism. The top-most cartridge 300 can be configured to move horizontally. The cartridge can move within the cartridge loading station 364. The cartridge transfer mechanism can move the cartridge 300 to an indexing wheel 366. The cartridge transfer mechanism can be any mechanism that allows movement of the cartridge 300. The cartridge transfer mechanism can be positioned below the cartridge 300. The flat external surface of the cartridge 300 can facilitate movement by the cartridge transfer mechanism. The cartridge transfer mechanism can be a conveyor. The cartridge transfer mechanism moves the cartridge 300 from the cartridge loading station 364 to the indexing wheel 366. The indexing wheel 366 can include a slot 368 to receive the cartridge 300. The cartridge transfer mechanism that moves the cartridge 300 can move the cartridge in a linear path between the cartridge loading station 364 and the indexing wheel 366. The slot 368 can be aligned with the cartridge loading station 364 when the indexing wheel 366 receives the cartridge 300. The indexing wheel 366 can rotate about an axle 376. The axle 376 can be located at the center of the indexing wheel 366. The system can include a protocol to rotate the indexing wheel 366 in synchronization with the cartridge transfer mechanism moving the cartridge 300 into the slot 368. The system can continuously move the next cartridge 300 from the cartridge loading station 364 into the next slots 368 of the rotating indexing wheel 366. The indexing wheel 366 can include any number of slots 368 including one, two, three, four, five, six, seven, eight, nine, ten, eleven, twelve, twenty-four, forty-eight, or any range of two of the foregoing values. The number of slots 368 can correspond to the number of assemblies 390.

The indexing wheel 366 rotates to an available assembly 390. The assembly 390 can be a thermocycler reader station. The assembly 390 can include a corresponding heater assembly 370. The assembly 390 can include a corresponding detector 380. In some embodiments, the heater assembly 370 travels with the cartridge 300 via the cartridge transfer mechanism. In some embodiments, the heater assembly 370 moves with the indexing wheel 366. In some embodiments, the heater assembly 370 moves separately from the indexing wheel 366. In some embodiments, the heater assembly 370 does not move. In some embodiments, the heater assembly 370 is stationary relative to the cartridge 300. In some embodiments, the heater assembly 370 is stationary relative to the assembly 390. In some embodiments, the heater assembly 370 is stationary relative to the detector 380. In some embodiments, the heater assembly 370 and the detector 380 are in a fixed relationship. In some embodiments, the heater assembly 370 receives the cartridge 300 from the indexing wheel 366 via the cartridge transfer mechanism. In some embodiments, the assembly 390 does not move. In some embodiments, the assembly 390 is stationary relative to the cartridge 300. In some embodiments, the detector 380 is stationary relative to the assembly 390. In some embodiments, the detector 380 and the assembly 390 are in a fixed relationship. In some embodiments, the assembly 390 receives the cartridge 300 from the indexing wheel 366 via the cartridge transfer mechanism.

The indexer assembly can include any number of heater assemblies 370 including one, two, three, four, five, six, seven, eight, nine, ten, eleven, twelve, twenty-four, forty-eight, or any range of two of the foregoing values. In some embodiments, the heater assembly 370 heats a single cartridge 300. In some embodiments, the heater assembly 370 heats more than one cartridge 300. In some embodiments, the heater assembly 370 heats more than one cartridge 300 according to a separate thermocycling protocols.

The indexer assembly can include any number of assemblies 390 including one, two, three, four, five, six, seven, eight, nine, ten, eleven, twelve, twenty-four, forty-eight, or any range of two of the foregoing values. The indexer assembly can include any number of detectors 380 within each assembly 390 including one, two, three, four, five, six, seven, eight, nine, ten, eleven, twelve, twenty-four, forty-eight, or any range of two of the foregoing values. In some embodiments, the assembly 390 monitors signals, in real-time, from a single cartridge 300. In some embodiments, the assembly 390 monitors signals, in real-time, from more than one cartridge 300. In some embodiments, the assembly 390 monitors signals, in real-time, from more than one cartridge 300 according to one or more detection protocols. In some embodiments, the detector 380 monitors signals, in real-time, from a single cartridge 300. In some embodiments, the detector 380 monitors signals, in real-time, from more than one cartridge 300 according to one or more detection protocols.

In some embodiments, the cartridge 300 is removed from heater assembly 370 via the cartridge transfer mechanism. In some embodiments, the cartridge 300 is removed from assembly 390 via the cartridge transfer mechanism. In some embodiments, the indexing wheel 366 can receive the used cartridge 300 in a slot 368. In some embodiments, the indexing wheel 366 rotates the used cartridge to a waste container. The cartridge transfer mechanism can deposit the used cartridge 300 in the waste container after amplification. In some embodiments, the used cartridge 300 moves with the indexing wheel 366. In some embodiments, the used cartridge 300 moves separately from the indexing wheel 366.

The reel assembly of FIGS. 6D-6E is configured for automated amplification and detection of one or more cartridges 300. The reel assembly can include a reel of cartridges 300. The reel of cartridges 300 can include two or more cartridges 300 coupled together. The top layers 322 of the cartridges 300 can be coupled. The substrate layers 320 of the cartridges 300 can be coupled. The bottom layers 328 of the cartridges 300 can be coupled. The reel of cartridges 300 can be flexible. The reel of cartridges 300 can be configured to form a coil. The reel of cartridges 300 can include cartridges 300 positioned side-to-side. The reel of cartridges 300 can include cartridges 300 stacked horizontally.

The reel assembly can include a cartridge advancing mechanism. The advancing mechanism can move the cartridge 300. The cartridge advancing mechanism can be any mechanism that allows movement of the reel of cartridges 300. The cartridge advancing mechanism can be a conveyor. The advancing mechanism can move the next cartridge 300 into position relative to the assembly 390. The advancing mechanism can move a set of cartridges 300 into position relative to the assembly 390. The assembly 390 can receive a number of detectors 380. In the illustrated embodiment, the assembly 390 can receive six detectors 380. The advancing mechanism can move a set of six cartridge 300 relative to the assembly 390. The advancing mechanism can move a set of six cartridges 300 for detection by the six detectors 380 received in the assembly 390. The advancing mechanism can advance cartridges 300 in sets of six. The advancing mechanism can position six amplification ready cartridges 300 under the assembly 390. The advancing mechanism can move six used cartridges 300 from the assembly 390. The reel of cartridges 300 can be advanced until all cartridges 300 are used.

The cartridge advancing mechanism moves one or more cartridges of the reel of cartridges 300 to the assembly 390. The assembly 390 can include the heater assembly 370 and the detector 380. The heater assembly 370 can heat a single cartridge 300. The detector 380 can detect light from a single cartridge 300. In the illustrated embodiment, six heater assemblies 370 are provided to heat six cartridges 300. In the illustrated embodiment, six detectors 380 are provided to detect signals from six cartridges 300. In some embodiments, the heater assembly 370 is stationary. In some embodiments, the detector 380 is stationary. In some embodiments, the heater assembly 370 is stationary relative to the detector 380. In some embodiments, the heater assembly 370 and the detector 380 are in a fixed relationship. In some embodiments, the heater assemblies 370 and the detectors 380 mounted in the assembly 390 receive the cartridges 300 from the cartridge advancing mechanism. The reel assembly can include any number of heater assemblies 370 including one, two, three, four, five, six, seven, eight, nine, ten, eleven, twelve, twenty-four, forty-eight, or any range of two of the foregoing values. In some embodiments, the heater assembly 370 heats a single cartridge 300. In some embodiments, the heater assembly 370 heats more than one cartridge 300. In some embodiments, the heater assembly 370 heats one or more cartridges 300 according to one or more thermocycling protocols. In one non-limiting example, the heater assembly 370 heats each of a plurality of cartridges 300 according to a different thermocycling protocol.

The reel assembly can include any number of assemblies 390 including one, two, three, four, five, six, seven, eight, nine, ten, eleven, twelve, twenty-four, forty-eight, or any range of two of the foregoing values. The reel assembly can include any number of detectors 380 within the assembly 390 including one, two, three, four, five, six, seven, eight, nine, ten, eleven, twelve, twenty-four, forty-eight, or any range of two of the foregoing values. In some embodiments, the assembly 390 monitors signals, in real-time, from a single cartridge 300. In some embodiments, the assembly 390 monitors signals, in real-time, from more than one cartridge 300. In some embodiments, the detector 380 monitors signals, in real-time, from a single cartridge 300. In some embodiments, the detector 380 monitors signals, in real-time, from more than one cartridge 300 according to one or more detection protocols. In one non-limiting example, the detector 380 monitors signals from each of a plurality of cartridges 300 according to a different detection protocol.

The cartridge advancing mechanism moves one or more cartridges of the reel of cartridges 300 from the assembly 390 after processing. The reel of cartridges 300 is sequentially fed into position relative to the assembly 390. In some embodiments, the used cartridges 300 is advanced relative to the assembly 390 via the cartridge advancing mechanism. In some embodiments, the cartridge advancing mechanism advances from left to right. The cartridges 300 to the left of the assembly 390 are ready for amplification and detection. The cartridges 300 to the right of the assembly 390 have undergone amplification and detection. The cartridge advancing mechanism can dispose of the reel of cartridges 300 when all cartridges 300 of the reel of cartridges 300 have undergone amplification and detection.

The cartridge 300 can be flat as described herein. The cartridge 300 can aid in automation. The flat external bottom surface of the cartridge 300 can facilitate automation by making the cartridge easier to move. By having a flat bottom, the cartridge 300 is easier to automate because it can slide in the horizontal plane in addition to being able to move in the vertical plane. In some embodiments, the cartridge 300 can be oriented with the heating side facing down. In some embodiments, the cartridge 300 can be oriented with the optics side facing up. This allows for flexibility in the instrument design for placing the detector 380 and heater assembly 370.

The flat external bottom surface of the cartridge 300 can facilitate energy transfer. The cartridge 300 can facilitate the application of heat to the contents of the reaction chamber 304. The cartridge 300 can facilitate the application of heat to the contents of the valve 310. The cartridge 300 can be configured to be heated from the bottom. The benefit is that gravity assists with fluid being on top of heater if there is an underfill. The benefit is that microfluidic properties assists in spreading the fluid along a large surface area for uniform heating. The benefit is the gravity facilitates the contact between the cartridge 300 and the heater assembly 370. In some embodiments, pressure is applied by the assembly 390 or a force member to facilitate the contact between the cartridge 300 and the heater assembly 370

In use, a pipette tip is inserted into the cartridge 300. Fluid is dispensed and flows through the fill channel 346 to the reaction chamber 304. The vent 308 allows air to escape. The valve 310 is heated to seal off the cartridge 300. In some embodiments, a stack of cartridges is loaded into the cartridge loading station 364. The cartridge transfer mechanism moves a cartridge 300 onto the indexing wheel 366. The indexing wheel 366 rotates to available thermocycler reader station. The cartridge transfer mechanism moves the cartridge 300 into the thermocycler. The cartridge transfer mechanism moves the cartridge 300 to waste after amplification and/or detection. In some embodiments, the reel of cartridges 300 is loaded into an instrument. The reel advancing mechanism advances the next set of cartridges into the thermocycler reader. The used cartridges advance forward after amplification and/or detection and the reel is thrown in waste after all cartridges are used.

The cartridge 300 can include many features. The projection 356 can create a lensing effect. The cartridge 300 can be a single molded substrate 320 with layers 322, 328 on each side to cover the open microfluidic channels and chambers. The open microfluidic channels and chambers can be formed during molding of the substrate 320. In some embodiments, the cartridge 300 can include two molded parts welded or adhered together to create the microfluidic channels and chambers. In some embodiments, only the surface where the sample is analyzed needs to be optically clear. The material could be polyproylene. In some embodiments, the projection 356 is omitted. The substrate layer 320 can include an optically transparent material. In some embodiments, the top layer 322 can cover the reaction chamber 304. The top layer can be optically transparent. The cartridge 300 can have features to minimize bubbles in the reaction chamber 304. In some embodiments, a mastermix can be added to the cartridge 300 before sealing with layers. This makes the cartridge assay-specific. This could reduce waste by eliminating additional consumables in the instrument. In some embodiments, a barcode can be etched onto the molded plastic of the substrate layer 320, which can eliminate custom label printing. In some embodiments, the bottom layer 328 can be foil. The cartridge 300 can be assembled in a reel for automation. The cartridge 300 can be stacked and indexed for automation. The cartridge 300 can be a single use consumable. The cartridge 300 can have reagents in the reaction chamber 304.

The cartridge 100, 200, 300 can be considered a reaction consumable. The cartridge 100, 200, 300 receives the amplification-ready sample for amplification. The assemblies 190, 290, 390 described herein can receive one or more cartridge 100, 200, 300 for amplification and detection (e.g., any number of cartridges including 1, 2, 3, 4, 5, 6, 7, 8, 9, 10, 11, 12, 24, 36, 48, 60, 72, 84, 96 or any range of two of the foregoing values). The cartridge 100, 200, 300 can include a single well or reaction chamber 104, 204 for amplification. The cartridge 100, 200, 300 receives a single sample from a single patient.

The cartridge 100, 200, 300 can receive a prepared sample. The sample can be prepared by one or more chemical reactions. The sample can be prepared by one or more physical reactions. The sample can be prepared by lysing the cells. The sample can be prepared by heating. The sample can be prepared by magnetic separation. The sample can be prepared by mixing one or more solutions. The sample can be prepared by mixing one or more reagents. The sample can be prepared at a location remote from the cartridge 100, 200, 300. The sample can be prepared in a separate module of an assembly that applies heat to the sample and detects signals from the sample. The sample can be combined with one or more master mixes. The sample can be combined with one or more probes for detection. One or more polynucleotides can be extracted from the sample.

The cartridge 100, 200, 300 can be disposable. The sample can remain on the cartridge after amplification. The sample can be sealed within the reaction chamber 104, 204, 304 by the valve 110, 210, 310. The cartridge 100, 200, 300 can prevent exposure to the sample therein. The cartridge 100, 200, 300 can be considered a single lane cartridge. The cartridge 100, 200, 300 can have a single inlet 106, 206, 306. The cartridge 100, 200, 300 can have a single reaction chamber 104, 204, 304. The cartridge 100, 200, 300 can have a single valve 110, 210, 310. The cartridge 100, 200, 300 can have a single vent 108, 208, 308. The cartridge 100, 200, 300 can have a single fill channel 146, 246, 346. The cartridge 100, 200, 300 can have a single vent channel 148, 248, 348.

The cartridge 100, 200, 300 can receive the prepared sample. The sample can be combined with a master mix prior to loading in the inlet 106, 206, 306 of the cartridge 100, 200, 300. The sample can be combined with a master mix depending on the one or more tests to be run. The sample can be combined with a master mix depending on the one or more pathogens to be detected.

The cartridge 100, 200, 300 can be designed for effective heating of the reaction chamber 104, 204, 304. The reaction chamber 104, 204, 304 can interface with the heater assembly 170, 270, 370. The contents of the reaction chamber 104, 204, 304 can undergo cyclical heating. The heater assembly 170, 270, 370 can heat according to a temperature profile that cyclically heats between two temperatures. The heater assembly 170, 270, 370 can maintain a temperature for a period of time. The temperature can be maintained such that the contents of the reaction chamber 104 are heated or cooled. The heater assembly 170, 270, 370 can maintain at least two temperatures for a period of time. The temperature can be maintained such that the contents of the reaction chamber 104 have a constant temperature throughout the reaction chamber 104, 204, 304 during each cycle of a cycling protocol. The heater assembly 170, 270, 370 can be shaped to rapidly change the temperature of the contents of the reaction chamber 104, 204, 304. The heater assembly 170, 270, 370 can maximize surface area in contact with the reaction chamber 104, 204, 304. The reaction chamber 104, 204, 304 can be thin-walled to effectively transfer heat to the contents of the reaction chamber 104, 204, 304.

The heater assembly 170, 270, 370 can apply heat to one or more cartridges. The cartridges can be identical to each other or they can differ from each other. The heater assembly 170, 270, 370 can simultaneously heat two or more reaction chambers. The heater assembly 170, 270, 370 can sequentially heat two or more reaction chambers. The heater assembly 170, 270, 370 can heat two or more reaction chambers in parallel. The heater assembly 170, 270, 370 can apply heat to a reaction chamber of one cartridge, but not apply heat to a reaction chamber of another cartridge.

The heater assembly 170, 270, 370 can simultaneously heat two or more valves. The heater assembly 170, 270, 370 can sequentially heat two or more valves. The heater assembly 170, 270, 370 can heat two or more valves in parallel. The heater assembly 170, 270 can apply heat to a valve of one cartridge, but not apply heat to a valve of another cartridge.

The heater assembly 170, 270, 370 can have any shape to interface with one or more cartridges. The heater assembly 170, 270, 370 can include the valve heater 172, 272, 372 and the reaction chamber heater 174, 274, 374. The valve heater 172, 272, 372 and the reaction chamber heater 174, 274, 374 can be independently actuated in relation to a single cartridge 100, 200, 300. The valve heater 172, 272, 372 can apply heat to seal the reaction chamber 104, 204, 304 before the reaction chamber heater 174, 274, 374 heats the contents of the reaction chamber 104, 204, 304. The heater assembly 170, 270, 370 can heat one portion of the cartridge without heating another portion of the cartridge. The heater assembly 170, 270, 370 can sequentially heat regions of the cartridge 100, 200, 300.

The reaction chamber heater 174, 274, 374 and the conductive element 176, 276, 376 can be a multi-well heater. The heater assembly 170, 270, 370 can include one or more contact heaters. The conductive element 176, 276, 376 can be a cup that receives the reaction chamber 104, 204, 304. The reaction chamber 104, 204, 304 can have any three-dimensional shape. The conductive element 176, 276, 376 can include a three-dimensional cavity. The conductive element 176, 276, 376 can surround the reaction chamber 104, 204, 304. The conductive element 176, 276, 376 can be heated by the reaction chamber heater 174, 274, 374. The reaction chamber heater 174, 274, 374 can be a heat block. The reaction chamber heater 174, 274, 374 can heat two or more conductive elements 176, 276, 376 of two or more cartridges 100, 200, 300. The valve heater 172, 272, 372 can be a heat block. The valve heater 172, 272, 372 can apply heat to the reservoir 160, 260, 360. The valve heater 172, 272, 372 can apply heat to the valve channels 150, 152, 250, 252, 350, 352. The valve heater 172, 272, 372 can be positioned to control flow characteristics of the TRS. The valve heater 172, 272, 372 can heat two or more valves 110, 210, 310 of two or more cartridges 100, 200, 300.

The heater assembly 170, 270, 370 can heat two different areas of the cartridge 100, 200, 300. The heater assembly 170, 270, 370 can apply heat to an area near the valve 110, 210, 310. The heater assembly 170, 270, 370 can apply heat to an area near the reaction chamber 104, 204, 304. The heater assembly 170, 270, 370 can apply heat without unduly heating another portion of the cartridge. The valve 110, 210, 310 and the reaction chamber 104, 204, 304 can be spatially separated. The heater assembly 170, 270, 370 can apply heat with two or more types of heaters. The heater assembly 170, 270, 370 can apply heat with contact heaters. The heater assembly 170, 270, 370 can apply heat with resistive heaters. The heater assembly 170, 270, 370 can apply heat underneath the valve 110, 210, 310. The heater assembly 170, 270, 370 can apply heat from a planar heater. The heater assembly 170, 270, 370 can apply heat around the reaction chamber 104, 204, 304. The heater assembly 170, 270, 370 can apply heat circumferentially around the reaction chamber 104, 204, 304. The heater assembly 170, 270, 370 can prevent a thermal gradient within the reaction chamber 104, 204, 304 during amplification.

The valve 110, 210, 310 can isolate the sample within the reaction chamber 104, 204, 304 for amplification. The valve 110, 210, 310 can isolate the sample within the reaction chamber 104, 204, 304 for detection. The valve 110, 210, 310 can isolate the sample within the reaction chamber 104, 204, 304 for disposal. The valve 110, 210, 310 seals the sample within the cartridge 100, 200, 300 to prevent cross-contamination between samples. The valve 110, 210, 310 seals the sample within the cartridge 100, 200, 300 to prevent exposure to users.

The cartridge 100, 200, 300 minimizes dead volume within the cartridge 100, 200, 300. The reaction chamber 104, 204, 304 is filled from the top to maximize the volume for the reaction chamber 104, 204, 304. The reaction chamber 104, 204, 304 vents from the top to maximize the volume for the reaction chamber 104, 204, 304. The reservoir 160, 260, 360 spans the height of the substrate layer 120, 220, 320. The fill channel 146 spans the height of the substrate layer 120, 220, 320. The vent channel 148 spans the height of the substrate layer 120, 220, 320. The vent 108, 208, 308 spans the height of the substrate layer 120, 220, 320. The cartridge 100, 200, 300 utilizes gravity to fill the reaction chamber 104, 204, 304. The cartridge 100, 200, 300 utilizes gravity to fill the fill channel 146, 246, 346 from the inlet 106, 206, 306. The cartridge 100, 200, 300 utilizes gravity to disperse the TRS from the reservoir 160, 260, 360. The cartridge 100, 200, 300 utilizes the concept of gas rising to vent the reaction chamber 104, 204, 304.

The cartridge 100, 200, 300 can be utilized for syndromic testing. The cartridge 100, 200, 300 can be used once with a single amplification reaction. The cartridge 100, 200, 300 can be used to simultaneously target multiple pathogens, for instance for pathogens that have overlapping symptoms. The cartridge 100, 200, 300 can allow for rapid identification of bacteria, viruses, fungi, parasites, or other pathogens from a single sample within a single reaction chamber 104, 204, 304. The cartridge 100, 200, 300 can be fully integrated into systems for syndromic testing. The cartridge 100, 200, 300 can accept a larger volume of amplification-ready sample which may be beneficial for syndromic testing. The volume of amplification-ready sample can contain multiple reagents, probes, and other solutions of a master mix that are needed for amplification and detection within the reaction chamber 104, 204, 304. The sample can be prepared for one or more simultaneous tests. The sample can be mixed with one or more master mixes. The sample can include a large volume for testing. The sample can be mixed with multiple probes for multiplex detection within the single amplification region.

Amplification and detection occur within the single reaction chamber 104, 204, 304 of the cartridge 100, 200, 300. The single reaction chamber 104, 204, 304 can have a shape that promotes the sample flowing to the bottom of the reaction chamber 104, 204, 304. The reaction chamber 104, 204, 304 can be tapered. The exterior surface of the reaction chamber 104, 204, 304 can have a flat bottom. The sample can be cyclically heated. The sample can be heated for isothermal amplification or any other method that includes applying heat to a sample. The detector 180, 280, 380 can be positioned over the reaction chamber 104, 204, 304. The detector 180, 280, 380 can detect fluoresce from one or more probes in the sample. The reaction chamber 104, 204, 304 can be surrounded by the conductive elements 176, 276, 376 such that any temperature gradient within the reaction chamber 104, 204, 304 is minimized.

The user can prepare multiple samples for amplification, with each sample as an input into a single cartridge 100, 200, 300. The samples can be prepared with reagents for amplification. The sample preparation can be dependent on the tests to be run. The cartridge 100, 200, 300 can be generic to the test to be run. The cartridge 100, 200, 300 can be loaded with the prepared sample. In some embodiments, the cartridge 100, 200, 300 does not contain amplification reagents before the sample is loaded. In some embodiments, the cartridge 100, 200, 300 does not contain probes before the sample is loaded. The amplification-ready sample is loaded into the cartridge 100, 200, 300 for amplification and detection. The cartridges 100, 200, 300 are loaded into the assembly 190, 290, 390 for heating and detection. The cartridges 100, 200, 300 are individually addressable. Each cartridge can undergo independent heating within the assembly 190, 290, 390. Each cartridge can undergo independent amplification within the assembly 190, 290, 390. Each cartridge can undergo independent detection within the assembly 190, 290, 390.

The heating can be asynchronous. The valve 110, 210, 310 can be heated before the reaction chamber 104, 204, 304 is heated. Initially, the valve 110, 210, 310 is open to allow the reaction chamber 104, 204, 304 to be filled with amplification-ready sample from the inlet 106, 206, 306. The cartridge 100, 200, 300 is loaded into the assembly 190, 290, 390. The valve 110, 210, 310 is then closed to seal the fill channel 146, 246, 346 and the vent channel 148, 248, 348 by application of heat by the valve heater 172, 272, 372. The TRS in the reservoir 160, 260, 360 is heated before amplification. The heater assembly 170, 270, 370 allows for asynchronous heating of different regions of the cartridge 100, 200, 300.

The valve 110, 210, 310 seals by flowing TRS into a T-junction. The T-junction is formed by the intersection of the valve channels 150, 152, 250, 252, 350, 352 and the lower channel set 130, 132, 230, 232, 330, 332. The T-junction can include a flared section of the valve channel 150, 152, 250, 252, 350, 352 that may cause favorable capillary action to fill the lower channel set 130, 132, 230, 232, 330, 332. The intersection of the valve channels 150, 152, 250, 252, 350, 352 and the lower channel set 130, 132, 230, 232, 330, 332 can have any shape that allows the complete sealing of the fill channel 146, 246, 346 and the vent channel 148, 248, 348. The heater assembly 170, 270, 370 can heat two or more valves of two or more cartridges 100, 200, 300. The heater assembly 170, 270, 370 can individually address each valve 110, 210, 310.

In some embodiments, the valve 110, 210, 310 are not reversible. The TRS is heated and flows into the fill channel 146, 246, 346 and the vent channel 148, 248, 348. The heater assembly 170, 270, 370 can stop the application of heat, allowing the TRS to cool and become immobile. In some embodiments, once the TRS flows from the reservoir 160, 260, 360 to the fill channel 146, 246, 346 and the vent channel 148, 248, 348, the TRS remains in this position. The TRS does not flow from the fill channel 146, 246, 346 and the vent channel 148, 248, 348 back to the reservoir 160, 260, 360. The TRS blocks the sample from leaving the reaction chamber 104, 204, 304 during amplification and detection. In other embodiments, the valve 110, 210, 310 is reversible allowing the fill channel 146, 246, 346 and the vent channel 148, 248, 348 to become unblocked.

The TRS flows from the reservoir 160, 260 in two directions toward the fill channel 146, 246, 346 and the vent channel 148, 248, 348. The TRS flows under the influence of gravity from the reservoir 160, 260, 360. The TRS flows by capillary action from the valve channels 150, 152, 250, 252, 350, 352 to the lower channel set 130, 132, 230, 232, 330, 332. The expanding gas in the reservoir 160, 260, 360 can push the TRS in both directions. The symmetry of the valve 110, 220, 310 as well as the centered and uniform application of heat from the heater assembly 170, 270, 370 can cause simultaneous and equal sealing of the fill channel 146, 246, 346 and the vent channel 148, 248, 348. The single reservoir 160, 260 can facilitate manufacturing and assembly of the cartridge 100, 200, 300. The symmetry of the valve 110, 210, 310 including mirror image valve channels 150, 152, 250, 252, 350, 352 can facilitate use by reliably sealing both the fill channel 146, 246, 346 and the vent channel 148, 248, 348 at the same time. The symmetry of the valve 110, 220, 320 including mirror image valve channels 150, 152, 250, 252, 350, 352 can facilitate use by reliably sealing both the fill channel 146, 246 and the vent channel 148, 248, 348 with equal volumes and flow rates of TRS. The symmetry of the valve 110, 220, 320 including mirror image valve channels 150, 152, 250, 252, 350, 352 can facilitate use by reliably sealing both the fill channel 146, 246, 346 and the vent channel 148, 248, 348 by application of heat by the valve heater 172, 272, 372. The valve heater 172, 272, 372 can be centrally located under the reservoir 160, 260, 360 to provide centralized and precise application of heat. The valve heater 172, 272, 372 can uniformly provide heat underneath the reservoir 160, 260, 360 and/or the valve channels 150, 152, 250, 252, 350, 352 to ensure equal flow rates and flow volumes from the reservoir 160, 260, 360 to the respective valve channel 150, 152, 250, 252, 350, 352.

In other embodiments, with two reservoirs and/or different valve channel characteristics, the fill channel 146, 246, 346 and the vent channel 148, 248, 348 can have sequential sealing of the fill channel 146, 246, 346 and the vent channel 148, 248, 348. In other embodiments, with two reservoirs and/or different valve channel characteristics, the fill channel 146, 246, 346 and the vent channel 148, 248, 348 can have unequal flow characteristics and sealing of the fill channel 146, 246, 346 and the vent channel 148, 248, 348.

The heater assembly 170, 270, 370 can include the reaction chamber heater 174, 274, 374 and the conductive elements 176, 276, 376 to provide uniform heat to the reaction chamber 104, 204, 304. The cartridge 100, 200, 300 can be designed to fill the reaction chamber 104, 204, 304 from the top. The amplification-ready sample flows under the influence of gravity to a portion of the reaction chamber 104, 204, 304. The reaction chamber 104, 204, 304 can be partially filled such that the entire height of the reaction chamber 104, 204, 304 that contains the sample is surrounded by the reaction chamber heater 174, 274, 374. The reaction chamber 104, 204, 304 can be filled such that a majority of the height of the reaction chamber 104, 204, 304 that contains the sample is surrounded by the reaction chamber heater 174, 274, 374. The design of the cartridge 100, 200, 300 can prevent back pressure to the inlet 106, 206, 306. Once the sample enters the reaction chamber 104, 204, 304 the influence of gravity prevents the sample from back flowing to the inlet 106, 206, 306. The position of the upper channel set 134, 136, 234, 236, 336 along the top of the substrate layer 120, 220, 320 can prevent backflow. The venting of the reaction chamber 104, 204, 304 while filling the reaction chamber 104, 204, 304 can prevent back flow. The pressure gradient allows the escape of gas toward the vent 108, 208, 308 but not the escape of fluid. The sample remains within the reaction chamber 104, 204, 304 once it passes through the fill channel 146, 246, 346. The sample does not enter the vent channel 148, 248, 348.

The valve 110, 210, 310 isolates the reaction chamber 104, 204, 304. The reaction chamber 104, 204, 304 is isolated from the inlet 106, 206, 306. The reaction chamber 104, 204, 306 is isolated from the vent 108, 208, 308. Both the upstream and downstream channels from the reaction chamber 104, 204, 304 are sealed. One valve 110, 210, 310 isolates both the inlet and the outlet of the network 102, 202, 302. One valve retains the sample on the cartridge 100, 200, 300 after amplification and detection.

The foregoing description is intended to illustrate various aspects of the present technology. It is not intended that the examples presented herein limit the scope of the present technology. The technology now being fully described, it will be apparent to one of ordinary skill in the art that many changes and modifications can be made thereto without departing from the spirit or scope of the appended claims.

1. A microfluidic cartridge comprising:
an inlet;
a reaction chamber;
a vent;
a fill channel spanning between the inlet and the reaction chamber comprising a first lower channel, a first through channel, and a first upper channel;
a vent channel spanning between the reaction chamber and the vent comprising a second upper channel, a second through channel, and a second lower channel; and
a valve configured to simultaneously seal the fill channel and the vent channel along the first lower channel and the second lower channel.

2. The microfluidic cartridge of claim 1, wherein the reaction chamber is conical.

3. The microfluidic cartridge of claim 1, wherein the reaction chamber is trapezoidal.

4. The microfluidic cartridge of claim 1, wherein the reaction chamber has a volume between 50 μl and 100 μl.

5. The microfluidic cartridge of claim 1, wherein the reaction chamber has a volume between 100 μl and 150 μl.

6. The microfluidic cartridge of claim 1, further comprising a top layer configured to seal the reaction chamber, the first upper channel, and the second upper channel.

7. The microfluidic cartridge of claim 1, wherein the valve is configured to confine a fluid sample to the fill channel and the reaction chamber.

8. The microfluidic cartridge of claim 1, further comprising a bottom layer configured to seal the first lower channel and the second lower channel.

9. The microfluidic cartridge of claim 1, further comprising a bottom layer configured to seal valve channels of the valve.

10. The microfluidic cartridge of claim 1, further comprising a first valve channel forming a junction with the first lower channel and a second valve channel forming a junction with the second lower channel.

11. An assembly for amplification and detection comprising:
a cartridge comprising:
an inlet;
a reaction chamber;
a vent;
a fill channel spanning between the inlet and the reaction chamber comprising a first lower channel, a first through channel, and a first upper channel;
a vent channel spanning between the reaction chamber and the vent comprising a second upper channel, a second through channel, and a second lower channel;
a valve configured to seal the fill channel and the vent channel along the first lower channel and the second lower channel;
a heater assembly configured to apply heat to the reaction chamber and the valve; and
a detector configured to detect fluorescence from the reaction chamber.

12. The assembly of claim 11, wherein the heater assembly comprises a conductive element configured to receive the reaction chamber.

13. The assembly of claim 11, wherein the heater assembly is configured to heat a thermally responsive substance of the valve.

14. The assembly of claim 11, wherein the detector is configured for two-color detection.

15. The assembly of claim 11, wherein the detector is configured to detect a plurality of different fluorogenic probes for syndromic testing.

16. The assembly of claim 11, wherein the assembly is configured to receive a plurality of detectors.

17. The assembly of claim 11, wherein the assembly is configured to receive a plurality of cartridges.

18. A method of amplifying and detecting comprising:
introducing an amplification-ready sample into a cartridge, wherein the cartridge comprises a fill channel spanning between an inlet and a reaction chamber, the fill channel comprising a first lower channel, a first through channel, and a first upper channel, wherein the cartridge comprises a vent channel spanning between the reaction chamber and a vent, the vent channel comprising a second upper channel, a second through channel, and a second lower channel;
closing a valve to simultaneously seal the fill channel and the vent channel along the first lower channel and the second lower channel;
heating the reaction chamber; and
detecting fluorescence from the reaction chamber.

19. The method of claim 18, further comprising performing syndromic testing by detecting multiple fluorogenic probes in a plurality of the cartridges.

20. The method of claim 18, wherein detecting fluorescence comprises detecting fluorescence from a sample volume between 50 μl and 150 μl.

21.-37. (canceled)
